(19) United States
(12) Patent Application Publication
(10) Pub. No.: US 2002/0131393 A1
(43) Pub. Date: Sep. 19, 2002

(54) Graphic user interface for a radio location determination system

(76) Inventor: Andrew Baldridge, Dallas, TX (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/092,327

(22) Filed: Mar. 6, 2002

Related U.S. Application Data
(62) Division of application No. 09/235,900, filed on Jan. 22, 1999, now abandoned.
Application No. 09/235,900 is a continuation-in-part of application No. 08/910,066, filed on Aug. 12, 1997.

(51) Int. Cl. H04L 12/56

(52) U.S. Cl. 370/343; 370/412

(57) ABSTRACT

A system for accessing a communication channel and displaying information to a user comprises means for transmitting successive packets of information over said communication channel; access means for prioritizing access of said packets of information to said communications channel said access means including means for withholding the transmission of said packets over said communication channel for a predetermined period of time; means for continuously sensing the state of said communication channel during said predetermined period of time; means for determining if said channel is clear after waiting for said predetermined period of time; and means for transmitting said packet after said predetermined period of time if said channel is clear; and command and control means coupled to said location determination means for accepting queries from a user and displaying the location of said transmitting devices on a map, said command and control means including a plurality of subscriber records and subscriber management means for accessing and modifying said records, said command and control means also including network management means for displaying a graphical network tree, said tree containing all of said transmitting devices on the network, said network management means including mapping means for positioning devices on said map and for defining regions of said map in response to user commands.

### CROSS REFERENCES RELATED APPLICATIONS

This is a complete application claiming the benefit of copending Continuation patent application Ser. No. 08/910,066, filed Aug. 12, 1997, entitled “An Improved Method and System for Determining Radio Location.”

### BACKGROUND OF THE INVENTION

Personal safety has become a visible concern for many in society, particularly those who frequent public places such as college campuses. Many personal-safety devices have been proposed and marketed which seek to alleviate these concerns. One important requirement for all safety devices is to provide an alarm that allows authorities to provide a prompt response.

Once an alarm has been received, the overriding goal for authorities is to promptly determine the location of the emergency call. Once the person's location is known, steps can be taken to provide appropriate aid in a reliable and timely manner. Additionally, any location determination system must instill users with enough confidence that attempts to use the system will be successful.

While it is a conceptually simple task to transmit a signal that can be tracked in an interference free environment, practical problems exist. For example, there is an increasing demand for the transmission spectrum by a myriad of types of wireless services, to the point where many bands must be shared to allow many wireless services to be offered. This sharing results in a complex communications environment, and many sophisticated techniques must be employed to ensure that systems will continue to operate reliably in spite of the “signal degradation” caused by the wireless environment.

Signal interference problems also exist. For example, interference can originate from other parts of the same system, from other compatible systems, such as might occur due to nearby campuses operating the same kind of system at each campus, from incompatible systems such as cordless telephones or point-to-point data links that typically also use the shared-band, and from equipment operating at higher power levels outside of the band (spurious radiation).

A variety of access methods have been previously used in the data and wireless fields. For example, a multiple access method known as ALOHA, is well known. In this simple method, which is effective for access to a medium that has little demand, a transmission is made whenever the data is ready, and the success of the transmission is based on the receipt of a positive acknowledgment of receipt of the message. If the acknowledgment is negative, indicating that either the message was not received and there was no acknowledgment, or that the message was received corrupted, then the mechanism will re-try, but with a scheme for backing off by a random delay, to prevent the system from “choking”. When media traffic increases, significant numbers of messages are corrupted by this method, and overall throughput falls to very low levels, with most of the time being spent on re-try attempts.

An improved method, Carrier Sense Multiple Access (CSMA), first senses whether a transmission is in progress before attempting to transmit, thereby preventing to large degree, the corruption of messages already in the process of transmission. However, this method can waste some of the system's capacity when a medium number of transmissions are attempted since the algorithm waits a significant length of time before re-attempting transmission.

Another algorithm used for multiple access to a frequency channel is p-persistent CSMA. Two constants are used with this algorithm: T, the end-to-end propagation delay of the bus, and p, a specified probability. A station using the p-persistent algorithm senses the channel and then the following occurs. If the channel is sensed idle, a random number between zero and one is chosen. If the selected number is less than p, the packet is transmitted; if not, the station waits T seconds and repeats the complete algorithm (which includes the contingency that the channel may be busy). Also, if the channel is busy, the station persists in sensing the channel until it is found to be idle and then proceeds as described above.

The p-persistent algorithm also uses the sense information to avoid transmitting when the channel is busy. It differs from the nonpersistent algorithm (which never persists in transmitting since it always backs off), by persisting in attempting to transmit. When the channel becomes free, this fact is immediately sensed by a station using the p-persistent algorithm. To avoid collisions with other ready stations that are employing the same strategy, or at least to inject flexibility into the algorithm, a station transmits only with probability p when the channel becomes free.

The delay T is chosen so that two stations sensing the channel to be free at the same time will not collide if one transmits and the other delays. In time T the leading edge of the transmission from the transmitting station will reach the sensor of the second station and the sensed signal will prevent it from transmitting. The parameter p can be chosen to optimize the algorithm for the application and its message traffic patterns.

### SUMMARY OF THE INVENTION

It is an object of the invention to provide a low interference-potential mechanism for multiple access by unsynchronized locator-transceivers using the frequency hopping techniques required for shared band-use.

It is a further object of the invention to significantly reduce effects of interference while operating in the ISM band, to enhance communication reliability.

It is still another object of the invention to provide a reliable spread-spectrum signaling technique for tracking the location of the locator-transceiver.

It is yet another object of the invention to provide a simple mechanism for prioritizing access of different classes of transmission.

It is a further object of the invention to provide a tracking system that is quickly and reliably locates people using the radio-transceiver.

It is another object of the invention to provide a device that allows security personnel to quickly come to the aid of people who experience a threat to their personal safety anywhere in or near a campus or similar environment.

It is a further object of the invention to provide a device which, when activated, transmits an identification signal whose source location can be remotely determined and tracked with enough precision for security personnel to quickly come to the aid of the person who activated it.

It is still another object of the invention to provide a system that is reliable and offers an on-demand confidence-test feature.

It is yet another object of the invention to provide a system that is both robust and user-friendly.

It is another object of this invention to effectively minimize the creation of interference in the shared band in which it operates, thereby ensuring communications-reliability, while still maximizing the throughput of the system.

It is another object of this invention to effectively minimize the deleterious effects of interference inherent in the shared band in which it operates, thereby ensuring communications-reliability, while still maximizing the throughput of the system.

It is still another object of the present invention to provide a system for locating an alarm call which uses of a number of different wireless locating technologies.

It is still another object of the invention to provide a system which uses shared radio-communication bands.

It is still another object of the present invention to provide a system whereby a graphical user interface displays various types of information to the user.

It is still another object of the present invention to provide a graphical user interface with a Subscriber Management Utility (SMU) which is used to manage subscribers, asset items, and to translate data from alternative database formats into the format used by the system.

It is yet another object of the present invention to provide a graphical user interface with a Network Management Utility (NMU) 1012 that is used to manage and configure the system.

It is still another object of the invention to provide a NMU which displays a graphical network tree that contains all of the discovered devices on the network and a mapping feature enables the user to position devices on a campus map and to define regions for the map.

It is yet another object of the invention to provide an NMU which can be used as a maintenance tool to fine-tune the devices on the network.

It is still another object of the invention to provide a graphical user interface with an Alarm Tracking Console (ATC) which is used to monitor and track alarms on the system.

It is yet another object of the invention to provide an ATC which graphically displays alarms in progress, subscriber information, and maintains an animated position track of a subscriber.

The is still another object of the invention to provide a graphical user interface with a Paging Server (PS) application that provides a paging capability to any application on the system.

It is yet another object of the present invention to provide a system where an application can become a client to the PS and send messages to it over a network.

It is a further object of the invention to provide a system where maintenance alert messages as well as subscriber alarm messages can be sent to one or more alphanumeric pagers.

It is still another object of the present invention to provide a graphical user interface with a Database Management Utility (DMU) that is used to manage the archiving of old data in the system database.

These and other objects of the invention are provided by a system for determining the location of a device comprising means for transmitting a location determination transmission over a communication channel; a plurality of detection device for receiving said location determination transmission; and means for prioritizing access to said communications channel including means for having said remote device wait to transmit over said communication channel for a predetermined period.

### BRIEF DESCRIPTION OF THE DRAWINGS

FIG. 1 depicts a block diagram of the major components of the network according to principles of the present invention;

FIG. 2 is a diagram of the structure of the data block according to principles of the present invention;

FIG. 3a is a block diagram of a Personal Alarm Device (PAD) according to principles of the present invention;

FIG. 3b is a pictorial view of one possible embodiment of the Personal Alarm Device (PAD) according to principles of the present invention;

FIG. 4a is a flowchart depicting the transmit-only mode of the operation of the Personal Alarm Device (PAD) according to principles of the present invention;

FIG. 4b is a flowchart depicting the transmit-and receive confirmation mode of the operation of the Personal Alarm Device (PAD) according to principles of the present invention;

FIG. 5 is a block diagram of a Proximity Sensing Transceiver (PROX) according to principles of the present invention;

FIG. 6 is a block diagram of a Direction Finding Receiver (DFR) according to principles of the present invention;

FIG. 7 depicts a flow diagram of the Priority-delay, Persistent—Carrier Sense Multiple Access (PDP-CSMA) technique according to the principles of the present invention;

FIG. 8 depicts a flow diagram of the Priority-delay, Frequency-Hopped—Carrier Sense Multiple Access (PDFH-CSMA) technique according to principles of the present invention;

FIG. 9 depicts a flow diagram of the fast-scan mechanism used by the Tracking System network according to principles of the present invention;

FIG. 10 depicts a time-diagram of the operation of the PDP-CSMA techniques network according to principles of the present invention;

FIG. 11 is a block diagram of the Direction-Finding Tracker (DFT) according to principles of the present invention;

FIG. 12 is a block diagram of an alternate embodiment (using signal-strength only) of the Tracker according to principles of the present invention;

FIG. 13 is a block diagram of the system according to principles of the present invention;

FIG. 14 is a block diagram of the CCC software according to principles of the present invention;

FIG. 15 is a SMU screen according to principles of the present invention;

FIG. 16 shows the subscriber form window according to principles of the present invention;

FIG. 17 shows a “Take New Picture” dialog box according to principles of the present invention;

FIGS. 18a-b show a dialog box according to principles of the present invention;

FIG. 19 shows an asset item form according to principles of the present invention;

FIG. 20 is a registration settings box according to principles of the present invention;

FIG. 21 shows the main window of the NMU according to principles of the present invention;

FIG. 22 shows the network device tree according to principles of the present invention;

FIG. 23 shows the concentrator property dialog box according to principles of the present invention;

FIG. 24 shows a map tool bar according to principles of the present invention;

FIG. 25 illustrates a portion of a map displaying network devices according to principles of the present invention;

FIG. 26 shows a name point properties dialog box according to principles of the present invention;

FIG. 27 shows the delete options dialog box according to principles of the present invention;

FIG. 28 shows a manage operators dialog box according to principles of the present invention;

FIG. 29 shows the personal profile dialog box according to principles of the present invention;

FIG. 30 shows a system permissions dialog box according to principles of the present invention;

FIG. 31 shows a report manager dialog box according to principles of the present invention;

FIG. 32 shows the layout of the screen in alarm view for the Alarm Tracking Console (ATC) according to principles of the present invention;

FIG. 33 shows a sample alarm list according to principles of the present invention;

FIG. 34 shows a campus map window according to principles of the present invention;

FIG. 35 shows a report dialog box according to principles of the present invention;

FIG. 36a shows the layout of the screen in guard tour view for the Alarm Tracking Console (ATC) according to principles of the present invention;

FIG. 36b shows the layout of the screen in incident history view for the Alarm Tracking Console (ATC) according to principles of the present invention;

FIG. 37 shows the send page alert dialog box according to principles of the present invention;

FIG. 38 shows the report manager dialog box according to principles of the present invention;

FIG. 39 shows the tracker assignments dialog box according to principles of the present invention;

FIG. 40 shows the manage operators field dialog box according to principles of the present invention;

FIG. 41 shows the personal profile dialog box according to principles of the present invention;

FIG. 42 shows the system permissions dialog box according to principles of the present invention;

FIG. 43 shows the layout of the screen for the main application window according to principles of the present invention;

FIG. 44 shows the setup communications dialog box according to principles of the present invention;

FIG. 45 shows the paging service dialog box according to principles of the present invention;

FIGS. 46a-b are flowcharts illustrating the operation of ATC;

FIGS. 47a-f are flowcharts illustrating the operation of various buttons from the ATC;

FIGS. 48a-b are flowcharts illustrating the operation of the NMU;

FIGS. 49a-k are flowcharts illustrating the operation of the various buttons on the NMU;

FIGS. 50a-b are flowcharts illustrating the operation of the Paging Server;

FIGS. 51a-b are flowcharts illustrating the operation of the SMU; and

FIG. 52 is a flowchart illustrating the operation of PAD Registration Process.

### DESCRIPTION OF THE PREFERRED EMBODIMENTS

Overall System Description

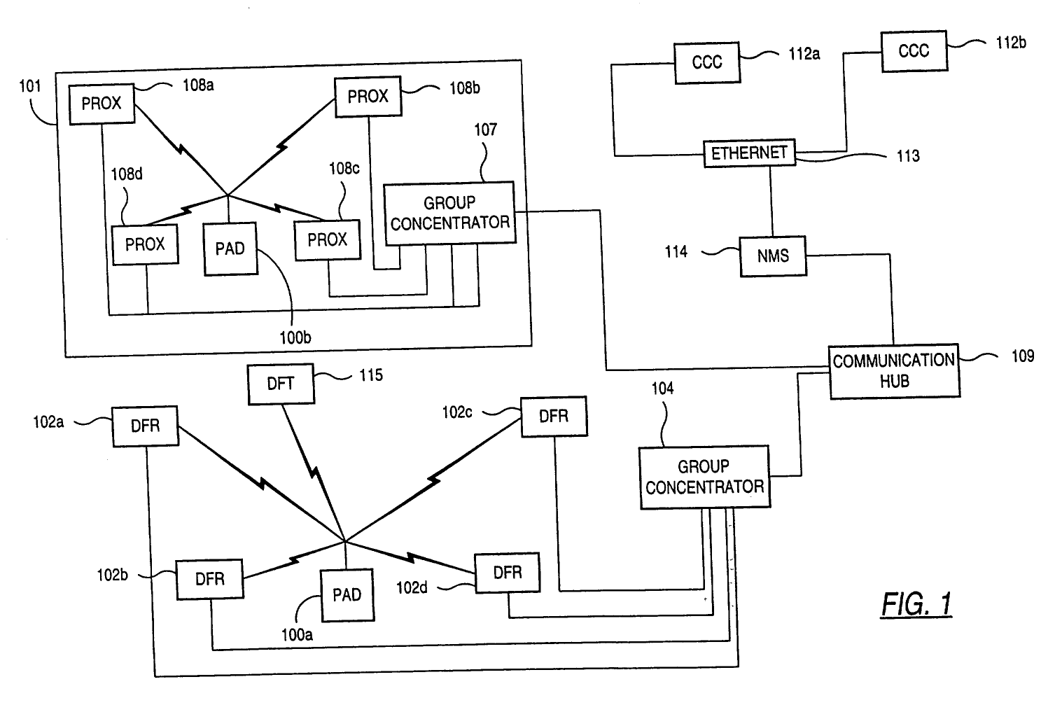

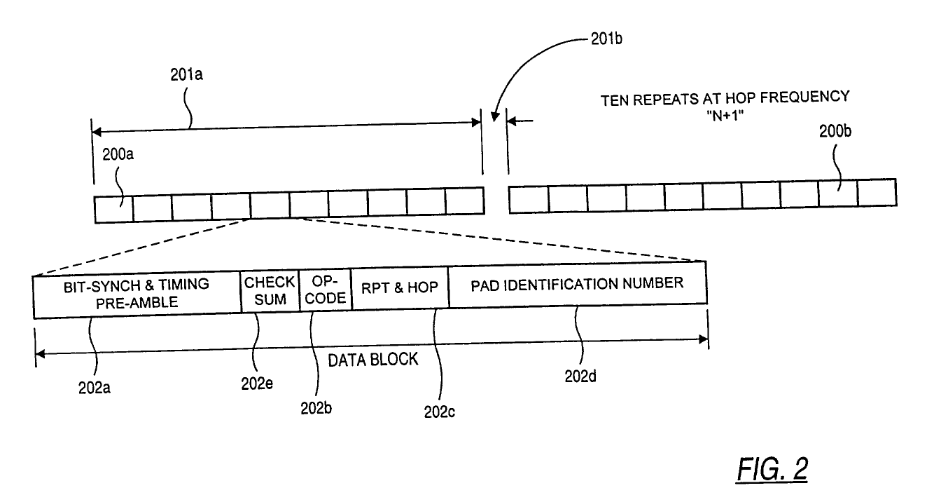

Referring now to FIG. 1, Proximity Receiver Controller Transmitters (PROXs) 108a, 108b, 108c, and 108d, located inside a building 101, receive RF signals transmitted from a Personal Alarm Device (PAD) 100b which is also located inside the building 101. The PROXs 108a, 108b, 108c, and 108d determine the PAD identity and PAD signal strength, then send this data to a group concentrator 107 which concentrates the data for transmission to a communication hub 109. The communication hub 109 routes the data to a Network Management System (NMS) 114 via a wire or wireless link. PROXs are advantageously located in the interiors of buildings where the uncertain attenuation and path of a signal makes detection by external receivers difficult. Although preferably used in building interiors, the PROXs may be placed outside of the building 101, in parking lots, for example.

Multiple PROXs are installed on nearly every floor of a building; the exact number and location of the PROXs depends on the layout and signal propagation properties of a particular building. The PROXs provide estimates of a PAD's signal strength, estimates measured over multiple frequencies used in each transmission from the PAD, as further explained below. The estimates are transmitted to the NMS where the signal strength estimates from all the PROXs receiving the PAD's signal are used in a signal-strength-vs.-distance technique, well known in the art, to accurately estimate of the PAD's location.

The signal strength data received by PROXs 108a-108d is used by the NMS 114 to estimate the PAD's location in the building; this estimated location is then sent by the NMS 114 to Command and Control Centers (CCCs) 112a and 112b for display. If the RF signal transmitted by the PAD 100b leaves the building, then Direction Finding Receivers (DFRs) 102a, 102b, 102c, and 102d detect the signal and provide location data to a data concentrator 104 which concentrates the data from the various DFRs, then to communication hub 109 which routes the data to the NMS 114. The NMS 114 uses this data to confirm the in-building location estimate of PAD 100b.

The PAD 100b transmits frequency-hopped signals which can originate on any of the minimum number of frequency channels required for shared-band use of the spectrum (typically 50 channels). In order to quickly “hear” a transmission, the PROXs and DFRs rapidly scan all of the frequency channels for possible transmissions.

Another PAD 100a, also transmitting frequency-hopped signals, is located outside of building 101, and transmits RF signals to the DFRs 102a, 102b, 102c, and 102d which rapidly scan a set of frequency-hopped channels for a signal, then estimate the time-of-arrival (TOA), and angle-of-arrival (AOA) of the signal. The DRFs 102a, 102b, 102c, and 102d are preferably located on radio towers and receive signals of PADs located beyond the receiving range of PROXs 108a-108d. Typically, three to five DFRs are used in a network that covers an area the size of a college campus. Of course, the number of DFRs can be varied to increase or decrease the network coverage area.

As stated above, the DFRs 102a-102d estimate the TOA and/or AOA of the signal transmitted by the PAD 100a. Two such estimates of AOA and three of TOA are sufficient to estimate the location of the signal source. However, the quality of the location estimate can be significantly improved when more estimates are available. The DFRs 102a-102d are preferably hard-wired to the group concentrator 104 where data is concentrated. The group concentrator 104 is coupled to communication hub 109 which routes the data to the NMS 114. Although hard-wiring is preferred, any type of communication link can be used for the connection. Additionally, the DFRs 102a-102d determine an identification number of the PAD 100a, and any additional data from the transmitting device, and an estimate of the absolute signal level. The DFRs 102a-102d send this information to the NMS 114 where the location can be estimated by multiple techniques; e.g. triangulation from the angle-of-arrival (AOA) estimates; the maximum-likely-position based on both absolute and relative signal strength estimates; and multilateration from the time-of-arrival (TOA) estimates from the different DFRs 102a-102d that report an event. As more measurement methods and points of measurement are used, such as use of relative phase of arrival of signals, or AOA information from additional DFRs, this additional information is used to increase the accuracy and reliability of the location estimates, by any of a variety of well known location-solution-optimization methods.

The NMS 114 also manages the operations of the network and can be located at a CCC 112 where operations of the network are controlled and monitored. Communication links 116 couple PROXs 108a-108d to the NMS 114, and can be point-to-point wireless, power-line communication, or hard-wired links.

The NMS 114 is connected to an ethernet network 113, and the CCCs 112a and 112b are also connected to the ethernet network 113. Thus, the CCCs 112a and 112b can be configured as master and slave CCCs and can be located anywhere along the ethernet network 113.

The PADs 100a and 100b may be transmit-only devices or, preferably, a two-way, transmit-receive devices. Whereas the transmit only device must rely on some form of external, secondary confirmation of the device's operation, the two-way device provides confirmation of the network operation at the device, in addition to possibility of providing other operational features. All PADs are battery operated with the battery having a long life, preferably, of at least one school year. The PADs batteries are recycled at the end of the school year or after an emergency call to ensure that the PADs are always operational.

The PADs 100a and 100b transmit alarm and confidence-test transmissions. When the user activates an alarm call, the PAD continuously transmits the signal used to locate the person. By “continuously” it is meant to include not only unbroken transmissions but also to include short (low duty-cycle) transmissions repeated frequently, which minimize the use of spectrum while still transmitting frequently enough for the personnel, coming to the aid of the caller, to track the signal through the network or with a hand-held tracking device. The PAD can also be activated to transmit a much shorter test signal to receive confirmation of the proper operation of the device and the network. The duration of an alarm could be as long as 30 minutes, even at the end of the school year (near the end of the battery's life expectancy). The alarm transmission carries the PAD identification number and an alarm type opcode.

A hand-held, signal-strength-only, or, signal-strength and direction-finding tracking device (DFT) 115, is used to locate PADs within the area of coverage. The DFT is used by the security operator to physically “home-in” on the PAD 100a transmitting an alarm.

The confidence-test transmission is used to confirm the operation of the PAD. The confidence test signal transmission is made for a one-second duration and is transmitted sequentially across ten hopped frequency channels (for multi-path fading diversity and for compliance with the shared band access rules.) Each hop consists of eight repeats of the preamble, op-code, transmission-counters and PAD identification number and checksums. Each time a confidence test signal is initiated, a different set of hopped frequencies are used, so that at least 50 different frequencies are used with about equal probability, as required for shared-band use. The confidence-test transmissions carry the PAD identification number and a confidence-test type opcode.

Frequency hopping techniques are used by the network to ameliorate the effects of signal “collisions” which inevitably occur with shared access to a communication band. Therefore, the PADs 100a and 100b transmit a narrow-band frequency hopped signal as detailed in FIG. 2. A series of data blocks 200a-200j are transmitted at a hop frequency N. After transmitting these data blocks, the hop frequency is changed to hop frequency N+1 after a hop transmission interval. Preferably, the hop transition interval is less than 1 ms.

A data block comprises a 64-bit preamble 202a which includes the bit-synch acquired by the system and timing information and may include a Barker code start flag. The purpose of the long preamble in the data structure is to provide a repetitive signal on which phase and angle of arrival measurements can be accurately made. The data block also includes a 8-bit opcode 202b which indicates the type of transmission. The “operation-code type” of transmission may, for example, be a confidence test transmission or an alarm transmission, or any other signaling type that may be used by the system, such as message-paging. The opcode 202b is followed by the checksum bit field 202e which provides for data validity checking by the receiver. The checksum is followed by a 16-bit repeat-count and hop-count field 202c which indicates the next hop frequency and the current repeat count showing the number of blocks transmitted at the current hop frequency. The repeat-and-hop field 202c is followed by 32-bit ID address field 202d which identifies the PAD sending the message. This data-block will be repeated multiple (eight) times in each hop transmission burst (the whole hop-dwell time). This data structure can be modified to include changes to the duty-factor of the alarm-call transmission, where either the maximum dwell time can be reduced, while keeping the hop time fixed, or keeping the dwell time and increasing the hop-transition time to multiple hop times in duration.

One illustrative embodiment of the present invention using the data block structure described above provides a channel bandwidth of 25 kHz, the number of hop channels of at least 50, a maximum dwell time of less than 400 ms, a MSK modulation of 15.625 kBPS, and a user data rate of 15.625 kBPS. The series of data blocks transmitted at hop frequency N occurs for 108.5 ms.

Since the transmission is relatively narrow-band, it is subject to severe multi-path fading indoors. The effects of multi-path fading are greatly ameliorated by the frequency-hopping access technique of the present invention, since it requires transmitting the signal successively on multiple narrow band channels. To maximize the multipath amelioration benefit, the hop frequencies are widely spaced in frequency (in accordance with the frequency-hopping requirements) to obtain maximum multi-path diversity. By using only the maximum estimated-signal-level readings from the multiple readings taken at the different frequencies of a single test or alarm transmission, the variance in estimated signal strength (with distance) is significantly reduced. Such lower variance translates to improved uniformity of results of the absolute and relative-signal-strength location estimation algorithms.

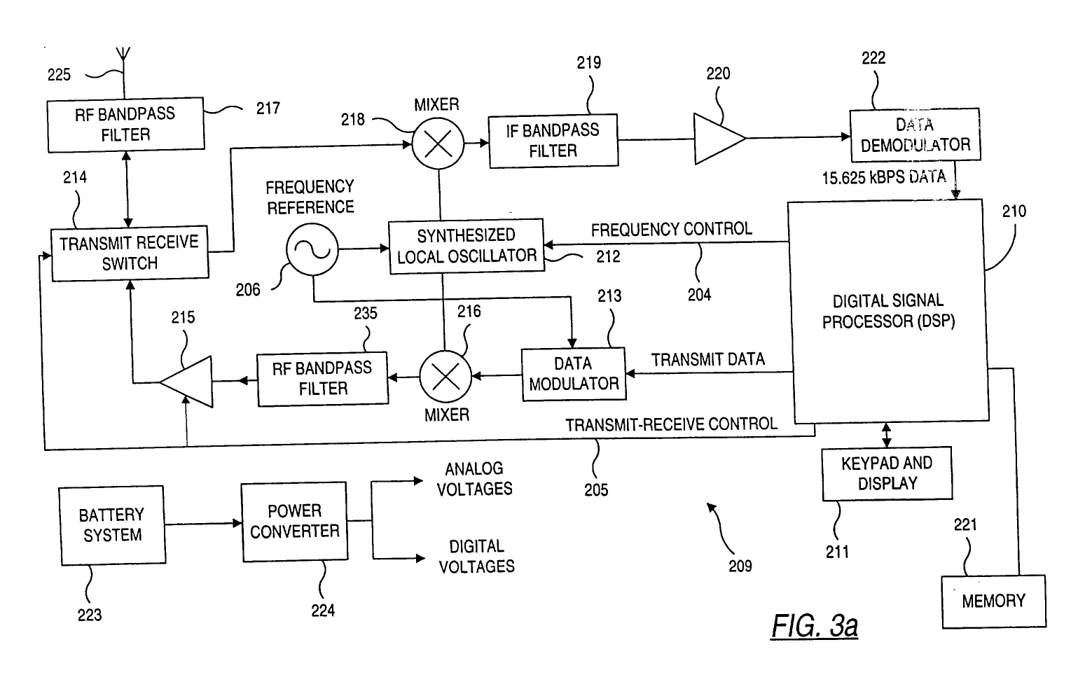

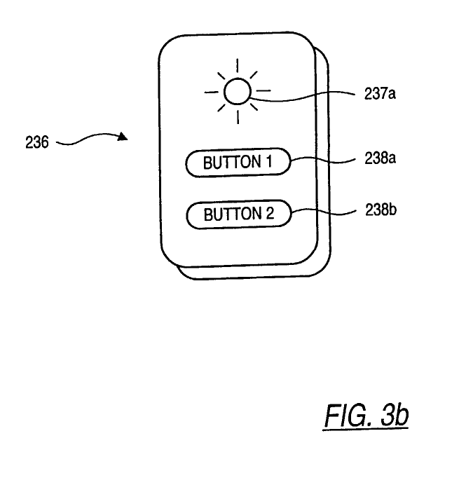

Turning now to FIG. 3a, a PAD comprises a frequency-hopped spread spectrum transceiver 209 that operates in the 902-928 MHz “Industrial Scientific & Medical” (ISM) band which allows for low-powered spread spectrum communication with minimum licensing requirements. This band is occupied by a number of services that share the band, under a set of technical-usage/access-rules set by the FCC.

A digital signal processor (DSP) 210 manages all the activities of the transceiver 209, based on programs stored in a DSP memory 221. The programs implement the prioritized frequency-hopped CSMA communication protocols, the data coding function, the real-time transceiver control activities and interaction with a key pad and display 211. Interaction commands received from the key pad and display 211 are converted into transmission or reception actions.

To transmit a signal, the DSP 210 initializes a synthesized local oscillator 212, which is supplied by a frequency reference 206, to the desired hop frequency, as required by the frequency-hopping protocol. The DSP 210 presents the data to be sent to a modulator 213, switches a transmit/receive (T/R) switch 214 to a “transmit” position and applies power to a power amplifier 215. The data is mixed with the signal from local oscillator 212 by a mixer 216, transmitted through a bandpass filter 235 which filters out unwanted signals, and then sent through the amplifier 215. The signal is then transmitted through the T/R switch 214 (which is in the “transmit” position), through a RF bandpass filter 235 which minimizes any unwanted noise or harmonics, and, finally, to an antenna 225 for transmission. The miniature antenna is sized to transmit and receive signals in the 902-928 MHz band.

When the DSP 210 requires reception, it routes signals from the antenna 225, through the filter 217, through the T/R switch 214 which is set to a “receive” position. The transmit receive switch 214 is set by DSP 210 via transmit-receive control 205. The RF signal is then mixed down in a double conversion to the desired frequency (typically a 45 MHz and 455 kHz intermediate frequency) at mixer 218 with a signal from the synthesized local oscillator 212, applied through a IF bandpass filter 219 and limiting-IF-amplifier 219. The signal is then processed by demodulator 222 to yield a 15.625 kBPS data signal. The data is then decoded by the DSP 210, and further action is determined according to the stored programs in the DSP memory 221.

The PAD derives power from a battery system 223, which preferably produces an output voltage of 6 volts, and converter 224 and provides interaction with the user through a set of push-buttons and LED indicator lights. The transmit power level is necessarily limited by the small battery and operating time limitations to about 100 milliwatts of output.

Referring now to FIG. 3b, the PAD 236 comprises LED light 237a which indicates that the unit is transmitting and a first push button 238a and a second push button 238b. The user presses both buttons simultaneously to send and alarm and one button after another button to initiate a test. The PAD is small, compact and battery powered. The life of the battery is preferably at least a school year in duration. To achieve such a lifetime, the maximum transmit power of the alarm call device will necessarily be quite limited. However, the signal must be powerful enough to be adequately received at reasonable distances, even inside buildings. With a small lithium battery, a 100 mw transmit level would satisfy the signal-range requirements and make possible confidence testing once a day through-out the school year, and still provide an alarm transmission of 30 minutes duration, even at the end of the school year.

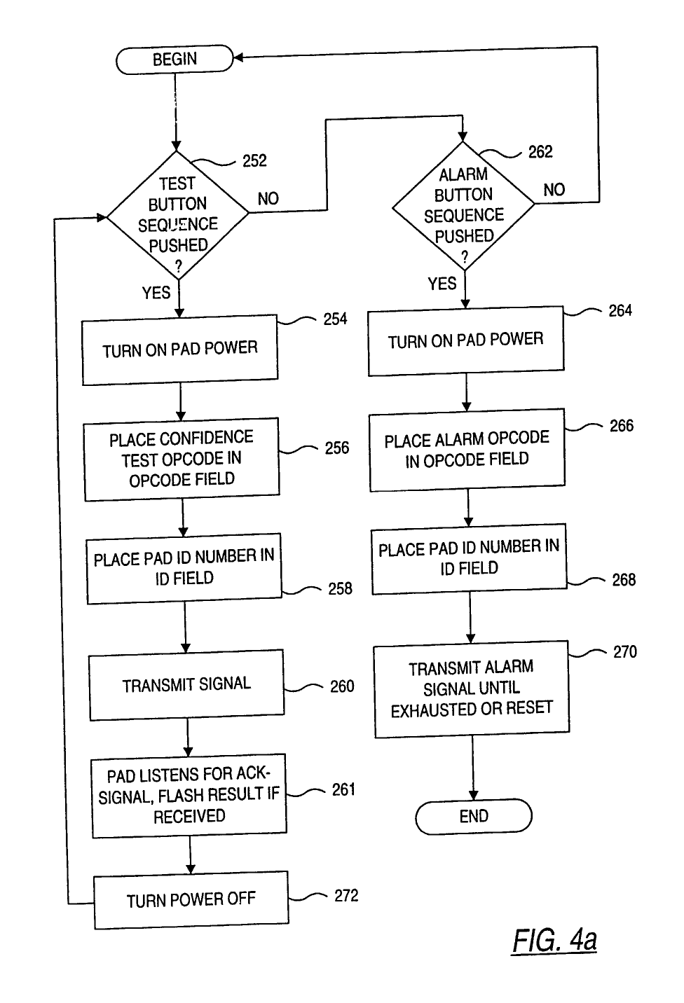

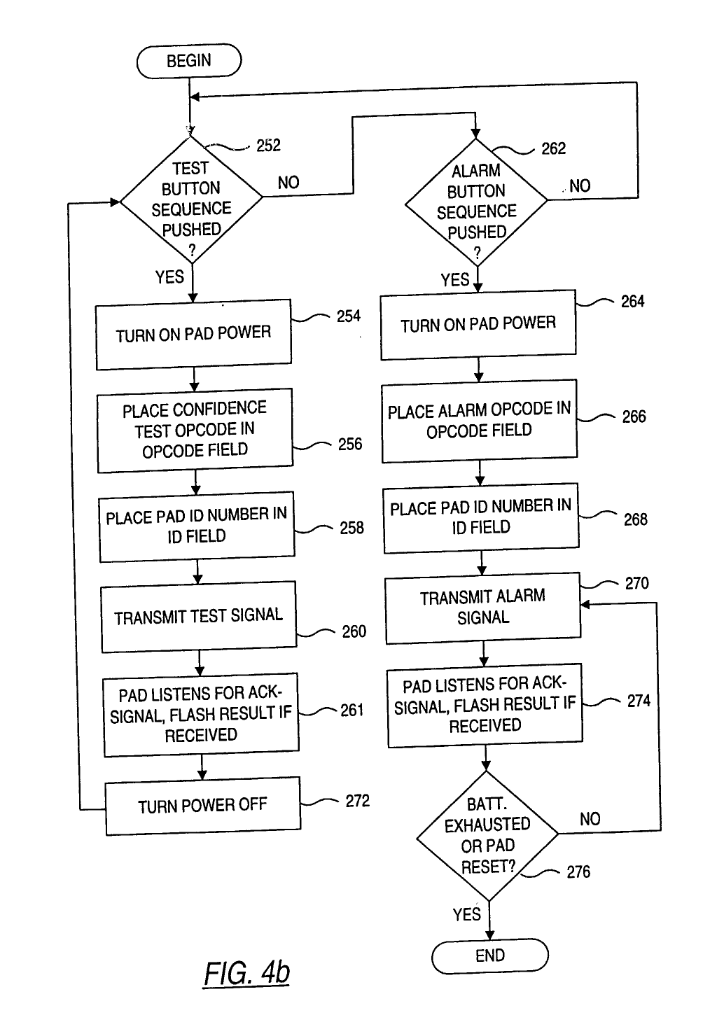

Referring now to FIG. 4a, the PAD determines at step 252 whether the confidence-test button on the PAD has been pushed. If affirmative, at step 254, power to the transceiver is turned on. Then, at step 256, the confidence test opcode is placed in the opcode field of the data block. The PAD's identification number is placed in the identification field at step 258. Next, the confidence test signal is transmitted at step 260, according to the prioritized-access method described in this invention. Prior to transmission, the PAD's receiver listens for an absence of other carriers on the transmit channel prior to enabling the transmitter, in accordance with the method of this invention, so avoiding unnecessary signal collisions. As described above, the PROX receives, decodes and validates the confidence test transmission, and transmits an acknowledgment signal (ACK) with the PAD's identification number, back to the PAD, on the last frequency channel used by the PAD in its hopping sequence. The PAD's receiver “listens” for the ACK signal and displays the result of the test by flashing the test indicator momentarily at step 261. Then, power to the PAD is turned off at step 272. Control returns to step 252 and button scanning resumes as described above. This access method provides a large number of PADs with equal probability of access to the channel, while the prioritizing algorithm of this invention, described below, allows “alarm transmissions” priority over all “confidence-test transmissions.” If step 252 is negative, the flow moves to step 262 which determines whether the alarm button on the PAD has been pressed. If step 262 is negative, the system continues scanning with step 252. If step 262 is affirmative, control continues with step 264 where power is turned on to the PAD. Next, at step 266, the alarm opcode is placed in the opcode field of the data block. Then, at step 268, the PAD's identification number is placed in the identification field of the data block. Next, at step 270, the PAD transmits the alarm signal (again, according to the prioritized-access method described in this invention,) until the battery is exhausted or until the PAD's transmission is reset. Execution then ends (and, for user confidence, the PAD's batteries must be recycled).

Once an alarm has been identified and displayed on the CCC monitors (computer-generated campus displays), the operations personnel can elect to dispatch the nearest security personnel (probably aided by a hand tracking device) to the aid of the caller. This is accomplished through conventional two-way voice communication between personnel at the CCC and emergency personnel as is known to those skilled in the art.

In the event of an alarm transmission, the PAD transmission is the same as for the confidence test, but repeats “continuously”, allowing the PROX to hear it at least five times per second. This great redundancy allows the possibility of some power saving in the PAD by reducing the duty-cycle of the PAD's alarm transmission by, for example, reducing the number of data-block repetitions per hop, or introducing a delay at the end of each transmission before hopping to the next channel—i.e. increasing the hop-transition interval.

Referring now to FIG. 4b, which depicts the operational flow diagram for another possible embodiment of the PAD. In this case the PAD behave the same way as the embodiment depicted in FIG. 4a, when executing a confidence test transmission, but the alarm test transmission differs in that every alarm transmission burst is acknowledged in the same way that the confidence test transmission is confirmed. In this case the PAD listens at step 274 between alarm transmissions, on the last channel used for transmission, for the ACK signal, and when it gets an ACK, flashes the alarm indicator to confirm operation. The process continues again until either the battery is exhausted or the PAD is reset at step 276.

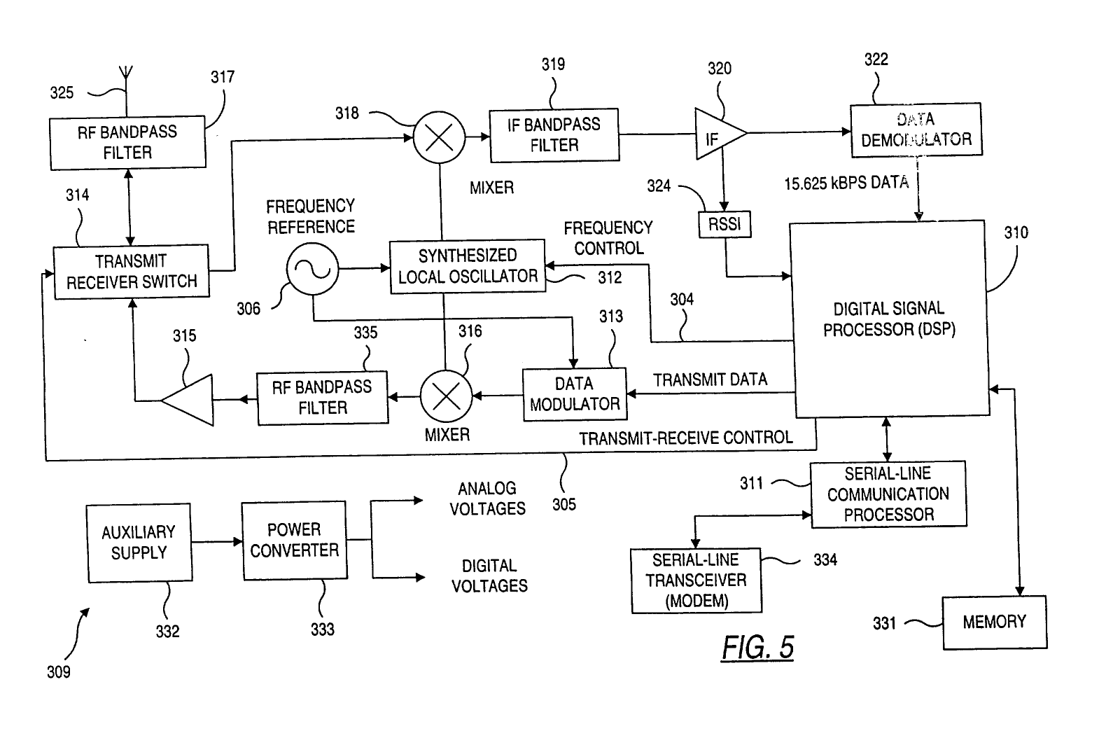

Referring now to FIG. 5, a PROX comprises a frequency-hopped spread spectrum transceiver 309. A digital signal processor (DSP) 310 manages all the activities of the transceiver 309, based on programs stored in a DSP memory 321. The programs implement the prioritized frequency-hopped CSMA communication protocols, the data coding function, the real-time transceiver control activities and interaction with the user interface which is a serial-line communication processor 311. The serial-line communication processor 311 communicates with a serial-line transceiver modem 334 which is coupled to a communication line.

To transmit a signal, the DSP 310 initializes a synthesized local oscillator 312 to the desired hop frequency via frequency control 304, as required by the frequency-hopping protocol, presents the data to be sent to a modulator 313, switches a transmit/receive (T/R) switch 314 to a “transmit” position via a transmit-receive control 305 and applies power to a power amplifier 315. The data is mixed with the signal from local oscillator 312 by a mixer 316, transmitted through a bandpass filter 317 which minimizes any unwanted noise and harmonics, and then sent through the amplifier 315. The signal then is then transmitted through the T/R switch 314 (which is in the “transmit” position), through a RF bandpass filter 335 which minimizes any unwanted noise and harmonics, and, finally, to an antenna 325 for transmission. The antenna 325 transmits and receives signals in the 902-928 MHz band.

When the DSP 310 requires reception, it routes signals from the antenna 325 through the bandpass filter 317, then through the T/R switch 314 which is set to a “receive” position via the control 305. The RF signal is mixed down to the desired 45 MHz and 455 kHz intermediate frequencies at a double conversion mixer 318 by a signal from the synthesized local oscillator 312, applied through a IF bandpass filter 319 and amplifier 320 where the absolute signal-strength is determined by calibrated relative signal strength indicator (RSSI) circuitry 324 and the signal is demodulated at 322 to yield a 15.625 kBPS data signal. The data is then decoded and signal-strength processed by the DSP 310, and further action is determined according to the stored programs in the DSP memory 321.

The power of the system is derived from a DC supply 332 which preferably has an output voltage of 24 volts. A power converter 333 converts the output voltage of supply to both analog and digital voltages which are used by the various elements in the PROX. The transmission-output power level is limited to less than one watt by the FCC standards for this band.

Interaction with the network is via a serial-line communication processor and suitable modem device. Two-way interaction occurs with the networks operations center via the concentrator and network hub.

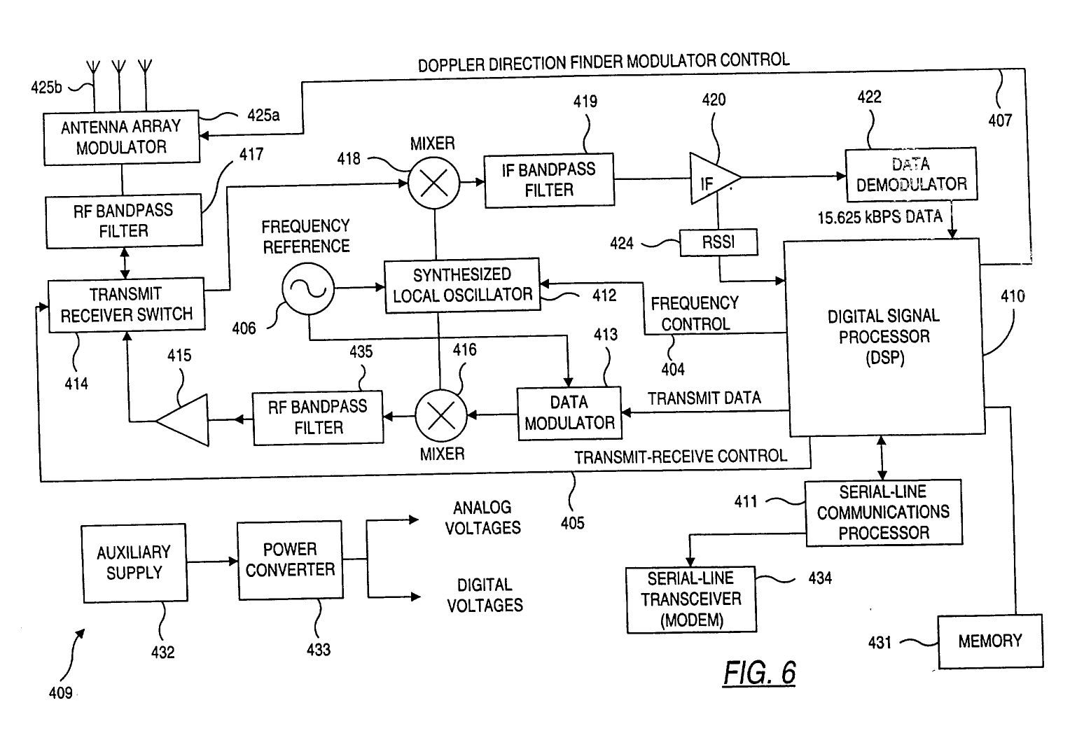

Referring now to FIG. 6, a DFR comprises a frequency-hopped spread spectrum transceiver 409. A digital signal processor (DSP) 410 manages all the activities of the transceiver 409, based on programs stored in a DSP memory 421. The programs implement the prioritized frequency-hopped CSMA communication protocols, the data coding function, the real-time transceiver control activities and interaction with a serial-line communication processor 411. The serial line communication processor 411 communicates with a serial-line transceiver modem 434 which is coupled to a communication line. Interaction commands received from the serial communication processor 411 are converted into transmission or reception actions by the DSP 410.

To transmit a signal, the DSP 410 initializes a synthesized local oscillator 412 to the desired hop frequency, as required by the frequency-hopping protocol, presents the data to be sent to a modulator 413, switches a transmit/receive (T/R) switch 414 to a “transmit” position (via transmit-receive control signal 405) and applies power to a power amplifier 415. The modulated signal is up-converted by the signal from local oscillator 412 at mixer 416, filtered a bandpass filter 417 which minimizes any unwanted noise or harmonics, and then amplified at 415. The signal then is then switched at the T/R switch 414 (which is in the “transmit” position), through a RF bandpass filter 435 which minimizes any unwanted noise or harmonics, and, finally, to an antenna 425 for transmission. Both antennas operate in the 902-928 MHz band.

When the DSP 410 requires reception, it routes signals from the antenna 425b, through antenna array modulator 425a, RF bandpass filter 417, through the T/R switch 414 which is set to a “receive” position (via transmit-receive control signal 405), the RF signal is mixed down to the desired frequency to yield 45 MHz and 455 kHz intermediate frequencies at double mixer 418 by a signal from the synthesized local oscillator 412 (which is controlled by a frequency reference 406), applied through a IF bandpass filter 419 and amplifier 420 where the signal is demodulated by 422 to yield a 15.625 kBPS data signal and detected by RSSI circuitry at 424 to yield a signal strength estimate. The data is then decoded, and signal strength processed by the DSP 410. Further action is determined according to the stored programs in the DSP memory 421.

The modulator 425a and antenna array 425b with its accompanying modulator, and complimentary angle of arrival software in the DSP form a pseudo-Doppler direction-finder. The modulator 425a is controlled by a Doppler direct finder modulator control signal 406 from the DSP 410.

The signals from the antenna array are processed by the DSP 410. The processing extracts data from the signals, determines angle and time of arrival of each significant multi-path arrival and estimates the absolute signal strength. This data is then communicated through the serial-line communication processor 411, serial-line transceiver 434, and the NMS via any type of link such as a telephone line, or PTP microwave.

In the case of the DFR, the transmit function is used mainly for direction-finder calibration, acknowledgment signals, and network maintenance purposes, and so the transmitter is connected to the transmitter receiver switch 414.

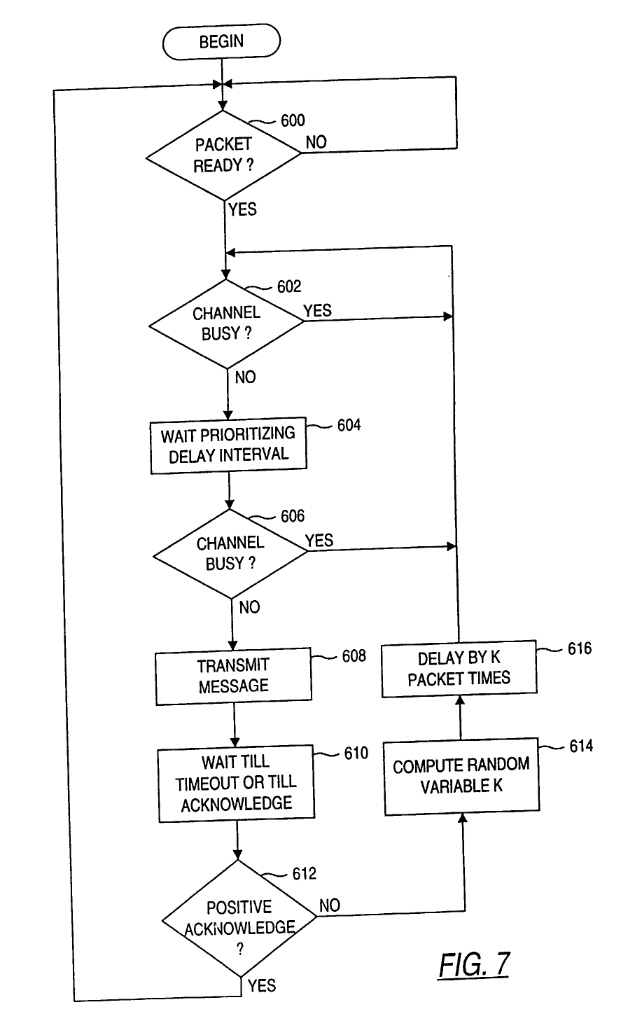

Referring now to FIG. 7, which depicts a flow diagram of the prioritizing delay, persistent CSMA technique in accordance with this invention. A PAD initiates accessing of a communication channel at step 600, determining whether a data packet is ready to be sent. If negative, control waits by loops back to the same step. If affirmative, at step 602, the channel is sensed to determine whether it is busy. If the channel is busy, control loops back to step 602 and the channel is sensed until it is idle. However, when step 602 is negative, that is, the channel is idle, the device waits at step 604 for a specific interval (the priority-delay interval) before testing for idle again at step 606. If the channel is no longer idle, control returns to step 602 to wait for the channel to become idle again. However, if step 606 finds the channel idle, control continues with step 608 and the message is transmitted. In other words, only if the channel is still idle after the priority-delay interval will the device transmit on the channel. By choosing the delay duration values of the priority-delay in certain classes, it can be seen that a lower priority transmission, using a longer delay compared to a higher-priority transmission using a shorter delay, implicitly grants higher priority to that transmission by never gaining access to the transmission medium before offering the higher priority device an unobstructed opportunity to gain access first.

At step 608, the PAD transmits the message. Next, at step 610, the PAD waits till it receives an acknowledgment from the PROX or DFR that the packet has been correctly received, or until the maximum wait time has expired. If a positive ACK has been received by the PAD at step 612, control returns to step 600 where the PAD waits for the next packet to be sent.

The access mechanism of FIG. 7 uses a single communications channel which, in a shared band, may be occupied by other users or noise. Using a frequency-hopped spread spectrum technique allows the devices to both avoid signal degradation caused by interference that may already be present on the channel, and to avoid causing interference on a channel that is currently busy.

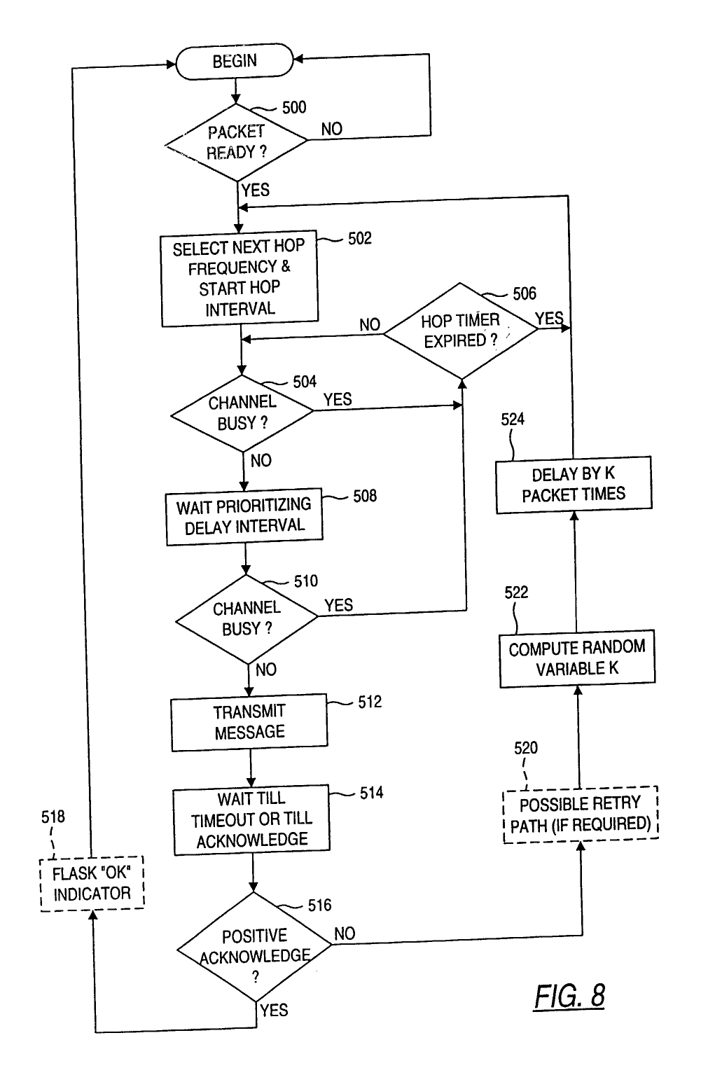

Referring now to FIG. 8, which depicts a flow diagram of the frequency-hopping, prioritizing-delay, persistent CSMA technique, according to this invention. At step 500 the PROX determines whether a packet is ready for transmission. If not, control passes back in a waiting loop to step 500 until a packet is ready. When step 500 is affirmative, the next hop frequency channel is selected at step 502 the PAD and the hop interval timer starts. Next, the device determines whether the channel is busy at step 504. If the channel is busy, the device determines whether the hop timer has expired at step 506. If the hop timer has expired, then control resumes at step 502 where a new hop channel is selected and the hop interval timer is reset. Thus steps 504 and 506 wait for the channel to become idle for up to one hop time.

If the answer to step 504 is negative (channel idle), then the device waits for a if prioritizing delay interval before proceeding at step 508. After this delay, at step 510, the device again determines whether the channel is busy. If the answer to step 510 is affirmative (channel became busy during the wait), control returns to step 506. However, if the channel is still idle at step 510, control proceeds with step 512 where the message is transmitted. Next, at step 514, the device waits until it receives an ACK or until the maximum wait period times out. At step 516, the device determines whether an ACK has been received. If the answer to step 516 is positive, control proceeds to step 518 where a “OK” indicator is flashed on the PAD. Next, control returns to step 500. If the answer at step 516 is negative, then step 520 retransmission is attempted. Next, at step 522, a random variable k is computed. Then, at step 524, the device waits for a delay of k milliseconds. Finally, control returns to step 502. Obvious variants of this scheme include that the there may be separate timers for hop interval (hop dwell time) and busy-channel time-out.

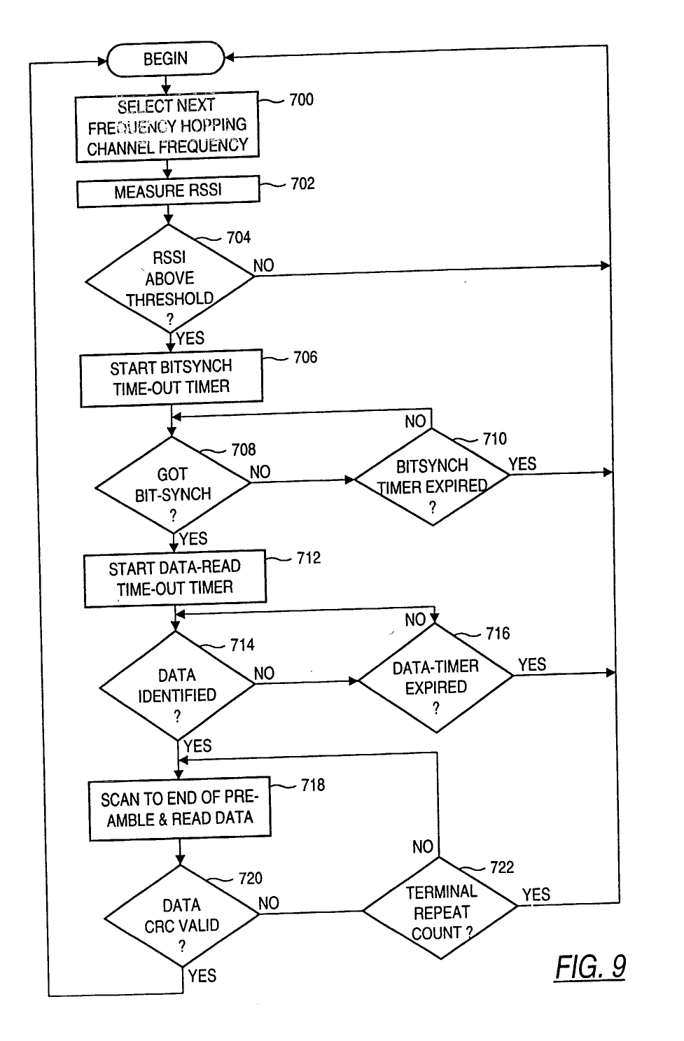

Referring now to FIG. 9, depicting a flow diagram of fast-scanning algorithm used by the PROX and DFR transceivers. The scanning process begins at step 700 where the system measures the received signal strength indication (RSSI) on the next frequency hop channel. At step 702, the system determines whether the RSSI is above a threshold. If the answer is negative (implying an empty channel), the system returns to step 700 to hop to the next frequency. If the answer to step 704 is affirmative, then at step 706 the bit-synch time out timer is started.

Next, at step 708, the system determines whether bit-synch has been detected. If the answer to step 708 is negative (implying noise or incompatible signal modulation in the channel), then at step 710 the device determines if the bit-synch timer has expired. If the answer to step 710 is affirmative, then the system returns to step 700. On the other hand, if the answer at step 710 is negative, then the system returns to step 708, attempting to detect bit-synch till the bit-synch timer expires.

If the answer to step 708 is positive, then the system starts the data read time-out timer at step 712. Next, at step 714, the device determines whether the decoded data is identifiable. If the answer at step 714 is negative, then, at step 716, the system determines whether the data-read time-out timer has expired. If the answer is affirmative, control returns to step 700. If the answer is negative, then control returns to step 714 where identifiable data is searched for until the data-timer expires.

If the answer at step 714 is affirmative, then at step 718 the device scans to the end of the preamble in the data block and reads the data. Next, at step 720, the device determines whether the CRC contained in the data block validates the data. If the answer is affirmative, control returns to step 700. If the answer is negative, then at step 722, the device decides whether a terminal repeat count exists. If the answer at step 722 is negative, then control returns to step 718 where the data is re-read. On the other hand, if the answer to at step 722 is affirmative, then control returns to step 700.

For each empty channel (RSSI output low), the dwell time is very short—typically less than a millisecond. For an occupied channel (RSSI above threshold) with an incompatible transmission (bit synch failed), about 3 to 4 milliseconds is required. In the case of a compatible channel (bit synch obtained), between 10 and 15 milliseconds are required to properly decode the data, depending on when in the PAD transmission the PROX arrives on-channel. Therefore, even under the worst case load on the system, the PROX will have at least five opportunities to detect the confidence test transmission from any particular nearby PAD.

One result of using the access control mechanism of this invention is that all currently active system transmissions in a locality will tend to become accurately “serialized”, avoiding collisions, and allowing the scanning operation of the PROX to accurately decode the data from the PAD's transmission. Also, allowing the PAD to “listen” for a significant interval (a few seconds) for an ACK from the PROX, allows the PROX to use the same access control mechanism and similar data structure to transmit the ACK to the PAD with a very low probability of signal loss due to collision with any interfering signals.

The NMS coordinates operations in the network and can be located at the CCC. The NMS communicates with the PROXs located in all the campus buildings, and the DFRs. The NMS computes the estimated location of an alarm transmission (based on either the signal amplitude information from multiple PROX devices, or from the TOA or AOA information from the DFRs) and communicates that to the CCC. The NMS also keeps track of the system's performance and responds to commands and requests from the command and control center. Additionally, the NMS manages the moment-to-moment operation of the network. The NMS can be located with the CCC or at any remote location The NMS also maintains all the data bases for the network's operation, such as for subscriber records.

The CCC manages logistics of the network. Any and all of the information gathered by the NMS can be accessed and displayed at the command and control center. The NMS holds all network infrastructure databases while the CCC holds all user databases. This includes the location of any active alarms. The CCC displays the location of the PAD sending the alarm signal. The CCC keeps a log of all the PADs performing confidence tests, logging the time and date of each test, as well as the estimated location quality information. Maintenance of the network's data bases are also performed from the CCC.

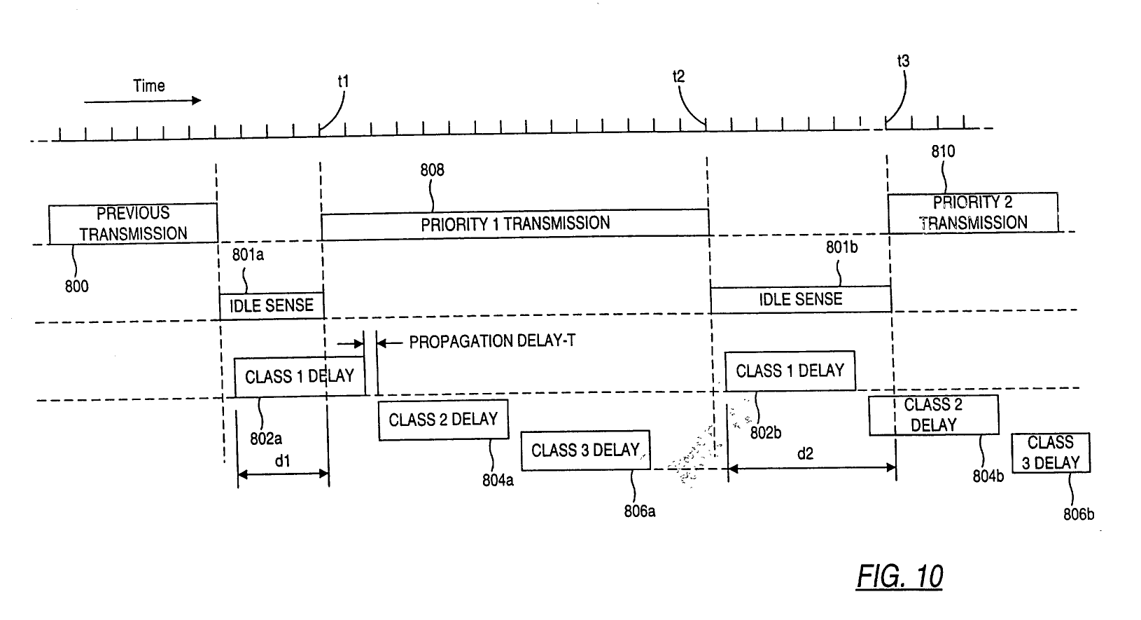

Referring now to FIG. 10, the timeline of the operation of the system is illustrated. After a prior transmission in a time window 800 ends at time to, the receivers in the PROXs and DFRs sense the channel for traffic during time window 801a occurring between times t₀ to t₁.

Different time windows exist for a transmissions having different priorities. Transmissions with the highest priority begin during time windows 802a and 802b; transmissions with medium priority occur during time windows 804a and 804b; and transmissions with the lowest priority are initiated during time windows 806a and 806b. The highest priority transmissions are alarm calls; medium priority transmissions include confidence tests; and low priority transmissions include the sending of telemetry or paging data. Of course, any number of priority classes may be used.

Within time windows 802, 804, and 806, a device waits for a random delay time before beginning a transmission. For example, a transmission with a high priority waits for a random time period d1 in time window 802a before beginning a transmission at time t₁. Then the transmission by a PAD of the high priority transmission occurs during time window 808 between times t₁ and t₂. At time t₂, the PROXs and DFRs begin sensing the signal traffic on the channel again.

The DFRs and PROXs sense the channel's signal traffic in time window 801b between times t₂ and t₃. At time t₃, after waiting for a delay of time duration d2, a medium priority transmission is initiated during time window 804b. The transmission occurs during time window 810 between time t₃ and time t₄.

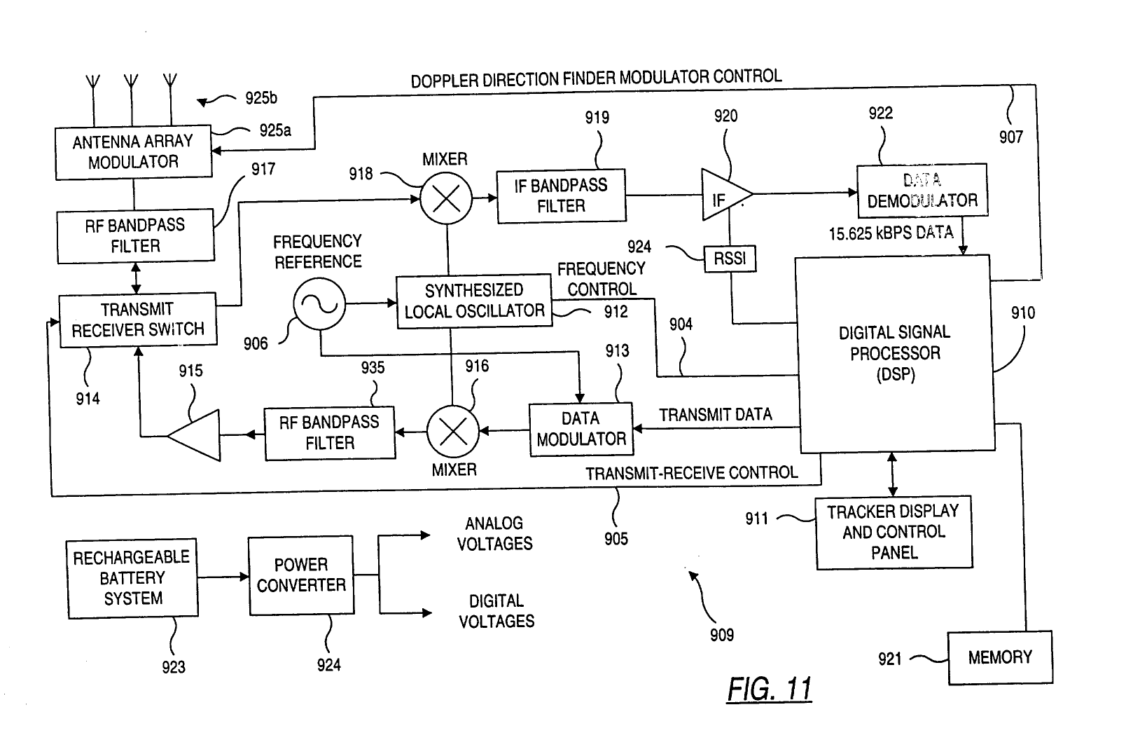

Referring now to FIG. 11, a DFT comprises a digital signal processor (DSP) 9f0 which manages all the activities of the transceiver 909, based on programs stored in a DSP memory 921. The programs implement the prioritized frequency-hopped CSMA communication protocols, the data coding function, the real-time transceiver control activities and interaction with a tracker display and control panel 911. Interaction commands received from the tracker display and control panel 911 are converted into transmission or reception actions by the DSP 910.

To transmit a signal, the DSP 910 initializes a synthesized local oscillator 912 to the desired hop frequency, as required by the frequency-hopping protocol, presents the data to be sent to a modulator 913, switches a transmit/receive (T/R) switch 914 to a “transmit” position (via transmit-receive control signal 905) and applies power to a power amplifier 915. The data is mixed with the signal from local oscillator 912 by a mixer 916, transmitted through a bandpass filter 935 which filters out unwanted signals, and then sent through the amplifier 915. The signal then is then transmitted to an antenna 925c for transmission. Both antennas operate in the 902-928 MHz band.

When the DSP 910 requires reception, it routes signals from the antenna 925b, through antenna array modulator 925a, RF bandpass filter 917, through the T/R switch 914 which is set to a “receive” position (via transmit-receive control signal 905), the RF signal is mixed down to the desired intermediate frequencies of 45 MHz and 455 KHz at double mixer 918 by a signal from the synthesized local oscillator 912 (which is supplied with a frequency reference 906), applied through a IF bandpass filter 919 and amplifier 920, where the signal absolute signal strength is estimated by calibrated RSSI circuitry, and on to the demodulator 922 where it is processed to yield a 15.625 kBPS data signal. The data is then decoded by the DSP 910, and further action is determined according to the stored programs in the DSP memory 921.

As with the DFR, the antenna 925b and its accompanying modulator 925a is a pseudo-Doppler direction-finder antenna array with complimentary control and angle of arrival software in the DSP. In the case of the DFT, the transmit function is used only for direction-finder calibration and network interaction purposes, and so the transmitter is connected to the transmitter receiver switch 914. The modulator 925a is controlled by a Doppler direct finder modulator control signal 906 from the DSP 910. Alternatively, a front-to-back ratio can be derived and used to determine location.

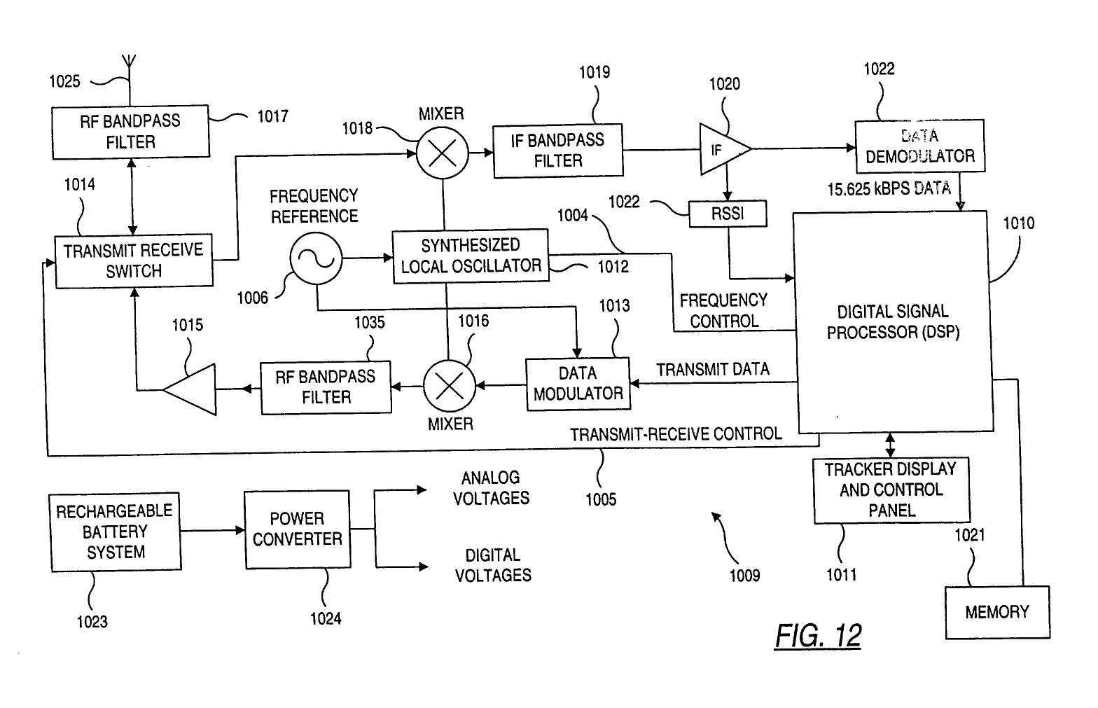

Referring now to FIG. 12, in an alternate embodiment a DFT comprises a digital signal processor (DSP) 1010 which manages all the activities of the transceiver 1009, based on programs stored in a DSP memory 1021. The programs implement the prioritized frequency-hopped CSMA communication protocols, the data coding function, the real-time transceiver control activities and interaction with a tracker display and control panel 1011. Interaction commands received from the tracker display and control panel 1011 are converted into transmission or reception actions by the DSP 1010.

To transmit a signal, the DSP 1010 initializes a synthesized local oscillator 1012 to the desired hop frequency, as required by the frequency-hopping protocol, presents the data to be sent to a modulator 1013, switches a transmit/receive (T/R) switch 1014 to a “transmit” position (via transmit-receive control signal 1005) and applies power to a power amplifier 1015. The data is mixed with the signal from local oscillator 1012 by a mixer 1016, transmitted through a bandpass filter 1035 which filters out unwanted signals, and then sent through the amplifier 1015. The signal then is then transmitted through the T/R switch 1014 (which is in the “transmit” position), through a RF bandpass filter 1017 which deletes any unwanted noise, and, finally, to an antenna 1025 for transmission. The antenna transmits and receives signals in the 902-928 MHz band.

When the DSP 1010 requires reception, it routes signals from the antenna 1025b, through antenna 1025, RF bandpass filter 1017, through the T/R switch 1014 which is set to a “receive” position (via transmit-receive control signal 1005), the RF signal is mixed down to a 45 MHz and 455 KHz intermediate frequencies at double mixer 1018 by a signal from the synthesized local oscillator 1012 (which is supplied with a frequency reference 1006), applied through a IF bandpass filter 1019 and amplifier 1020, where the signal absolute signal strength is estimated by calibrated RSSI circuitry, and on to the demodulator 1022 where it is processed to yield a 15.625 kBPS data signal. The data is then decoded and the signal strength estimates processed by the DSP 1010, and further action, such as information display and control panel interaction, is determined according to the stored programs in the DSP memory 1021.

Thus, a low interference-potential mechanism for multiple access by unsynchronized locator-transceivers using the frequency hopping techniques required for band-use is provided. Interference is significantly reduced while operating in the ISM band, which enhances communication reliability. A reliable spread-spectrum signaling technique is provided for tracking the location of the transceiver with a simple mechanism for prioritizing access of different classes of transmission. The system quickly and reliably locates people using the radio-transceiver and allows security personnel to quickly come to the aid of people who experience a threat to their personal safety anywhere in or near a campus or similar environment. A device is provided which transmits an identification signal that can be remotely located and tracked with enough precision for security personnel to quickly come to their aid. The system is reliable, robust, and user-friendly and offers an on-demand confidence-test feature. Interference is effectively managed or controlled or avoided, thereby ensuring communications-reliability , while still maximizing the throughput of the system which uses of a number of different wireless locating technologies and shared transmission bands.

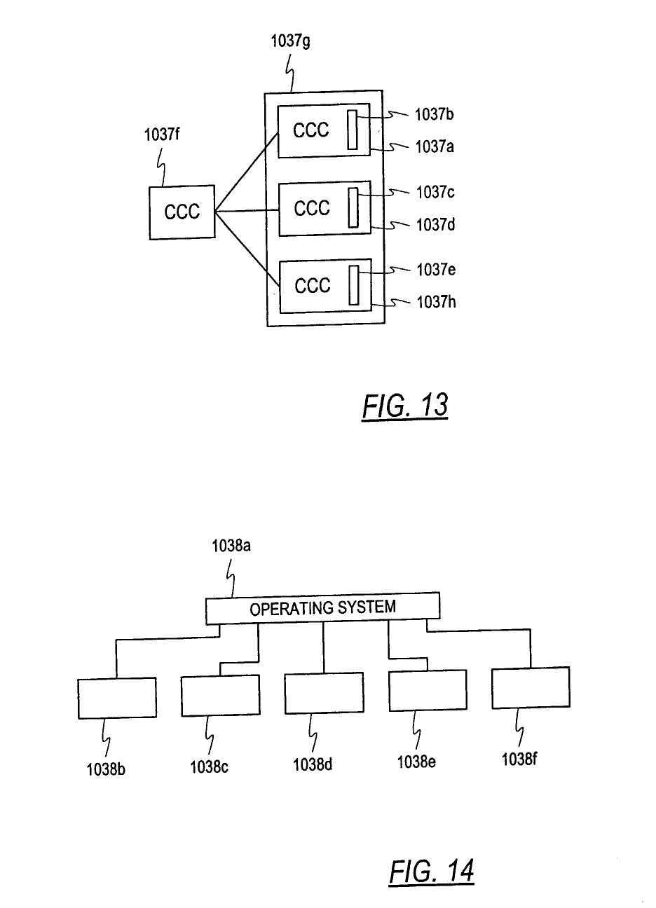

Referring now to FIG. 13, the user interacts with a Command and Control System 1037g at CCCs 1037a, 1037d, and 1037h via user interfaces 1037b, 1037c, and 1037e, respectively. The user interfaces include functional units which allow the system to display information and interact with the user. These functional units include a Subscriber Management Utility, a paging server, network management utility, command and control console, and the alarm tracking console.

In one embodiment of the present invention, the CCCs 1037a, 1037d, and 1037h are networked computer clients running an operating system, for example, the Microsoft Windows NT operating system. A client-server model is supported so that a campus can support one or more CCCs, each connected via a network to a single Network Control Computer (NCC) 1037f.

Referring now to FIG. 14, the CCC software system consists of five applications: a Subscriber Management Utility 1038b; a Network Management Utility 1038c; an Alarm Tracking Console 1038d; a Paging server 1038e; and a Database Management Utility 1038f overseen by an operating system 1038a.

The Subscriber Management Utility (SMU) 1038b is a database front-end tool for the system. The SMU 1038b application is used to manage subscribers, asset items, and to translate data from alternative database formats into the format used by the system.

The Network Management Utility (NMU) 1038c is a graphical tool that is used to manage and configure the system. The NMU 1038c displays a graphical network tree that contains all of the discovered devices on the network. A mapping feature enables the user to position devices on a campus map and to define regions for the map. In addition, the NMU 1038c can be used as a maintenance tool to fine-tune the devices on the network.

The Alarm Tracking Console (ATC) 1038d is used to monitor and track alarms on the system. The ATC 1038d graphically displays alarms in progress, subscriber information, and maintains an animated position track of a subscriber.

The Paging Server (PS) application 1038e is a network service application that provides a paging capability to any application on the system. An application can become a client to the PS 1038e and send messages to it over a network. Once received by the PS 1038e, the messages are sent via modem, to a paging gateway. Maintenance alert messages as well as subscriber alarm messages can be sent to one or more alphanumeric pagers.

The Database Management Utility (DMU) 1038f is a tool that is used to manage the archiving of old data in the system database.

The Subscriber Management Utility

As described above, the Subscriber Management Utility (SMU) is the database front-end tool for the system. The SMU application manages subscribers, manages system assets, and performs database translation. The SMU application is highly portable and can be used on a notebook computer with a smaller screen resolution of 800×600 pixels as well as on a desktop computer with 1024×768 pixel resolution. In addition, the application can be used with any conventional operating system, for example the Microsoft Windows 95 operating system.

The SMU is used to add and modify subscribers' records in the system via an on-screen data entry form. A subscriber represents an individual that has a Personal Alarm Device (PAD). Each PAD in the system is “owned” by only one person. A subscriber record consists of a unique subscriber ID (typically a Social Security number); subscriber name; subscriber category (student, officer, teacher, etc.); contact information (i.e. primary and secondary addresses, phone numbers, etc.); physical description (sex, height, build, hair color, eye color, etc.); photograph; emergency contact; and unique PAD ID. The SMU application prevents duplicate subscribers from being entered into the database. In addition, the application ensures that no other subscriber currently has a PAD with the same ID number.

The SMU is used to add and modify asset records in the system via an on-screen data entry form. An asset is a piece of equipment or other inventory item that has an Asset Alarm Device (AAD). Each AAD in the system is “owned” by only one inventory

item. As asset record contains a unique asset ID (such as an inventory control code); the asset category; asset description; serial number; owning department; location description; contact information (name and phone numbers of responsible party); photograph; and unique AAD ID.

The SMU application is also responsible for database translation. It will be necessary, in most cases, to translate a campus's existing database data from its native format into the database format. Since there are a multitude of database formats in use, there is no standard format that can be used. As a result, the SMU is designed to use translation modules that can be installed into the application at any time. A translation module is a separate program that is designed to translate data from one database format into another database format. The translation module is encapsulated into a Windows Dynamic Link Library (DLL) that can be linked at run-time into the SMU application. The SMU application, as a result, does not need to know anything about the translation module.

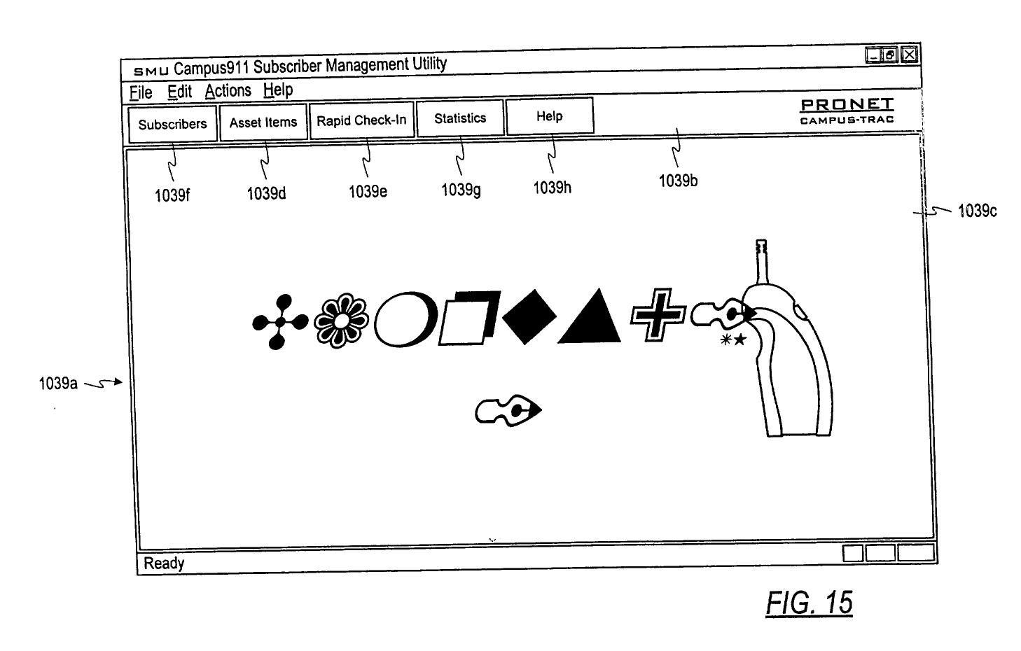

Referring now to FIG. 15, a screen 1039a contains a toolbar 1039b across the top of an applications window 1039c. The toolbar, when activated (“pulled down”), comprises several buttons. An asset items button 1039d displays an asset form in the application window. A rapid check-in button 1039e displays the rapid check-in form in the application window. A subscribers button 1039f displays the subscriber form in the application window. A statistic button 1039g displays the statistics dialog box in the application window. Finally, a help button 1039h displays the on-line help window.

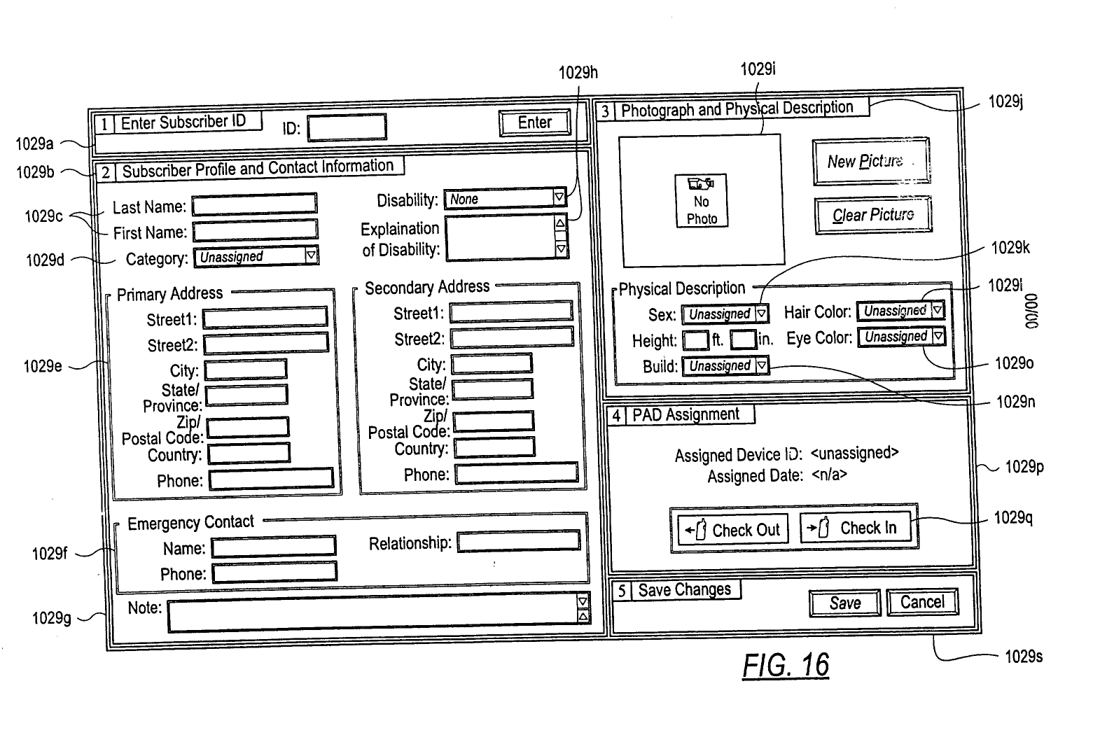

The user can display the subscriber form by pressing the subscribers button on the toolbar, or by selecting “Subscribers” from the ACTIONS menu. Referring now to FIG. 16, the subscriber form window is designed to look like a paper form.

A subscriber ID section 1029a is used to select which particular subscriber to display. Once the user enters a subscriber ID and presses the ENTER key (or the Enter push-button), the record is retrieved from the database and its contents are displayed on the form. If a record with the entered subscriber ID is not found, the user has the option to create a new record.

A subscriber profile and contact information section 1029b contains a subscriber name (first and last) field 1029c; a subscriber category (student, officer, teacher, etc.) field 1029d; address field 1029e; disability and description of disability field 1029h; contact information (i.e. primary and secondary addresses, phone numbers, etc.) field 1029e; emergency contact (name, phone, and relationship) section 1029f; and miscellaneous notes section 1029g.

A photograph and physical description section 1029j contains a photograph field 1029i; a sex field 1029k; a height field 1029m; a build field 1029n; a hair color field 1029l; and an eye color field 1029o.

Finally, the form displays a PAD assignment field 1029p with a check-out button 1029r and a check-in button 1029q. A save changes field 1029s also a user to save changes which they have included in the form. The PAD Assignment section contains an assigned device field which indicates the Personal Alarm Device (PAD) identification number. If no PAD is assigned, “<unassigned>” will be displayed. The section also includes the assigned date which is the date that the PAD was assigned. If no PAD is assigned, “<none>” will be displayed. The check-in and check-out buttons are used to check in a previously checked-out PAD, and to check out a new PAD to a subscriber. If a PAD is already assigned for a subscriber, the check-out button will be disabled since only one PAD can be checked out for a single subscriber. Similarly, if a PAD is not assigned to a subscriber, the check-in button is disabled. Once a PAD has been checked out, the assigned device and assigned date fields on the form will change to reflect the new information. When a PAD is checked-in, these fields will be cleared.

The save changes section contains two buttons: “Save” and “Cancel.” When the user presses the save button, the subscriber form is saved to the database. Pressing the cancel button will cancel all of the changes that were made (if any) and will close the subscriber form.

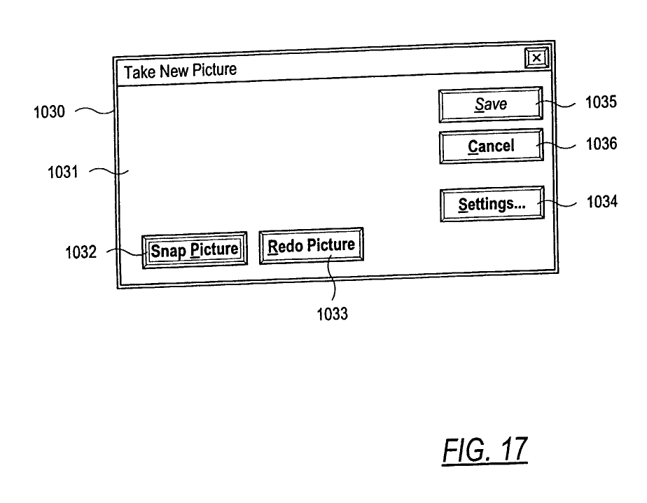

The SMU application is designed to capture a photograph from a capture adapter, for example the Snappy(TM?) adapter manufactured by ______. The adapter can input a video signal from a NTSC-compatible output device, such as a video camera. To take a new picture, the user presses the new picture button. Referring now to FIG. 17, a “Take New Picture” dialog box 1030 will appear on the CCC screen. The dialog box 1030 will display a live video feed 1031 from the NTSC video source. A snap picture button 1032 takes a snapshot of the current video display. The image will freeze-frame and will display in color. A redo picture button 1033 resets the video capture process. Live video will display in the dialog box. A settings button 1034 displays the Snappy camera control settings. The camera input's brightness, contrast, sharpness, tint, red, green, and blue settings can be adjusted. The window also contains a save button 1035 and a cancel button 1036.

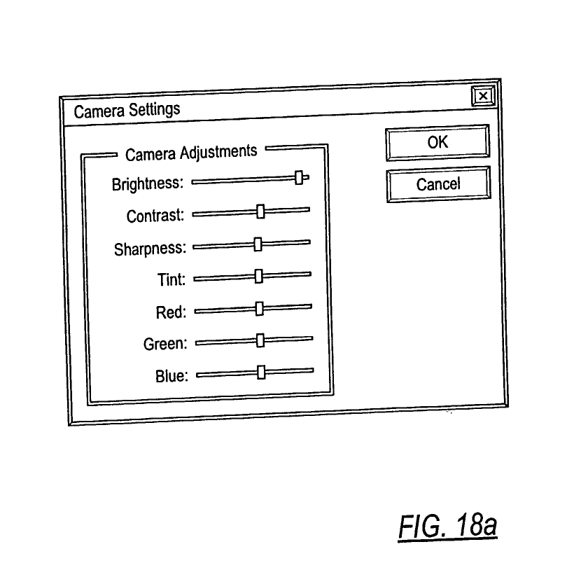

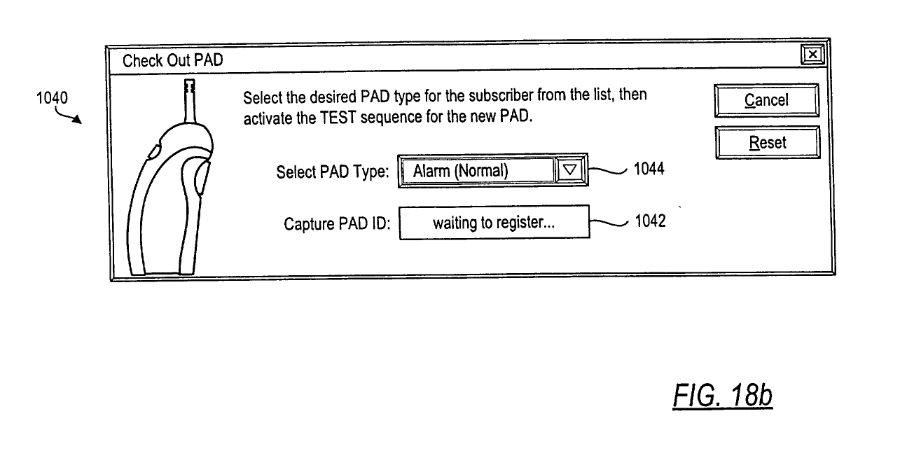

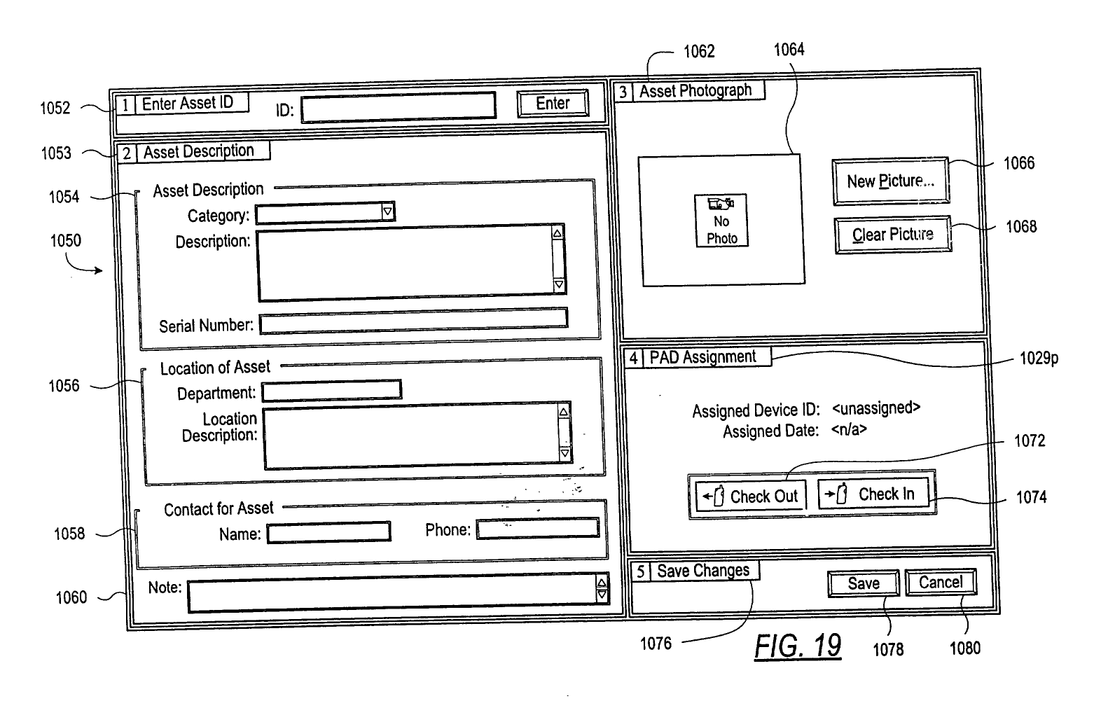

When the user presses the check-in button, the “Check-Out PAD” dialog box will be displayed on the screen. Referring now to FIG. 18, a check-out PAD dialog box 1040 contains a PAD-type field 1042 and a capture PAD ID field 1044. The PAD type dropdown list box 1040 contains an alarm option which is the normal subscriber alarm PAD. The field includes a watchman PAD option which is used by an officer to “mark” their rounds on campus. The watchman PAD positions are stored in the database. Finally, the dropdown box contains a maintenance PAD option which is used to troubleshoot and tune the network.

The Capture PAD ID displays the captured PAD ID during the registration process. The dialog box contains the reset button. Pressing this button restarts the registration process. Once the registration completes, the dialog box will automatically close and the subscriber form will be updated with the new information.

Referring now to FIG. 19, an asset item form 1050 is used by the user to display the asset item form by pressing the asset items button on the toolbar, or by selecting “asset item” from the ACTIONS menu.

This section is used to select the asset item record to display. Once the user enters an asset ID and presses the ENTER key (or the Enter push-button) the record is retrieved from the database and its contents are displayed on the form. If a record with the entered asset ID is not found, the user has the option to create a new record.

An asset description section 1053 contains an asset description section 1054 subscriber (including category, description, serial number), a location of the asset section 1056 (including owning department, location description), and a contact information section 1058 (consisting of name and phone number of responsible party).

The asset item form also contains an asset photograph section 1062. The SMU application is designed to capture a photograph from a capture adapter (described above). The adapter can input a video signal from an NTSC-compatible output device, such as a video camera. To take a new picture, the user presses the new picture button.

The form 1050 also includes a PAD assignment section 1070 which contains an assigned device field and an assigned date field. The assigned device field displays the Asset Alarm Device (AAD) identification number. If no AAD is assigned, “<unassigned>” will be displayed. The assigned date field includes the date that the AAD was assigned. If no AAD is assigned, “<none>” will be displayed. A check-in button 1072 and check-out button 1074 are used to check in a previously checked-out AAD, and to check out a new AAD to an asset. If a AAD is already assigned to an asset, the check-out button 1072 will be disabled since only one AAD can be checked out for a single asset item. Similarly, if an AAD is not assigned to an asset, the check-in button 1074 is disabled. Once an AAD has been checked out, the assigned device and assigned date fields on the form will change to reflect the new information. When an AAD is checked-in, these fields will be cleared. When the user presses the check-in button 1074, the check-out AAD dialog box will display on the screen.

The form 1050 also includes a save changes section 1079 which contains a save button 1078 and a cancel button 1080. When the user presses the save button 1078, the asset item form is saved to the database. Pressing the cancel button 1080 will cancel all of the changes that were made (if any) and will close the form.

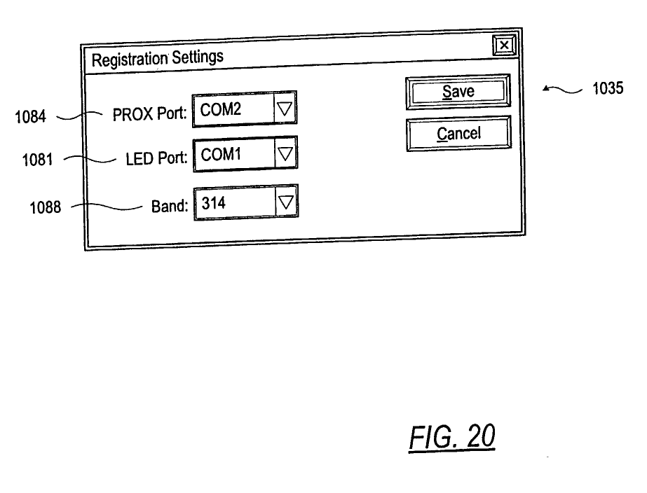

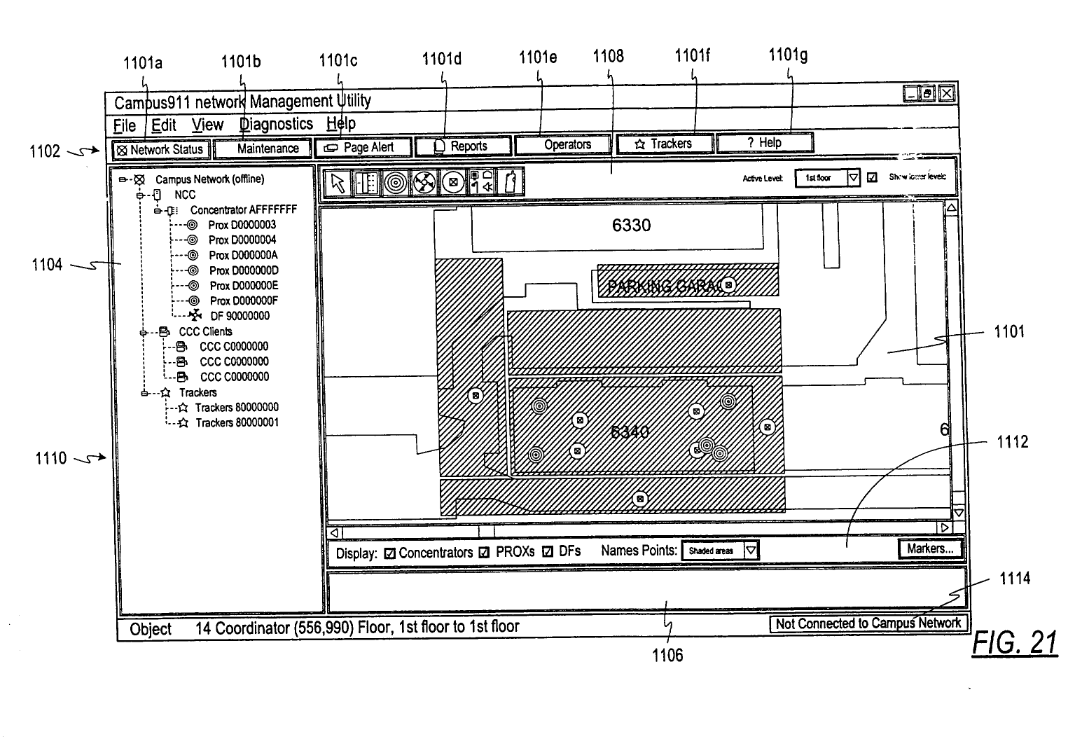

Finally, a registration settings box 1082 provides some user selectable options for registration. Referring now to FIG. 20, the box contains the following options: A PROX port field 1084 selects where the communications port that the registration PROX is connected to on the computer. The options are NONE, COM1, COM2, COM3, COM4. A LED port field 1086 selects where the communications port that the registration LED reader is connected to on the computer. The options are NONE, COM1, COM2, COM3, COM4. The band selection list 1088 contains a list of RF bands. The options are (314, 316, 318). Pressing a save button 1090 will save any changes that were made. A cancel button 1092 will close the dialog box and not save any of the changes made.

The Network Management Utility

The Network Management Utility (NMU) is a graphical tool that is used to manage and configure the network. The NMU displays a graphical network tree that contains all of the discovered devices on the network. A mapping feature enables the user to position devices on a campus map and to define regions for the map. In addition, the NMU can be used as a maintenance tool to fine-tune the devices on the network.

Referring to FIG. 21, the tool comprises a main window 1100 including an application tool bar 1102. The tool bar 1102 contains a network status button 1101a which displays a network device tree 1104; a maintenance button 1101b which displays the network maintenance tree; a page alert button 1101c which displays the page alert dialog box for sending pages; a reports button 1101d which displays the report manager dialog box to print reports; an operators button 1101e which displays the operator dialog so that operators can be added, modified, or deleted from the system; a tracker button 1101f which displays the tracker dialog box to add and remove hand-held trackers from the system; and a help button 1101g which displays the on-line help for the application. A campus map 1110 is also displayed as is a map-view options bar 1112 and a network connection status bar 1114.

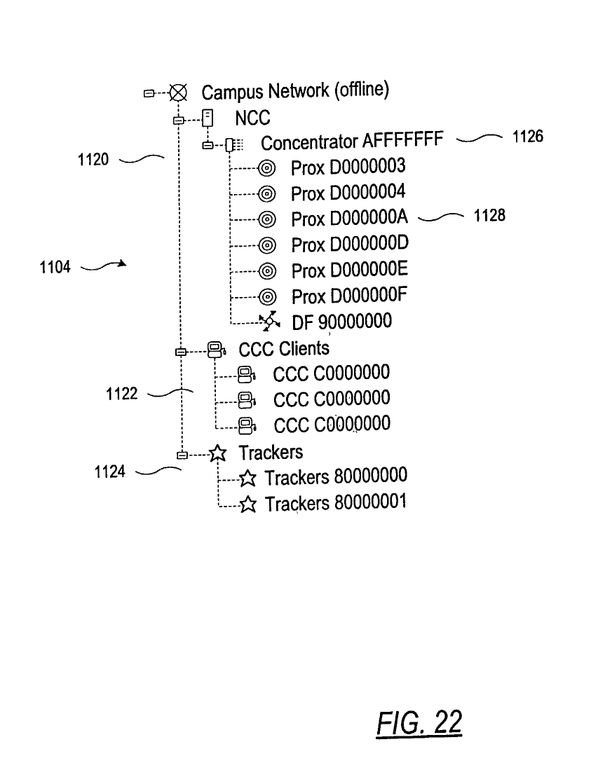

Referring now to FIG. 22, the network device tree 1104 displays all of the discovered network devices in a graphical tree structure. All network devices are organized in a parent-child relationship. For example, all PROXs and DFRs that are connected to a particular concentrator appear as subordinates to the concentrator label in the list.

An icon is associated with each type of network device in the network tree 1104. For example, an icon 1120 represents the NCC, icons 1122 represent installed clients, icons 1124 represent installed trackers, icons 1126 represent a single concentrator, and icons 1128 represent PROXs and DFRs. In addition, the icon can represent whether the device is functioning normally, or if it is in error. Each icon and label in the network tree represents a device in the network. Information about each device can be obtained by double-clicking with the left mouse button on the label in the tree.

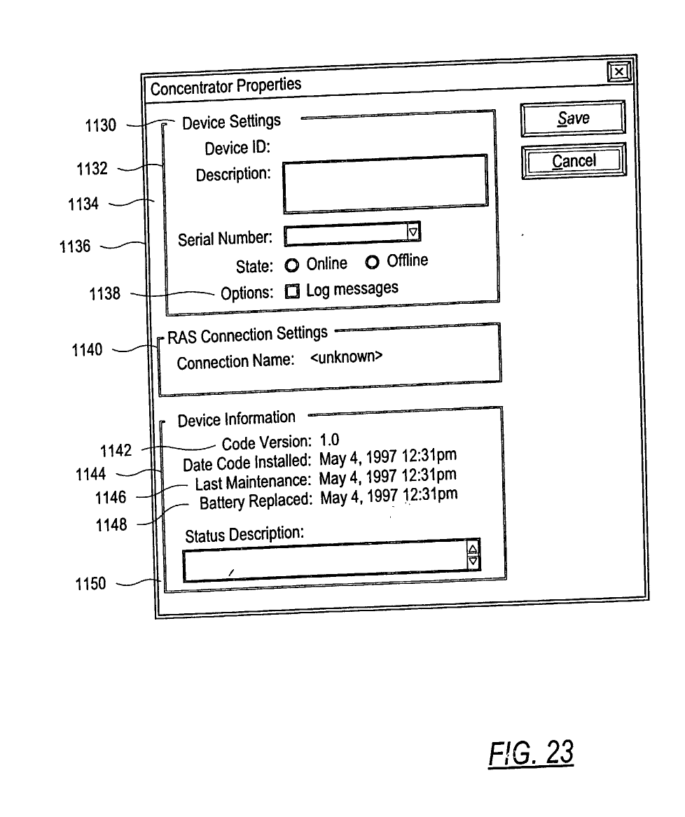

Referring now to FIG. 23, the concentrator property dialog box contains current information about the selected concentrator. The concentrator properties dialog box contains a device ID 1130 which is the unique internal identification number for the device. This number is automatically detected during device discovery. The box also comprises a location field 1132 which is a textual description used for maintenance purposes describing the physical location of the device; a map level field 1134 which is the map floor level where the device is located. The box also includes a state field 1136 which is the current online/offline device state. The user can select the desired state and a change notification will be sent to the NCC computer requesting the change. The CCC will be informed later by the NCC if the status change was successful. An options field 1138 allows the user to choose to log all message sent by the concentrator. The RAS connection settings field 1140 is the name of the RAS connection label in the RAS manager. A code version field 1142 shows the current firmware code version. The date code installed field 1144 indicates the date and time of the code installation in the device. A last maintenance field 1146 indicates the date and time of the last maintenance on the device. A battery replaced field 1148 shows the date and time that the internal backup battery was replaced. A status description field 1150 gives a textual description of the device's current state.

The PROX property dialog box is similar in appearance and content to the concentrator dialog box and contains the current information about the selected PROX. The PROX properties dialog box contains the following fields. A device ID field is the unique internal identification number for the device. This number is automatically detected during device discovery. A location field is a textual description used for maintenance purposes describing the physical location of the device. A map level field indicates the map floor level that the device is located. A state field shows the current online/offline device state. The user can select the desired state and a change notification will be sent to the NCC computer requesting the change. The CCC will be informed later by the NCC if the status change was successful. An options field relates to the fact that each PROX can support up to two external peripherals: “A” and “B.” The user can enable/disable these peripherals. A code version field shows the current firmware code version. A date code installed field indicates the date and time of the code installation in the device. A last maintenance field shows the date and time of the last maintenance on the device. A parent concentrator field shows the device ID of the concentrator that the device is connected to. A status description field gives a textual description of the device's current state.

The DFR property dialog box is similar to the PROX and concentrator boxes and contains current information about the selected DFR. The DFR properties dialog box contains the following fields. A device ID field shows the unique internal identification number for the device. This number is automatically detected during device discovery. A location field gives a textual description used for maintenance purposes describing the physical location of the device. A map level field shows the map floor level where the device is located. A state field indicates the current online/offline device state. The user can select the desired state and a change notification will be sent to the NCC computer requesting the change. The CCC will be informed later by the NCC if the status change was successful. A GPS position field shows the true longitude and latitude position for each DFR. The user must enter these values. A code version field indicates the current firmware code version. A date code installed field indicates the date and time of the code installation in the device. A last maintenance field shows the date and time of the last maintenance on the device. A parent concentrator field shows the device ID of the concentrator that the device is connected to. Finally, a status description field gives a textual description of the device's current state.

The CCC property dialog box which contains the current information about the selected CCC is similar to the boxes described above having device settings and device information fields. Specifically, a device ID field shows the unique internal identification number for the device. This number is automatically detected during device discovery. A host name field indicates the network host name for the machine. A code version field shows the current software code version. A date code installed field indicates the date and time of the code installation in the device. A last maintenance field shows the date and time of the last maintenance on the device. A status description field gives a textual description of the device's current state.

The tracker property dialog box is also similar to the above-described boxes and contains current information about the selected tracker. The tracker properties dialog box contains the following information fields. A device ID field shows the unique internal identification number for the device. This number is automatically detected during device discovery. The tracker number field indicates the simple tracker number assigned to the tracker. The code version field shows the current software code version. The date code installed field indicates the date and time of the code installation in the device. The last maintenance field shows the date and time of the last maintenance on the device. The battery replaced field indicates the date and time of the last battery replacement. The status description field gives a textual description of the device's current state.

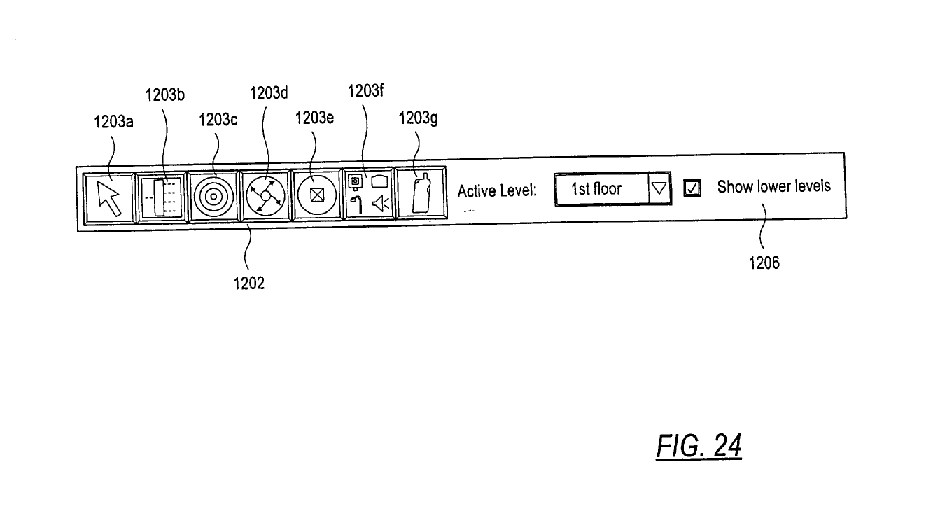

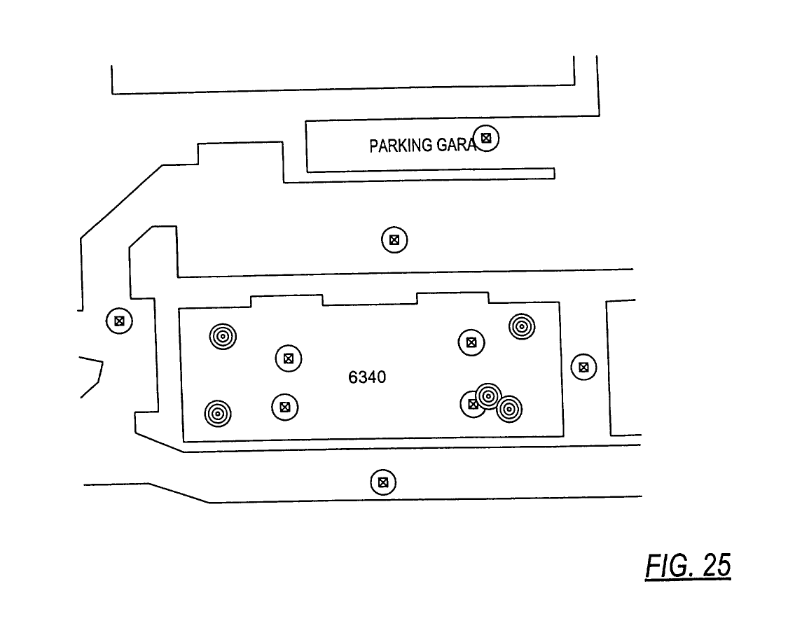

Referring now to FIG. 24, a map tool bar 1200 is used to manipulate the campus map. Using the tool bar 1200, the user can place device objects on the map, move them on the map, and delete them from the map. In addition, the user can manipulate the object on different “floor” planes of the map.

The map tool bar contains the following components: a map object tools section 1202, an active floor level section 1204, and a floor display filter section 1206.

The following is a list of the map object tools and their functions. An arrow tool 1203a is used to select objects on the map. Once an object is selected, the user can display the properties for the object, move the object, delete the object, and change the shape of certain objects on the map.

A concentrator object tool 1203b enables the user to place a concentrator on the map. Placing a concentrator on the map is only useful for maintenance reasons. If a concentrator should be in an error state, a maintenance person can quickly find the physical location of the device.

A PROX object tool 1203c enables the user to place a PROX on the map. The position and floor settings of the PROX may be used in alarm position calculations. A DF object tool 1203d enables the user to place a DF on the map. The position and floor settings of the DF may be used in alarm position calculations. A name point tool 1203e enables the user to define a region on the map and give it a text description. In addition, the user can specify the validity of the region on a floor-by-floor basis. For example, a region can be on a single floor, a range of floors, or all floor levels on the map.

A special network device object tool 1203f is a special network device object tool and enables the user to place a special network device on the map. Placing this device on the map is only useful for maintenance reasons. If a device should be in an error state, a maintenance person can quickly find the physical location of the device.

A PAD simulator tool 1203g is used to simulate the position of a PAD on the map. A position description will be displayed by the NMU in the diagnostic display area for the user to use to help in adjusting the layout of the network devices on the map.

The active floor level list box 1204 enables the user to select the floor view for the campus map. Network devices can be placed on different levels. Name point zones can be placed on a single floor, or can span floors.

The floor display filter 1206 is used to enable and disable the display of network devices that are on floor levels below the current floor. When the show filter is selected, devices below the current level are displayed in a different color from the devices that are on the current level of the map. When the show filter is deselected, only the devices on the current level are shown.

Referring now to FIG. 25, a portion of a map displaying network devices for the current floor and devices that are below the current floor is illustrated.

The campus map area displays a graphic map. Since a map may be larger than the map display area, the user can scroll the map into view with horizontal and vertical scroll bars. The user uses the map to position network devices. The placement of the network devices affects the position calculation done during an alarm track. The user uses the map tool bar and the map view options to manipulate the map.

The user can place network device objects on the map by first selecting the desired object tool on the map tool bar and then clicking on the map at the location to place the object.

A name point zone does not represent a network device, but rather a logical name for a map region. The user can draw a rectangular region with the name point zone tool and define that area.

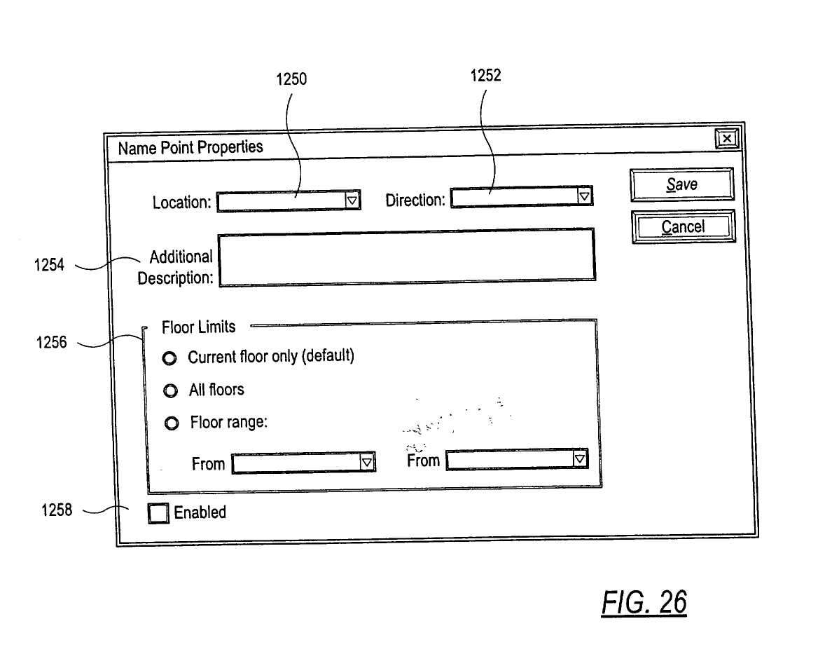

Referring to FIG. 26, a name point properties dialog box appears when the user draws a region and contains the following components. A location field 1250 is a dropdown list box of locations that were previously defined for the campus map. A direction field 1252 indicates the direction associated with the name point (north, south, east, west, etc.). An additional description field 1254 is any additional text to describe the location. A floor limits area 1256 is the name point and can be valid on the current floor (i.e. the floor that it was created), valid on all floors, or valid only on a range of floors. An enabled field 1258 is the name point and can be enabled or disabled. If a name point is disabled, it will not be considered in an alarm track solution.

The user can retrieve information about an object on the map by double-clicking on the object with the mouse to display the device's property information dialog box. Any object that has been placed on the map can be quickly located using the device network tree. The user first right-clicks the mouse on the particular device in the tree to find the location on the map; a short context menu will appear. The user then selects the “Find on map” option in the context menu and the map will automatically move to the object's location and floor.

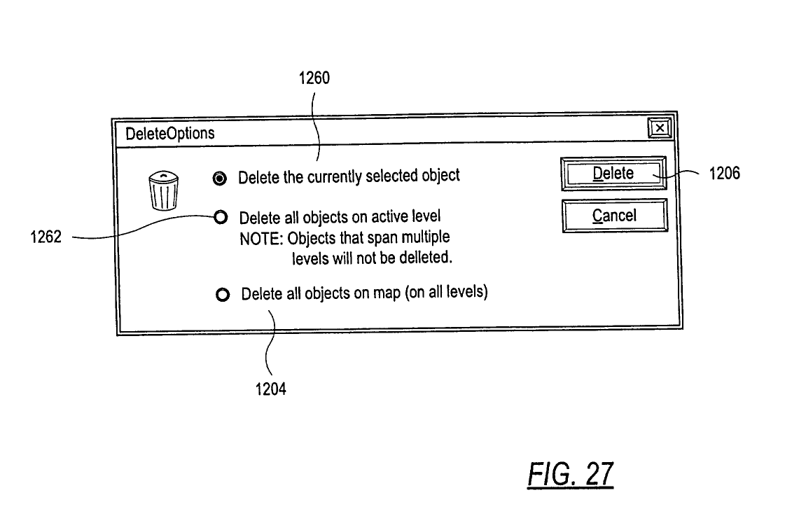

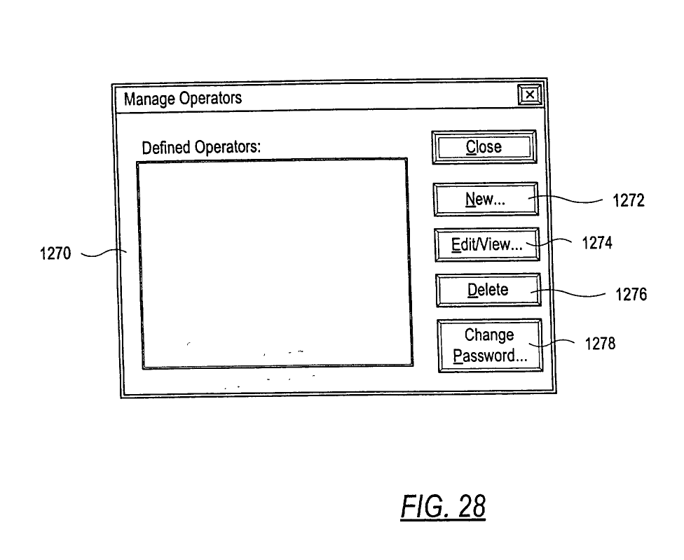

The user can delete a single object from the map, delete all objects on the current map floor level, or can delete all objects on all floors of the map. To delete a single object, the user must first select the object with the Arrow tool in the map tool bar. Then the user can press the DELETE key on the keyboard, or right-click on the object to display a short context menu. The user can select the delete option in the context menu. To delete all of the objects on the current floor or all objects on the map regardless of floor, the user can simply press the delete key without any object being selected. Once the user has given the delete command, the delete options dialog box will appear (see FIG. 27) to prompt the user.

If a single object is selected, the currently selected object option 1260 is designated. If no object is selected, the user can choose either delete all objects on active level option 1262 or delete all objects on map option 1264. To complete a delete operation, the user must press the delete push-button 1266.

The map view options enable the user to change the view of the campus map. One group of options is the display options. The map display options are used to show or hide images on the map. The following display options are provided. A concentrators option enables and disables the displaying of concentrator images on the map. A PROXs option enables and disable the displaying of PROX images on the map. A PFRs option enables and disables the displaying of DF images on the map. A name points option enables the user to display all name point zones on the map as a shaded area or as single point representation. In addition, the user can choose to completely hide the display of name points on the map.

The navigation marker option enables the user to give a particular map position a name. That name can be used to quickly jump to the map position. This is useful when dealing with a large complicated map. Using the markers dialog box, the user can add a new description based on the current map position, or can select from previously defined map locations and the map will be moved to that location. The markers dialog box contains a component to add to this list which allows a user to add the new location to the list of defined locations. This description will be available for the user to choose from at any time. A show option is used if an entry is highlighted in the location to move the map to the defined location. A delete option is used if an entry is highlighted in the location list and the delete push-button will permanently remove the entry from the list.

The diagnostic display will display all maintenance information. The Network status bar displays the current Network Control Computer (NCC) connection status. If the NMU is currently connected, the status bar displays “Connected to Campus Network.” Otherwise, the status bar displays “Not Connected to Campus Network.” Users gain access to the software on the CCC system by having user accounts and access privileges. The NMU application enables an administrator to create and manage users and to assign access rights to CCC functions. All of the users of the CCC system are called operators. To manage the operators in the system, the user selects “Operators” in the MANAGE menu.

Referring to FIG. 28, a manage operators dialog box contains a defined operators field 1270 which is a list of operator names already in the system. A new button 1272 creates a new operator. An edit/view button 1274 views or modifies an existing operator. A delete button 1276 omits an operator from the system. A change password button 1278 changes the password for an operator.

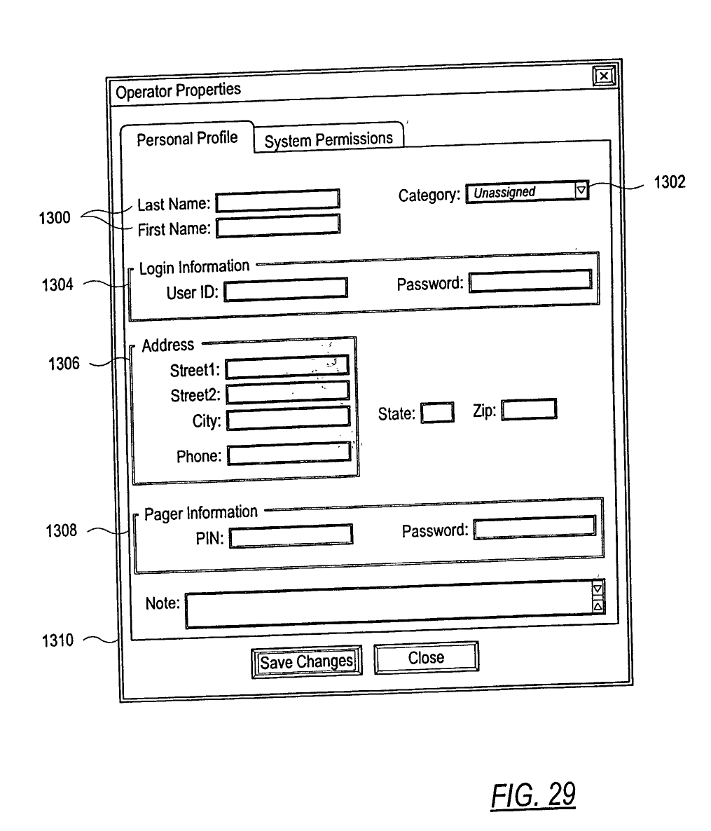

Each operator in the system has a personal information profile and a system permissions profile. FIG. 29 shows the personal profile dialog for an operator. The personal profile dialog box contains a name field 1300 which represents the operator's first and last name. A category field 1302 shows the operator category (administrator, maintenance, officer, clerk, etc.). A login information field 1304 lists the login ID and password assigned to the operator. An address field 1306 shows the operator's street address and phone number. A pager information field 1308 indicates the pager PIN and password for system paging. A miscellaneous note field 1310 contains additional notes concerning the operator.

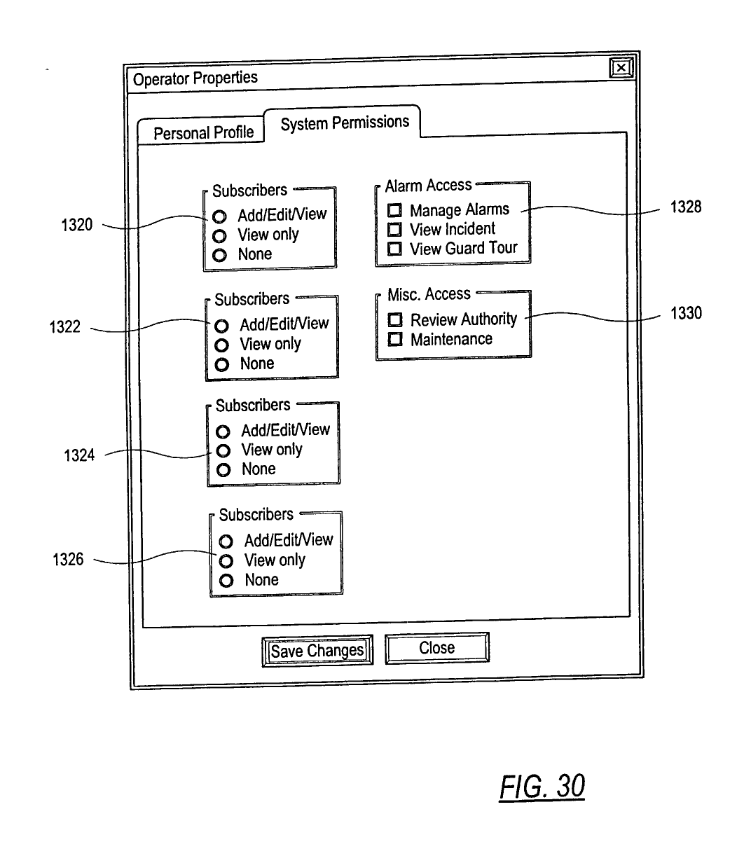

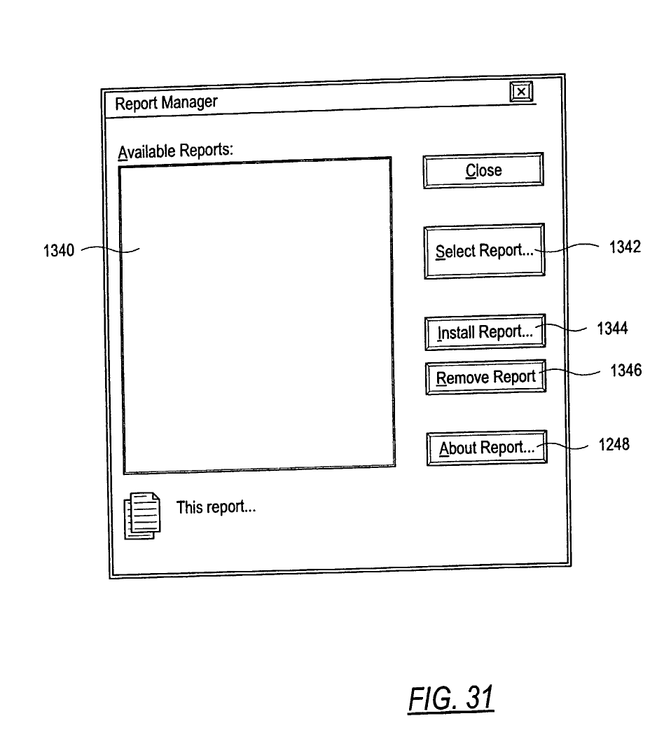

Referring to FIG. 30, a system permissions dialog for an operator is illustrated and contains a subscribers field 1320 indicating if the operator can be allowed add/edit/view access, view only, or no access to subscribers. An operators field 1322 indicates if the operator can be allowed add/edit/view access, view only, or no access to operators. A trackers field 1324 indicates if the operator can be allowed to assign/view, view, or no access to tracker assignments. A reports field 1326 indicates if the operator can be allowed add/remove/print, print only, or no access to reports. An alarm access field 1328 indicates access to alarms, incident histories, or guard tours can be enabled or disabled. A miscellaneous access field 1330 indicates if an operator can be assigned review authority over an incident. In addition, an operator can be given maintenance privileges.

To quickly change a password for an operator, the user first selects an operator from the operator list and then presses the change password push-button. The change password dialog box contains a current password field 1278 which indicates that the user must enter the current operator password. A new password field which indicates that the user must enter the new operator password. A verify password field indicates that the user must re-enter the new operator password to verify the password change.

The user can print reports from the Network Management Utility (NMU). To display the list of installed reports, the user can press the reports application tool bar button, or select “Report Manager” from the VIEW menu.

Referring now to FIG. 31, a report manager dialog box contains an available reports field 1340 which is a list of installed reports. As the user highlights entries in the list, a description for the selected report is shown at the bottom of the dialog box. A select report field 1342 executes the report highlighted in the installed report list. An install report field 1344 enables the user to install new reports into the report manager. A remove report field 1346 enables the user to remove reports from the report manager. An about report field 1348 displays information about the highlighted report.

A tracker must first be registered with the system prior to use. The user can add a new tracker to the system by selecting “Trackers” from the MANAGE menu. A manage trackers dialog box is used to manage tracking and contains the following components. An installed trackers field is a list of all trackers installed in the system. An add field is used to add a new tracker to the system.

An add tracker dialog box contains the following fields. A device field is used to indicate the tracker's device ID entered by the user. The tracker number represents that he user must assign the tracker to a number from 1-50. The tracker number list will only contain numbers that have not been previously assigned to other trackers. The view field shows installed tracker's information. The delete option omits a tracker from the system.

The user can send a page to one or more recipients from the NMU. To access the paging options, the user selects “Send Page Alert” from the application tool bar, or “Send Page Alert” from the FILE menu. The send page alert dialog box contains the following components. A recipients field shows a list of operators in the system with pagers who are members of the category selected in the show dropdown list box. A show field is used to select the category of operator to show in the recipient's list box. A message indicates the textual message to send to a recipient.

Alarm Tracking Console

The Alarm Tracking Console (ATC) is used to monitor and track alarms on the network. The ATC application graphically displays alarms in progress, subscriber information, and maintains an animated position track of a subscriber. In addition, the user can play back guard tour tracks and incident history alarm tracks.

The ATC application has three operational views. First, alarm view shows a view of active alarms. Second, guard tour view displays a view of guard tour tracks. Finally, incident history view shows a view of closed and archived incidents.

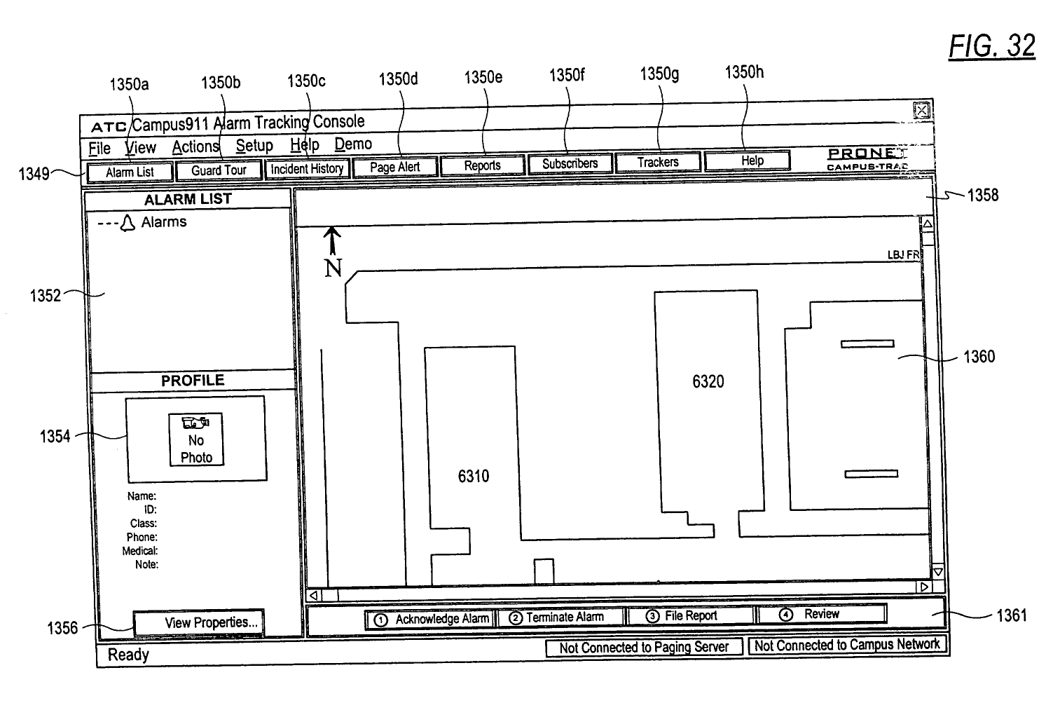

FIG. 32 shows the layout of the screen in alarm view for the Alarm Tracking Console (ATC). As shown, the application tool bar 1349 for alarm view comprises several tool bar buttons. An alarm list window 1350a switches the ATC application into alarm view. This view enables the user to track and manage active alarms on the network. A guard tour button 1350b switches the ATC application into guard tour view. This view enables the user to display a guard tour track for any individual with a watchman-type PAD. The guard tour can be played back to show the real-time path of an individual. An incident history button 1350c switches the ATC application into incident history view. This view enables the user to review previously closed or archived incidents. The incidents can be played back to see what had occurred during the actual active alarm. A page alert button 1350d displays the page alert dialog box to enable the user to send a page to one or more operators. A reports button 1350e displays the report manager dialog box to enable the user to print out various system reports. A subscribers button 1350f displays subscriber properties for any subscriber. Hand-held trackers button 1350g displays the tracker assignments dialog box to enable the user to checkin/check-out trackers. A help button 1350h displays online help for the application. An alarm list window 1352 maintains a list of the active alarms on the network. The user selects an alarm to track by clicking on the desired subscriber name in the list.

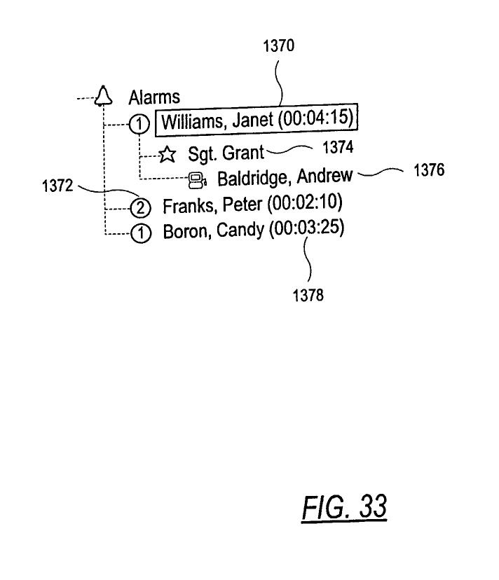

Referring now to FIG. 33, a sample alarm list is illustrated. The alarm list displays a name of the subscriber activating alarm 1370. A state of the alarm 1372 (1=waiting for acknowledgment, 2=waiting for termination, 3=waiting for report, 4=waiting for review) is displayed. A hand-held tracker 1374 on the system appears under the subscriber's name to which the trackers are tuned. An ATC operator who acknowledges an alarm appears under the appropriate subscriber's name. The elapsed time 1378 of the active incident appears after the subscriber's name. The timer will continue to run until the alarm is terminated.

Referring again to FIG. 32, a profile window 1354 shows summary information for the selected alert. The window contains photograph, name, subscriber ID, classification, phone, number, medical problem, and miscellaneous note.

A view properties button 1356 enables the user to view all of the subscriber's information. A position description window 1358 provides a continuous update of the position and displays a position number in ‘x’ of ‘y’ format, date and time of position determination, track channel number, and textual descriptions of the best position predictions.

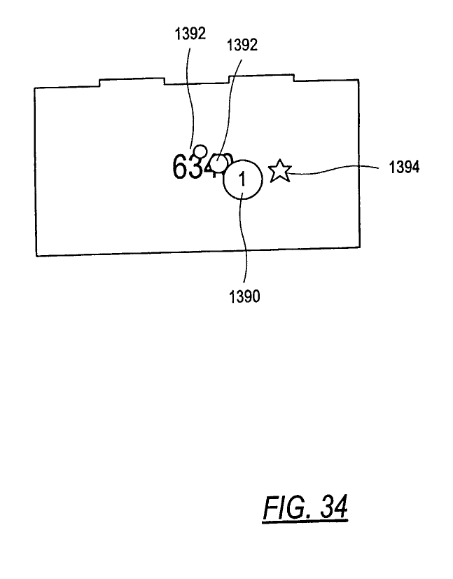

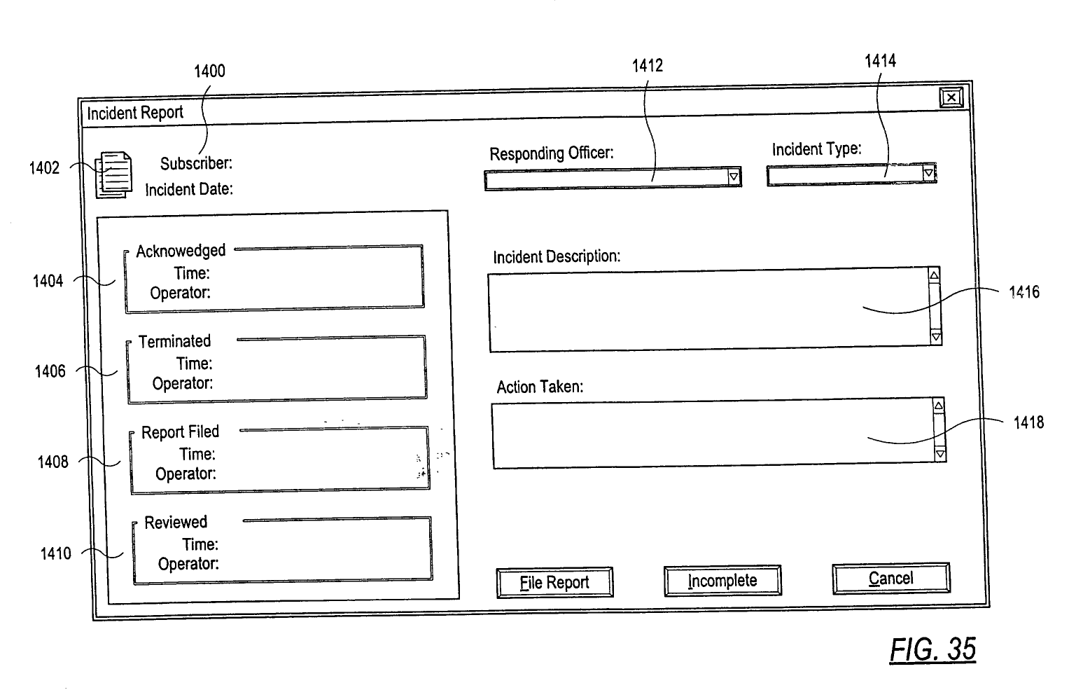

Referring now to FIG. 34, a campus map window 1360 is used to display alarm tracks for alarms on the network. When the user selects a subscriber in the alarm list window, the campus map displays a graphical alarm track on the map corresponding to the position of that subscriber. Only the selected subscriber's track is shown on the map. To view another alarm track, the user selects another entry in the alarm list window.

The alarm track consists of one to four varying-sized circles on the map. The largest circle 1390 on the map represents the most recent alarm position and contains the floor number inside of the alarm position. The smaller circles 1392 represent the three most recent positions and help aid the user in determining the direction and speed that the subscriber is moving. The circles will continue to animate around the map until the alarm is terminated. The map will automatically move to center the most recent alarm position on the map. If the user needs to move the map manually, the user simply clicks on the map in the desired direction and the map will scroll. In addition to the alarm track, hand-held tracker positions are also represented graphically on the map. A star 1394 graphic represents the tracker's position. The tracker graphic will traverse the map in the same manner as the alarm position.

The user can right-click the mouse on the campus map to get a summary of all of the alarms on the network. The entire campus map will be sized to fit the campus map window, and all of the active alarms will be displayed.

An actions window 1361 contains four buttons including an acknowledge button which enables the user to acknowledge the alarm that is selected in the Alarm List Window. A security password is required to acknowledge an alarm. The operator must enter a valid operator ID and password to proceed with the operation. A terminate button enables the user to terminate the alarm selected in the alarm list window. Once the track is terminated, the ATC will no longer update the position window or campus map display. In addition, the timer in the Alert List Window associated with the alarm is halted. A security password is required to terminate an alarm. The operator must enter a valid operator ID and password to proceed with the operation. A file report button enables the user to fill out an incident form for the alarm selected in the alarm list window. Referring now to FIG. 35, a report dialog box contains a subscriber name 1400, date and time of alarm 1402, acknowledging operator with date and time of acknowledgment 1404, terminating operator with date and time of termination 1406, operator filing report with date and time of filing 1408, operator reviewing incident with date and time of review 1410, responding officer name 1412, incident type (accident, robbery, false alarm, etc.) 1414, incident text description 1418, and action taken text description 1418.

A file report push button saves the data entered on the form and promotes the alarm to the review state. An incomplete push-button saves the data entered on the form but keeps the alarm in the file report state.

The review button enables the user to review an incident report and give final approval. Once approval is given, the alarm is removed from the alarm list window.

The report dialog box contains a reviewer's comments data entry field. The other fields on the dialog box are the same as in FIG. 35 and are now read-only and cannot be changed. The approve push-button saves the data entered on the form and removes the alarm from the active alarm list window. The incomplete push-button saves the data entered on the form but keeps the alarm in the review state.

The network connection status bar displays the current Network Control Computer (NCC) connection status. If the ATC is currently connected to the NCC, the status bar displays “Connected to Campus Network.” Otherwise, the status bar displays “Not Connected to Campus Network.” In addition to the NCC connection status, the status bar also contains the connection status to a paging server. If the ATC is connected to the paging server, the status bar displays “Connected to Paging Server.” Otherwise, the status bar displays “Not Connected to Paging Server.”

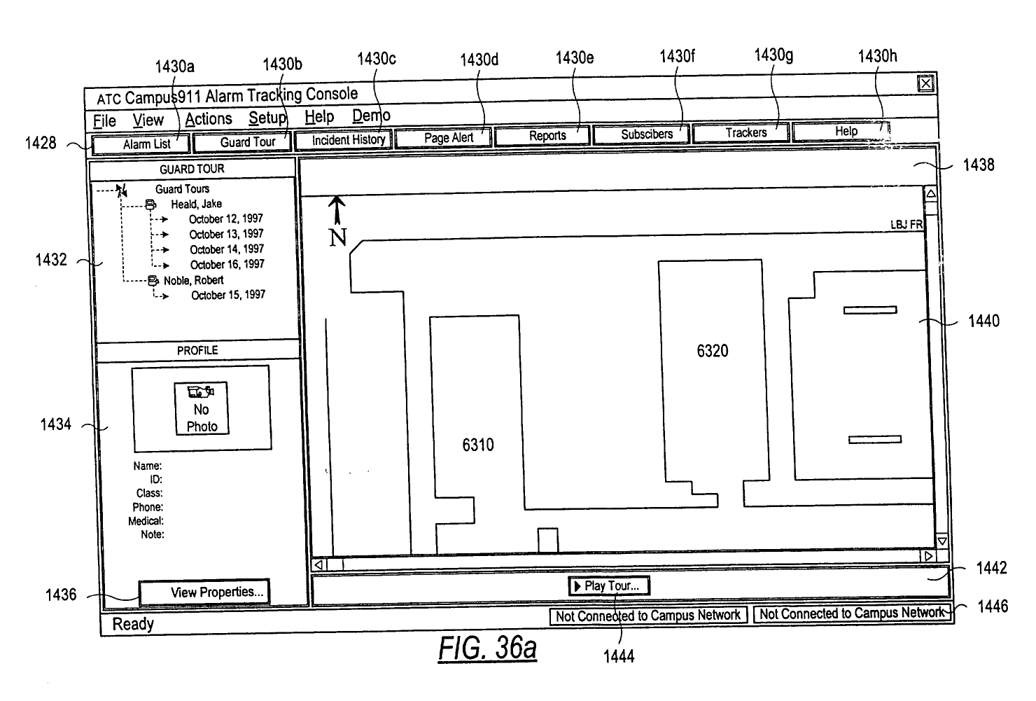

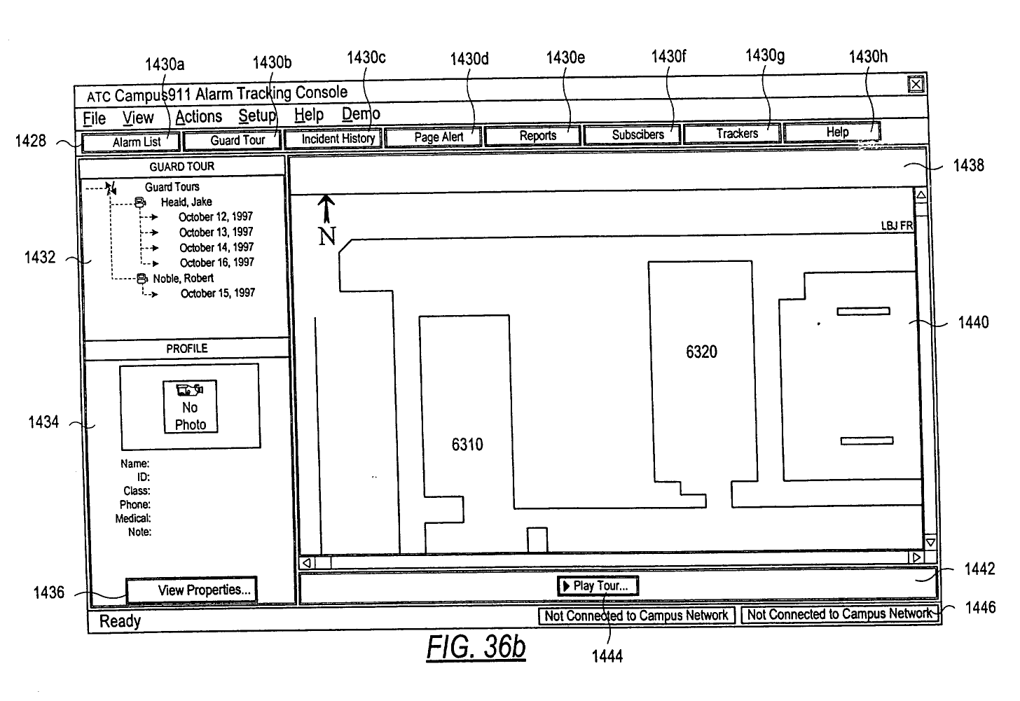

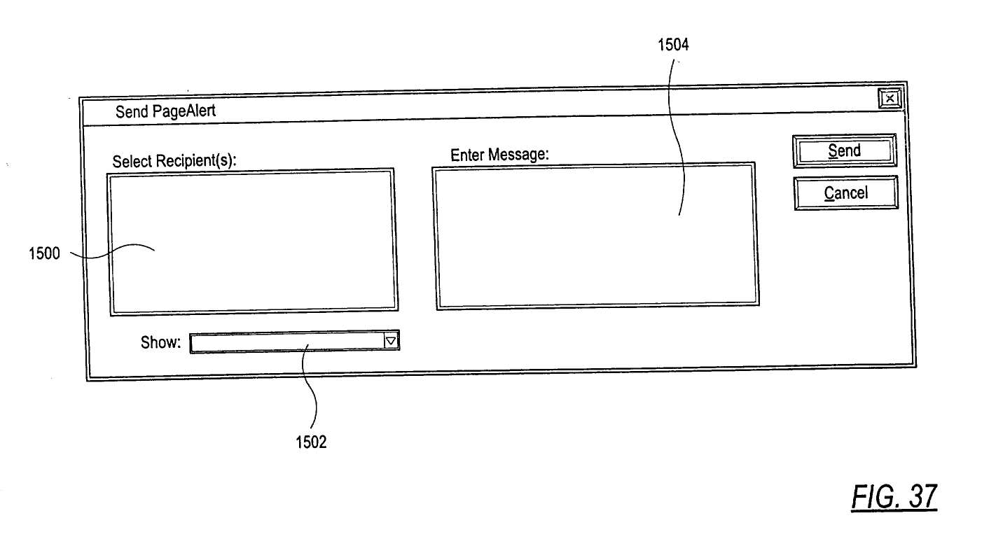

Referring now to FIG. 36a, the layout of the screen in guard tour view for the Alarm Tracking Console (ATC) is illustrated. An application tool bar 1428 (for guard tour view) includes an alarm list button 1430a which switches the ATC application into alarm view. This view enables the user to track and manage active alarms on the network. A guard tour button 1430b button switches the ATC application into guard tour view. This view enables the user to display a guard tour track for any individual with a watchman-type PAD. The guard tour can be played back to show the real-time path of the individual. An incident history button 1430c switches the ATC application into incident history view. This view enables the user to review previously closed or archived incidents. The incidents can be played back to see what had occurred during the actual active alarm. A page alert 1430d displays the page alert dialog box to enable the user to send a page to one or more operators. A reports button 1430e displays the report manager dialog box to enable the user to print out various system reports. A subscribers button 1430f displays subscriber properties for any subscriber. A hand-held trackers button 1430g displays the tracker assignments dialog box to enable the user to check in/check out trackers. A help button 1430h displays online help for the application.

A guard tour list 1432 maintains a list of all guard tours stored in the database. Guard tours are organized in a tree structure where individuals are listed with the dates of their tours. The user selects a tour to display by clicking on the desired tour date in the list.

A profile window 1434 shows summary information for the selected tour. The window contains a photograph, name, subscriber, ID, classification, phone number, medical problem, and miscellaneous note. A view properties button 1436 enables the user to view all of the operator's information.

A position description window 1438 provides a description of the guard tour. The position description window displays the position number in ‘x’ of ‘y’ format, date and time of position determination, track channel number, and one to three text descriptions of the best position predictions.

If the user scrolls the position description window list, the campus map will automatically center to the guard tour position showing in the list. The position number will be highlighted on the map.

A campus map window 1440 is used to display guard tour tracks on the network. When the user selects a tour date in the guard tour list window, the campus map displays a graphical trail on the map corresponding to the tour positions of that individual on the date selected. Each position on the map is numbered. The position description window 1438 is used to highlight tour positions on the map. For example, if position number two is visible in the position window, the campus map 1440 will automatically scroll the map to where position two was calculated and the position will be displayed in a different color than the other track positions. Only the tour selected in the guard tour list window 1432 is shown on the map. To view another tour, the user can select another entry in the guard tour list window 1432.

The guard tour track consists of a series of square graphics containing the position number they represent. All squares are the same color (e.g., yellow) except for the position number visible in the position description window which appears as a different color (e.g., purple). If the user needs to move the map manually, the user simply clicks on the map in the direction to move and the map will scroll. The user can right-click the mouse on the campus map to get a full map view of all of the guard tour positions for the selected tour. The entire campus map will be sized to fit the campus map window and all of the positions will be displayed.

An actions window 1442 contains the play tour push-button 1444. This button enables the user to play-back the entire guard tour as it happened. Each tour position will be highlighted on the map and the position description window will change to reflect the new position. Once the user presses the play guard tour push-button 1444, the push-button changes to stop playback. The user can press this push-button to stop the playback of the tour. If the user selects another tour in the guard tour list, the play-back of the previously selected tour will automatically stop. In addition, if the user changes from the guard tour view to another view, the play-back will stop.

A network connection status bar 1446 displays the current Network Control Computer (NCC) connection status. If the ATC is currently connected to the NCC, the status bar displays “Connected to Campus Network.” Otherwise, the status bar displays “Not Connected to Campus Network.” In addition to the NCC connection status, the status bar also contains the connection status to a paging server. If the ATC is connected to the paging server, the status bar displays “Connected to Paging Server.” Otherwise, the status bar displays “Not Connected to Paging Server.”

FIG. 36b shows the layout of the screen in incident history view for the Alarm Tracking Console (ATC) and contains an alarm list button 1452a which switches the ATC application into alarm view. This view enables the user to track and manage active alarms on the network. A guard tour button 1452b switches the ATC application into guard tour view. This view enables the user to display a guard tour track for any individual with a watchman-type PAD. The guard tour can be played back to show the real-time path of the individual. An incident history button 1452d switches the ATC application into incident history view. This view enables the user to review previously closed or archived incidents. The incidents can be played back to see what had occurred during the actual active alarm. The page alert button 1430d displays the page alert dialog box to enable the user to send a page to one or more operators. A reports dialog 1430e displays the report manager dialog box to enable the user to print out various system reports. A subscribers button 1430f displays subscriber properties for any subscriber. A hand-held trackers button 1430g displays the tracker assignments dialog box to enable the user to check-in/check-out trackers. A help button 1430h displays online help for the application.

An incident history list window 1454 maintains a list of all closed incidents. Closed incidents are those that have completed the review stage and are no longer active. These incidents are organized in a tree structure where subscriber names are grouped by date. The user selects an incident to display by clicking on the subscriber name in the list. A profile window 1456 shows summary information for the selected incident. The window contains a photograph, name, subscriber ID, classification, phone number, medical problem, and miscellaneous note.

A view properties button 1454 enables the user to view all of the subscriber's information. A position description window 1460 provides a listing of all of the recorded positions for the alarm incident. The position description window displays the following information: position number in ‘x’ of ‘y’ format, date and time of position determination, track channel number, and one to three text descriptions of the best position predictions.

A campus map window 1462 is used to display alarm tracks for alarms on the network. When the user selects a subscriber in the incident history list window, the campus map window displays a graphical alarm track on the map corresponding to the position of that subscriber as it originally occurred. Only the selected subscriber's track is shown on the map. To view another incident history, the user selects another entry in the incident history list window.

The alarm track consists of one to four different size circles on the map. The largest circle on the screen represents the most recent alarm position and contains the floor number inside of it. The smaller circles represent the three most recent positions and help aid the user in determining the direction and speed that the subscriber was moving. The map will automatically move to center the position highlighted in the position description window. If the user needs to move the map manually, the user simply clicks on the map in the direction to move and the map will scroll.

The user can right-click the mouse on the campus map and the entire campus map will be sized to fit the campus map window. The actions window 1464 contains the following components. A play incident button 1466 enables the user to play back the entire incident as it happened. Each alarm position will be highlighted on the map and the position description window will change to reflect the new position. Once the user presses the play incident push-button, the push-button changes to stop playback. The user can press this push-button to stop the playback. If the user selects another incident in the incident history list window, the play-back of the previously selected incident will automatically stop. In addition, if the user changes from the incident history view to another view, the play-back will stop. A view report button 1468 enables the user to review the report that was filed for the incident.

An incident report dialog box contains all of the data entered during the file report and review states of the alarm incident. The dialog box is read-only so that no data can be changed.

A network connection status bar 1470 displays the current Network Control Computer (NCC) connection status. If the ATC is currently connected to the NCC, the status bar displays “Connected to Campus Network.” Otherwise, the status bar displays “Not Connected to Campus Network.” In addition to the NCC connection status, the status bar also contains the connection status to a paging server. If the ATC is connected to the paging server, the status bar displays “Connected to Paging Server.” Otherwise, the status bar displays “Not Connected to Paging Server.”

A user interface allows for operations that are accessible in each of the alarm, guard tour, and incident history views. The user can send a page to one or more recipients from the Alarm Tracking Console (ATC). To access the paging options, the user selects send page alert from the application tool bar, or send page alert from the FILE menu.

Referring now to FIG. 37, the send page alert dialog box contains a recipients field 1500 which is a list of operators in the system with pagers who are members of the category selected in the show dropdown list box. A show field 1502 selects the category of operator to show in the recipients list box. A message field 1504 represents the text message to send to the recipient.

The user can print reports from the Alarm Tracking Console (ATC). To display the list of installed reports, the user can press the reports application tool bar button, or select “Report Manager” from the VIEW menu.

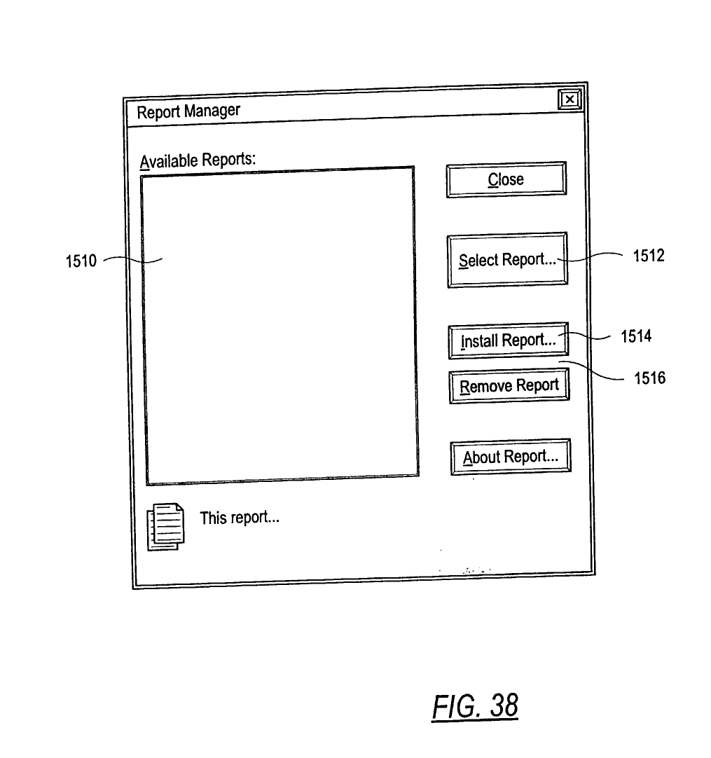

Referring now to FIG. 38, the report manager dialog box contains an available reports field 1510 which is a list of installed reports. As the user highlights entries in the list, a description for the selected report is shown at the bottom of the dialog box. A select report button 1512 executes the report highlighted in the installed report list. An install report button 1514 enables the user to install new reports into the report manager. A remove report button 1516 enables the user to remove reports from the report manager. An about report button 1518 displays information about the highlighted report.

The user can view information for any subscriber using the Alarm Tracking Console (ATC) application. To access subscriber information, the user can select the subscribers push-button on the application tool bar, or can select subscribers from the SETUP menu. The user will be prompted to enter the subscriber's ID to view.

Once the user enters the desired subscriber ID, a subscriber properties dialog box containing the subscriber's personal profile, contact information, and device information will be displayed. Most of the information contained in the dialog box was entered in the Subscriber Management Utility (SMU) and contains a subscriber ID, subscriber name (first and last), subscriber category (e.g., student, officer, or teacher), disability and description of disability, sex, height, build, hair color, eye color, photograph, miscellaneous note, and contact information.

The contact information contains the contact information (e.g., primary and secondary addresses and phone numbers); emergency contact (name, phone, and relationship); and device information.

The user can assign trackers to operators. As a result, when an assigned tracker is activated, the assignee's name will appear in the alarm list associated with the associated incident and tracker.

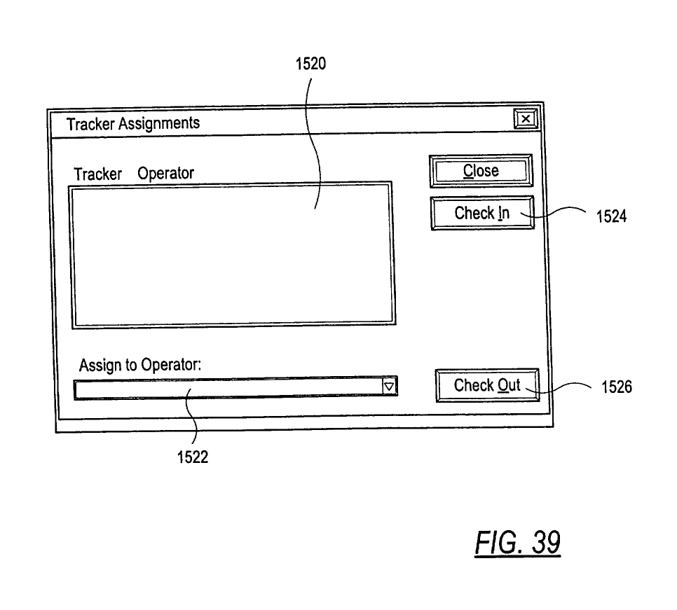

Referring to FIG. 39, the tracker assignments dialog box contains a tracker list 1520 which is a list of installed trackers in the system with the owning operator's name. If the tracker is not checked out to anyone, the operator name column will be blank. An operator list 1522 is a list of all operators in the system. A check-in field indicates if the user highlights an entry in the tracker assignment list that currently has no operator assigned, pressing the check-in push-button 1524 will check in the tracker. The operator's name will be removed from the entry in the tracker assignments list. A checkout button 1529 checks out a highlighted entry in the tracker assignment list having an assigned operator. The operator's name will be added to the entry in the tracker assignments list.

Users gain access to the software on the CCC system by having user accounts and access privileges. The Alarm Tracking Console (ATC) application enables an administrator to create and manage users and to assign access rights to CCC functions. All of the users of the CCC system are called operators. To manage the operators in the system, the user selects “Operators” in the SETUP menu.

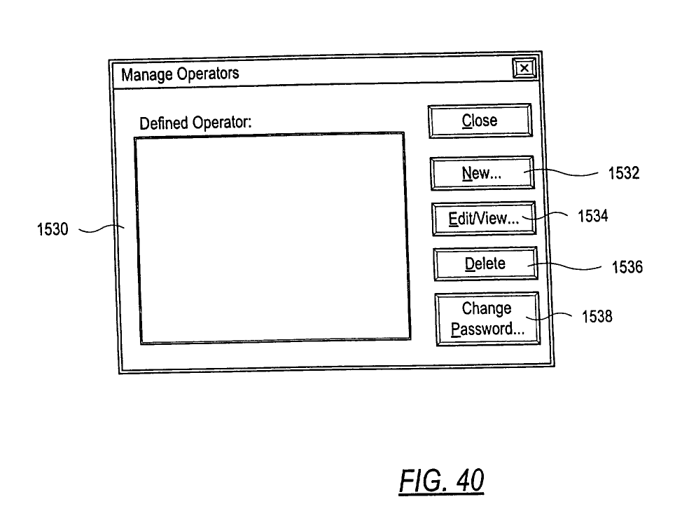

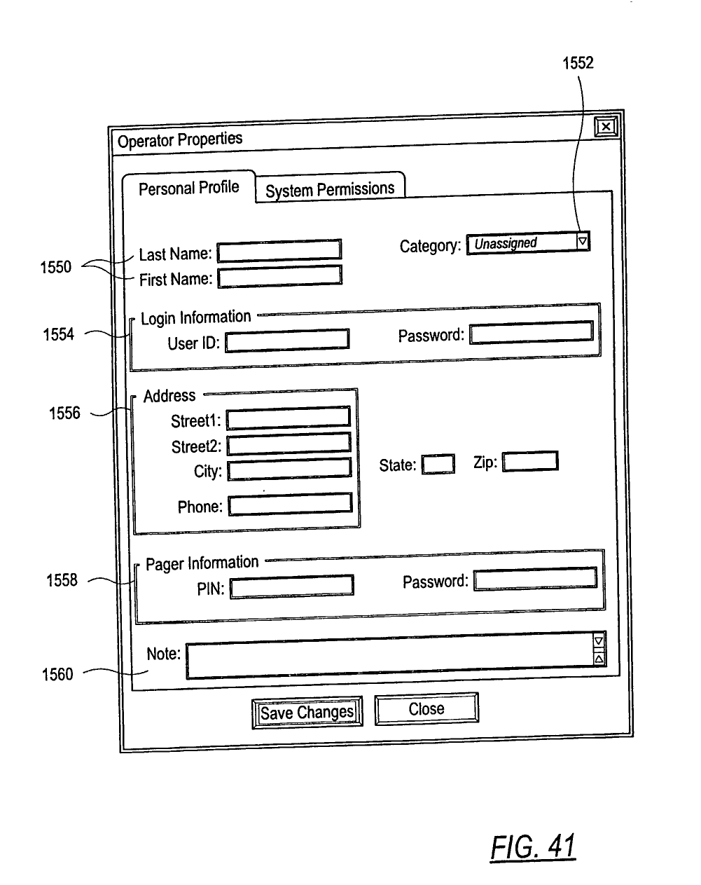

Referring to FIG. 40, the manage operators field dialog box contains a defined operators field 1530 which is a list of operator names already in the system. A new button 1532 creates a new operator. An edit/view button 1534 allows a view or modify existing operator. A delete button 1536 omits an operator from the system. A change password button 1538 changes the password for an operator.

Each operator in the system has a personal information profile and a system permissions profile. Referring now to FIG. 41, the personal profile dialog box contains a name button 1550 which is an operator's first and last name. A category field 1552 indicates the operator category (administrator, maintenance, officer, clerk, etc.). A login information field 1554 indicates the system login ID and password assigned to an operator. An address field 1556 indicates an operator street address and phone number. A pager information field 1558 indicates a pager PIN and password for system paging. A miscellaneous note field 1560 indicates additional notes about the operator.

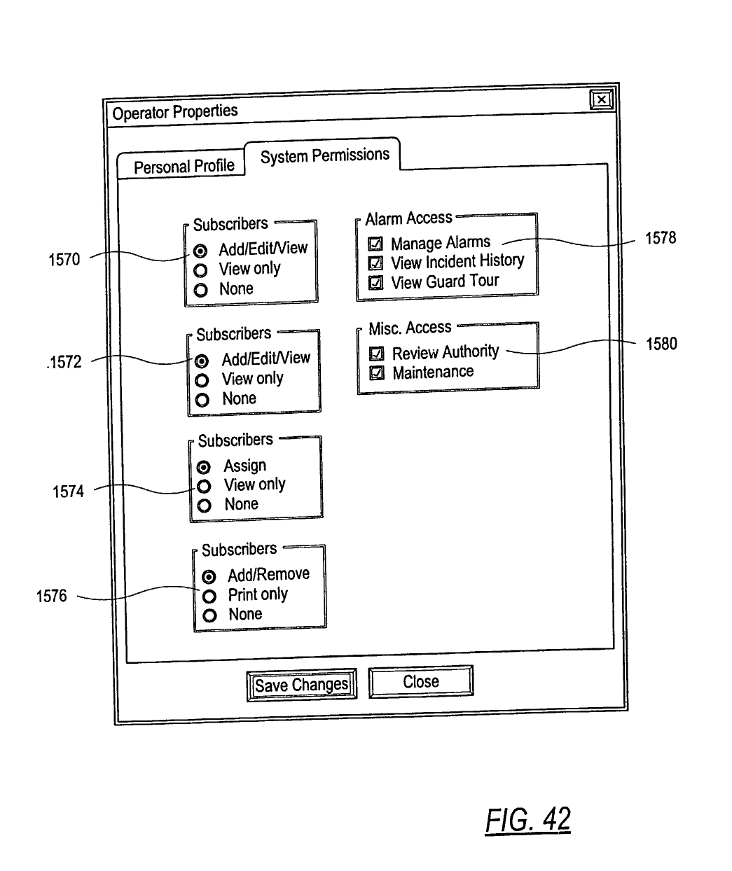

Referring to FIG. 42, the system permissions dialog for an operator is shown. The system permissions dialog box contains a subscribers field 1570 which indicates the operator can be allowed add/edit/view access, view only, or no access to subscribers. An operators field 1572 indicates the operator can be allowed add/edit/view access, view only, or no access to operators. A trackers field 1574 indicates the operator can be allowed to assign/view, view, or no access to tracker assignments. A reports field 1576 indicates the operator can be allowed add/remove/print, print only, or no access to reports. An alarm access field 1578 indicates access to alarms, incident histories, or guard tours can be enabled/disabled. A miscellaneous access field 1580 indicates an operator can be assigned review authority over an incident. In addition, an operator can be given maintenance privileges.

To quickly change a password for an operator, the user first selects an operator from the operator list and then presses the change password push-button. The change password dialog box contains the following components. The current password indicates the user must enter the current operator password. The new password indicates the user must enter the new operator password. The verify password indicates the user must reenter the new operator password to verify the password change.

Paging Server

The paging server application is a network service application that provides a paging capability to any application on the system. An application can become a client to the paging server and send messages to it over the network. Once received by the paging server, the messages are sent, via modem, to a paging company gateway. Using the paging server, maintenance alert messages, as well as subscriber alarm messages, can be sent to one or more alphanumeric pagers on a campus.

The paging server has two modes of operation: online and offline. When in the online mode, the paging server will try to send all pending pages to the paging company gateway. In the offline mode, the paging server will continue to receive and queue pages, but does not actively send the pages to the paging company gateway. The paging server is designed to start in the online state when first loaded. If the computer that the paging server is loaded on is rebooted during normal operation, the paging server will be configured to automatically run and any pending pages will be sent to the paging company gateway.

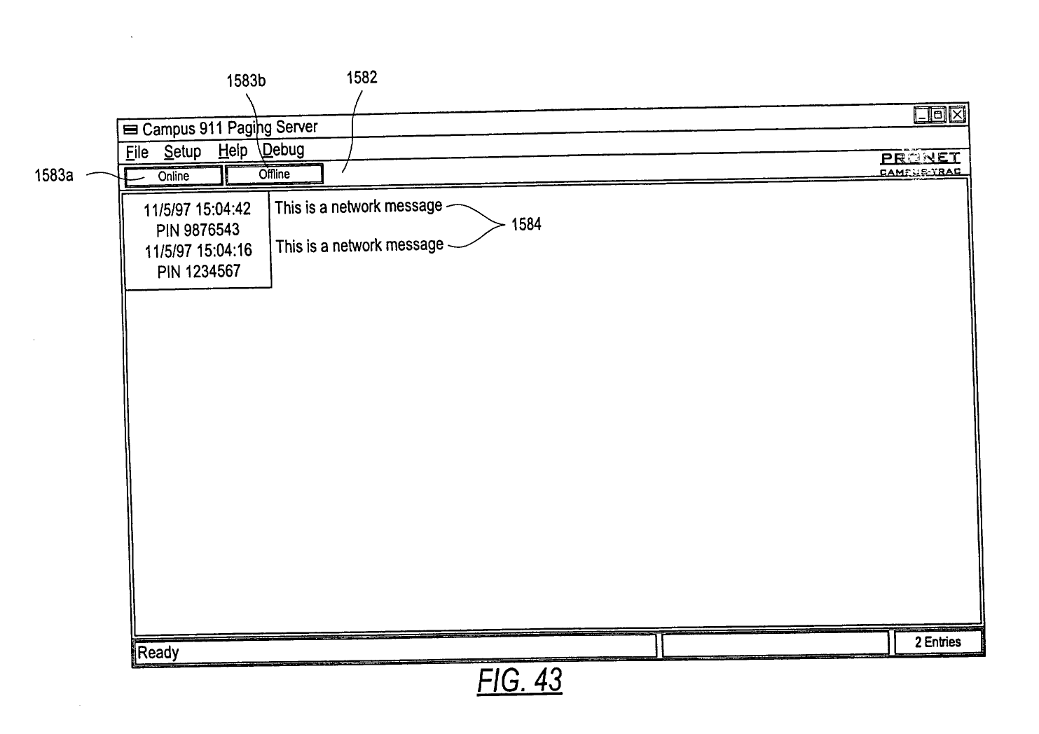

Referring now to FIG. 43, the layout of the screen for the main application window is illustrated. The main window contains a toolbar 1582 with an online button 1583a which places the paging server in the online mode. In this mode, any pending messages, as well as any new messages, will be sent to a paging company gateway. An offline button 1583b places the paging server in the offline mode. In this mode, the paging server will continue to queue-up received messages, but will not attempt to send the messages to the paging company gateway. The application window area is used to display a log 1584 of received messages. Each individual log entry contains the time and date of arrival at the paging server; receiving pager's personal identification number (PIN); and the message being sent. In addition, each log entry is color-coded for the pending state. A pending message is a message that has not yet been successfully sent and will appear in a specific color (e.g., yellow). Additionally, the log entry is color-coded in the failed state. A failed message is a message that was refused by the paging company gateway. Failed messages will appear in a different color (e.g., red). Finally, the log is color-coded for sent messages. A sent message is a message that was accepted by the paging company gateway. Sent messages will appear in yet another color (e.g., green).

The status bar contains two special sections. A paging status section displays the status of the paging server when online. A log count section displays the number of entries in the log.

The user can access the communications settings for the paging server by selecting the “Setup Communications” option in the SETUP menu.

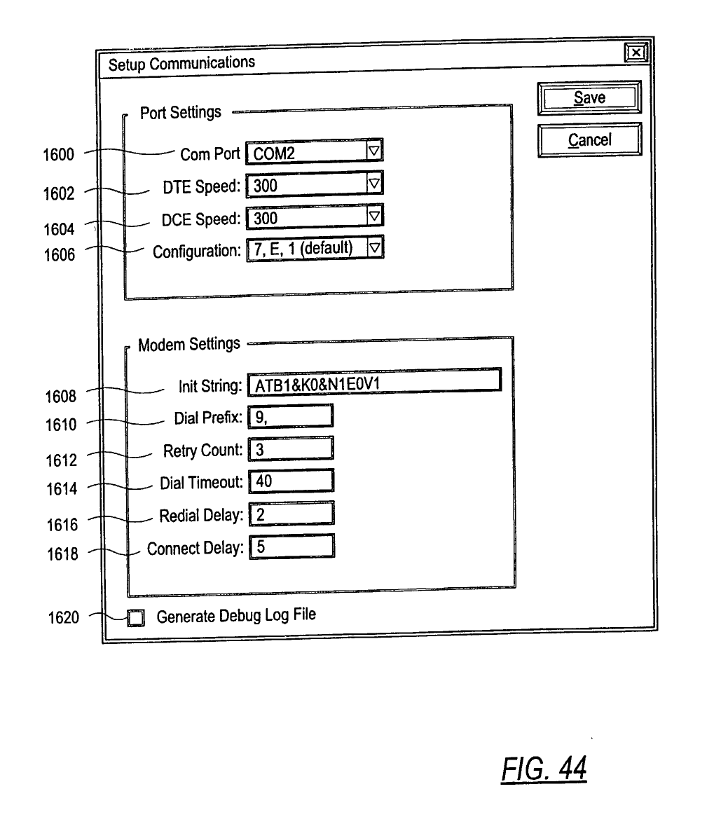

Referring now to FIG. 44, the setup communications dialog box contains the following user options. The Communications Port (Com Port) field 1600 is used to communicate with the modem. A DTE speed field 1602 indicates the rate that the computer will send data to the modem. A DCE speed field 1604 indicates the desired rate for the calling modem to negotiate with the called modem. A configuration field 1606 indicates the data bits, parity, and stop bits to use for communication. An init string field 1608 indicates the modem initialization string to send to the modem. A dial prefix field 1610 indicates a dial string that is sent to the modem prior to dialing a phone number. A retry count field 1612 indicates the number of times the paging server will attempt to redial a paging company in a single session. A dial timeout field 1614 indicates the number of seconds the paging server will wait for a modem connection to occur before aborting the call. A redial delay field 1616 indicates the number of seconds the paging server will wait after aborting a call before instructing the modem to dial again. A connect delay field 1618 indicates the number of seconds the paging server will wait before sending data to the paging company after establishing a connection. A generate debug log file field 1620 indicates an option to generate a debug file that will record all sequences of communication for diagnostic purposes.

The user can access the paging service settings for the paging server by selecting the paging service option in the SETUP menu. The paging server sends all received messages to a primary paging company. For diagnostic and monitoring purposes, a copy of all received messages can be sent to a specific pager using the Shadow Service.

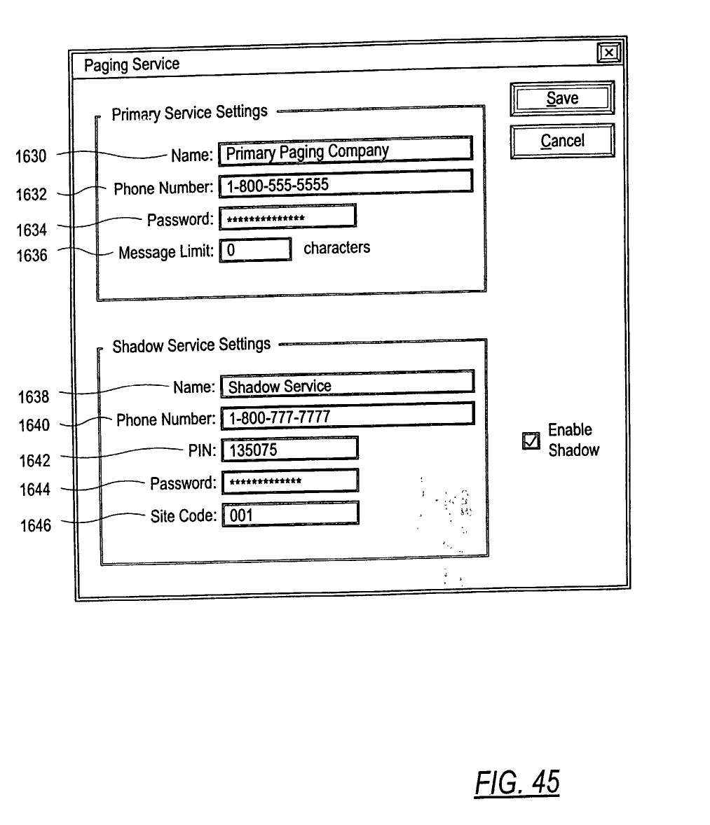

Referring now to FIG. 45, the paging service dialog box contains a primary service settings name field 1630 and indicates the name of the paging service to call. The primary paging service is the service that will be used for all messages received by the paging server. A phone number field 1632 indicates the phone number to dial to communicate with a paging company gateway. A password field 1634 indicates the password (if required) to access the paging company's gateway. A message limit field 1636 indicates the maximum number of characters that can be sent in a single message. A shadow service settings field 1638 indicates the name of the paging service to call. The shadow service is used to send a copy of all messages received by the paging server to a specific pager. For example, this could be a special maintenance pager. A phone number field 1640 indicates the phone number to dial to communicate with the paging company's gateway. A PIN field 1642 indicates the personal identification number (PIN) of the pager. A password field 1644 indicates the password (if required) to access the paging company's gateway. A site code field 1646 indicates an alphanumeric code that will be prepending to the original message.

The user can access the network settings for the paging server by selecting the “Setup Network . . . ” option in the SETUP menu. The setup network dialog box a Port field which indicates the system service port to register the paging server. A password field indicates the password required for connecting clients. A monitor system integrity field indicates a built-in check to monitor client processes. A compose message field allows the user to compose test messages to test the installation of the paging server by selecting the “Compose Message” option in the FILE menu. The compose message dialog box contains a field which indicates the Personal Identification Number (PIN) of the receiving pager. A message field indicates a message to send to the pager. When the user presses the “Send” button, the message is added to the paging log.

Alarm Tracking Console Operation

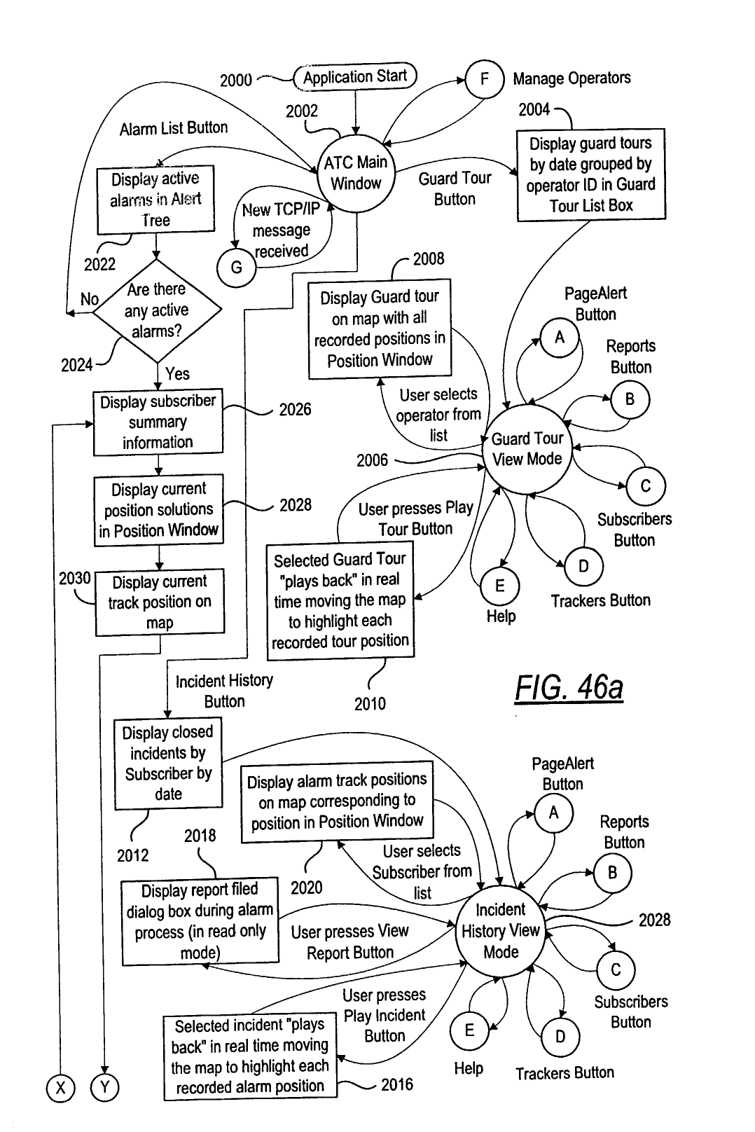

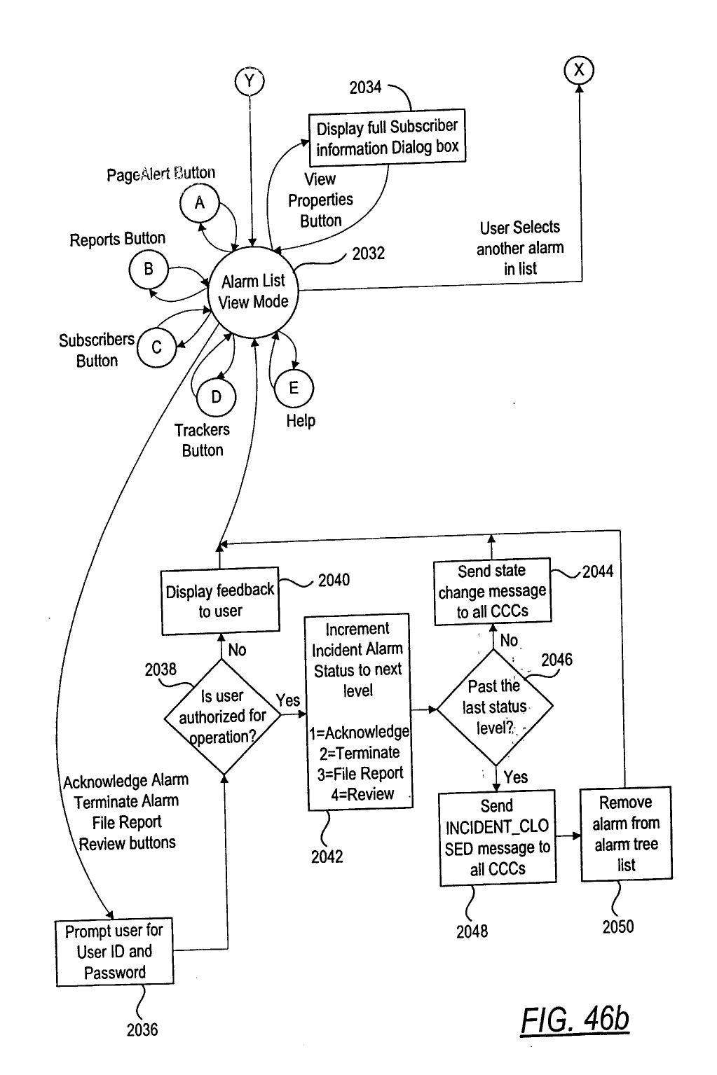

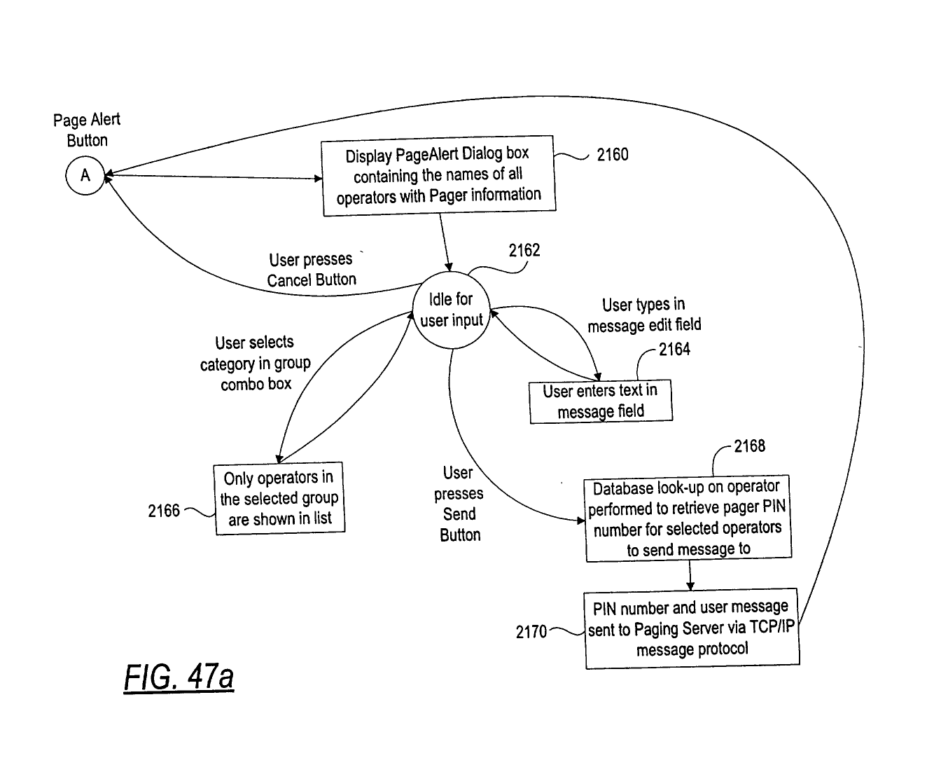

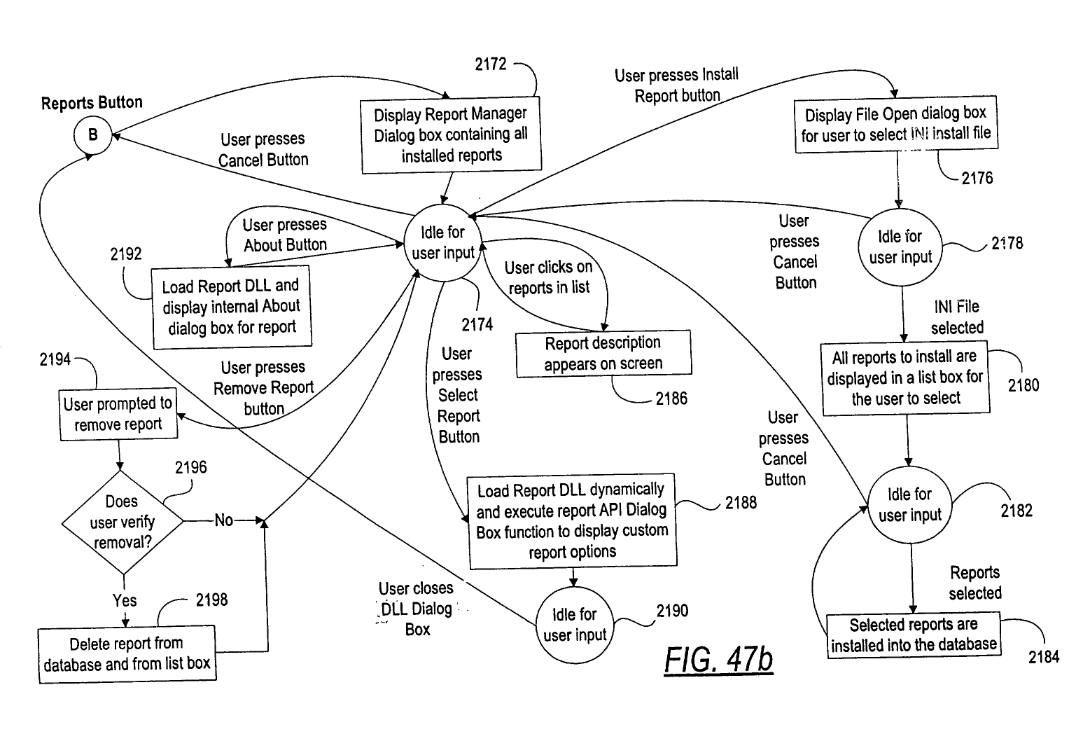

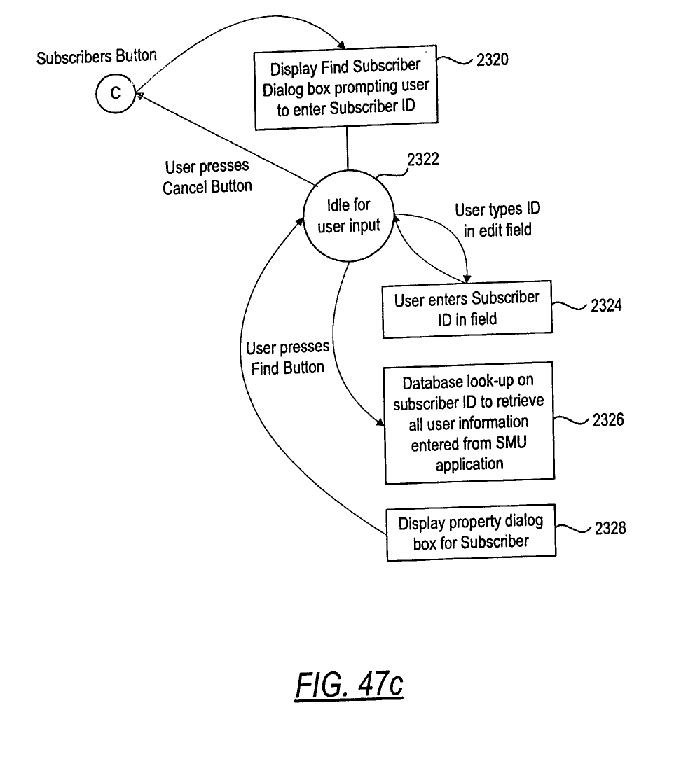

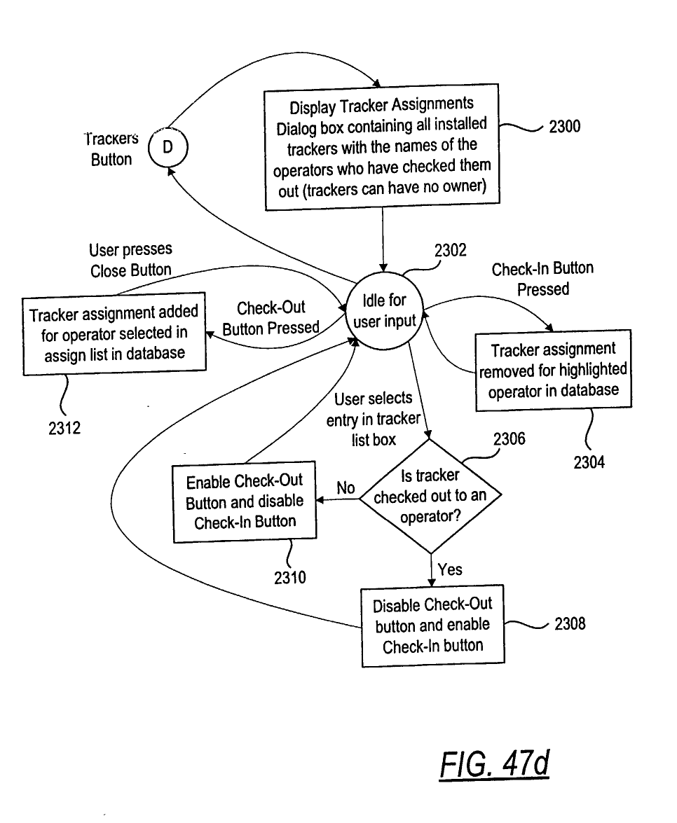

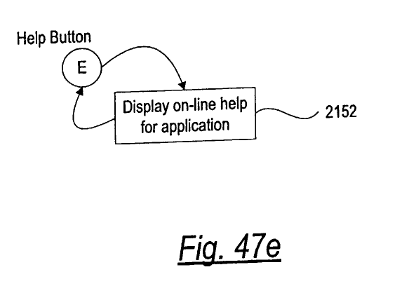

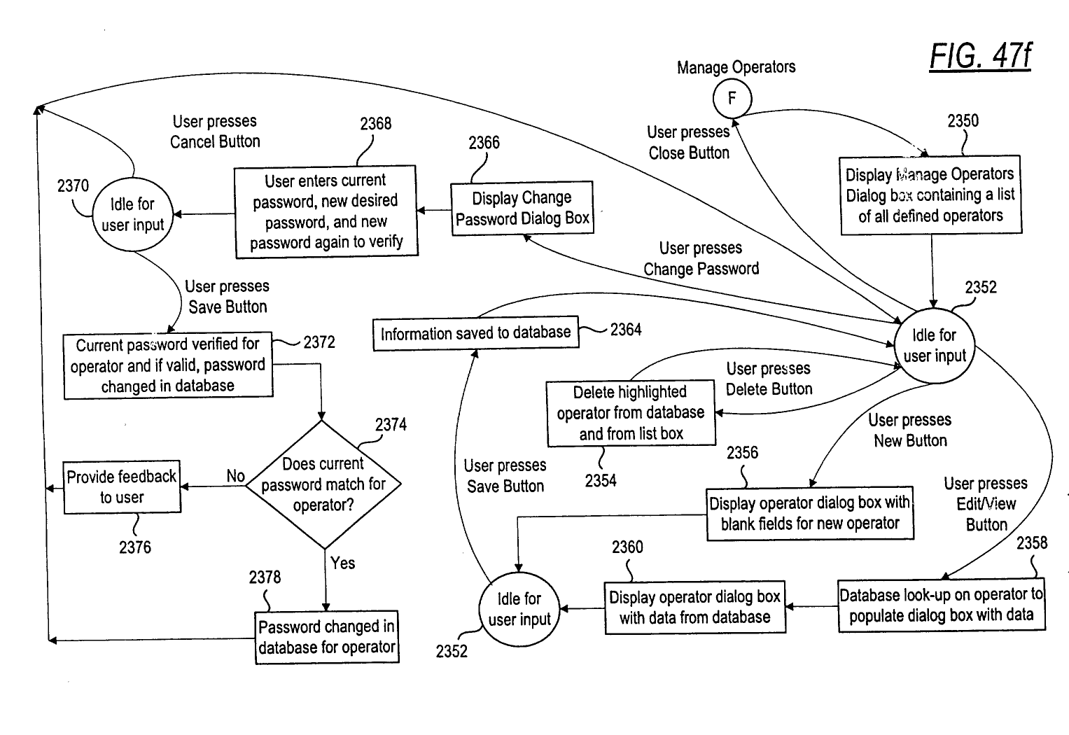

The Alarm Tracking Counsel Operation is illustrated in FIG. 46. At step 2000, the application starts. Next, at step 2002, the application enters the ATC main window. This has been described previously. If the guard tour button has been push, at step 2004, the guard tours are displayed. Then, control proceeds to step 2006 where guard tour view mode is entered. At step 2006, the Page alter button can be pressed (see FIG. 47a); the Reports button can be pressed (see FIG. 47b); the subscribers button can be pressed (see FIG. 47c); the Trackers button can be pressed (see FIG. 47d); or the help button can be pressed. If the user selects an operator from the list, control proceeds to step 2008 where the guard tour is displayed on the map with all the recorded positions on the positions window. Control then returns to step 2006. At step 2006, the user can press the Play Tour Button. Control then proceeds to step 2010 where the selected guard tour plays back in real time moving on the map to highlight each recorded position.

Returning to step 2002, a new TCP/IP message can be received. Control proceeds to the algorithm described in FIG. 47g.

At step 2002, the Incident History Button can be pressed. Control then proceeds to step 2012 where the display gives incidents by subscriber by date. Next, control proceeds to step 2014 where Incident History Mode is entered. From Incident History Mode, the Page Alter button can be pressed; the Reports button can be pressed; the subscribers button an be pressed; the Trackers button can be pressed; and the Help button can be pressed.

From step 2014, the user can press the Play Incidents button. Control then proceeds to step 2016 where selected incidents are played back in real time moving the map highlight to each recorded position. Control then returns to step 2014.

From step 2014, the user can also press the View Report button. Control then proceeds to step 2018 where the report filed in the dialog box during the alarm process is displayed. Control then returns to step 2014.

From step 2014 the user can also select a subscriber from the list. Control then proceeds to step 2020 where the alarm track position are displayed on the map corresponding to the positions in the position window. Control then returns to step 2014.

From step 2002, the user can also press the alarm list button. Control then proceeds to step 2022 where active alarms in the alarm tree are displayed. Next, at step 2024 the system determines whether there are any active alarms. If the answer is negative, control returns to step 2002. If the answer is affirmative, then control continues with step 2026 where subscriber summary information is displayed. Next, at step 2028, the current position solutions are displayed in the position window. Then at step 2030 the current track position on the map is displayed. Next, control proceeds to step 2032 where Alarm List View mode is entered.

At step 2032, the page alert button can be pressed; the reports button can be pressed; the subscribers button can be pressed; the trackers button can be pressed; and the help button can be pressed. The user can also select another alarm in the list and control proceeds to step 2026.

The user can also acknowledge the alarm, terminate the alarm, file the report, or press the review button. Control then proceeds to step 2036 where the system prompts the user for the user's id and the user's password. At step 2038, the system determines whether the user is authorized for the attempted operation. If the answer is negative, control proceeds to step 2040 where some feedback (e.g., a message indicating denial) is displayed to the user and then control returns to step 2032.

If the answer at step 2038 is affirmative, then control proceeds to step 2042 where the system increments the alarm status to the next level. Next, at step 2046 the system determines whether the last level status has been reached. If the answer is affirmative, then control proceeds to step 2048 where an incident closed message is sent to all CCCs. Then at step 2050, the alarm is removed from the alarm tree list. Next, control returns to step 2032.

If the answer at step 2046 is negative, then control proceeds to step 2044 where a state change message is sent to all CCCs. Then control returns to step 2032.

Referring now to FIG. 47a, the operation of the Page Alert button is now described. At step 2160, the Page Alert dialog box is displayed containing the names of all the operators with pager information. At step 2162, the system is idle allowing input from the user. The user types text into the message field at step 2164. If the user presses the Send button, at step 2168, a database look-up on an operator is performed to retrieve the pager PIN number for selected operators. Then, at step 2170, the PIN number and user message is sent to the paging server via TCP/IP message protocol. Execution then concludes. If, at step 2162, the user selects a category in the group combination box, at step 2166, only the operators in the selected group are shown.

Referring now to FIG. 47b, the operation of the Reports button is described. At step 2172, the system displays the Report Manager dialog box which contains all of the installed reports. Next, at step 2174, the system is idle to allow for user input if a user presses the Install Report button, at step 2176, the system displays the File Open dialog box. Next, at step 2178, the system is idle for user input. At step 2178, if the user presses the Cancel button control returns to step 2174. However, if a file is selected, at step 2180, all reports are displayed in a list box for the user to select. Next, at step 2182, the system is idle to allow for user input. If the user presses the Cancel button, control returns to step 2174. However, if the user selects a report, step 2184 is executed whereby reports are installed in the database. Control returns to step 2182.

If at step 2174, the user clicks on the Reports lists, step 2186 is executed where the report description appears on the screen. Control returns to step 2184.

If at step 2174 the user presses the Select Report button, control continues at step 2188 where the report is loaded dynamically and the custom report options are displays. Next, at step 2190 the system is idle to allow for user input. When the user closes the dialog box, the system exits the Report button function.

If, at step 2192, the user presses the About button, the system loads the report DLL and displays the internal About dialog box. Control returns to step 2174.

If, at step 2174, the user presses the Remove Report button, at step 2194 the user is prompted to remove the report. Next, at step 2196, the system determines whether the user wants to verify removal. If the answer is negative, control returns to step 2174. If the answer is affirmative at step 2198, the report is deleted from the database and from the list box. Control returns to step 2174.

Referring now to FIG. 47c, the operation of the subscriber button is now described. At step 2320, the find subscriber dialog box is displayed prompting the user to enter the subscriber ID. At step 2322, an idle state is entered for the user to input data. If the user types the ID in the edit field, at step 2324, the user enters the subscriber ID into the field. Control returns to step 2322. If the user presses the find button, at step 2326, the system performs at database look-up on the subscriber ID to retrieve all information entered from the SMU application. Then, at step 2338, the property dialog box is displayed for the subscriber. Control continues at step 2322.

Referring now to FIG. 47d, the operation of the trackers button is now described. At step 2302, an idle state is entered allowing the user to input data. If the check-in button is pressed, at step 2304, the tracker assignment is removed. If the user selects the entry in the tracker list box, at step 2306, the system determines whether the tracker is checked out to an operator. If the answer is affirmative, at step 2308, the check-out button is disabled and the check-in button is enabled. If the answer is negative, at step 2310, the check-out button is enabled and the check-in button is disabled. Control returns to step 2302.

If the check-out button is pressed, control continues with step 2312 where the tracker assignment is added for the operator selected in the assign list in the database. When the close button is pressed, control returns to step 2302.

FIG. 47e illustrates the operation of the Help button where at step 2152, online help information is displayed.

Referring now to FIG. 47f, operation of the manage operations function is described. At step 2350, the manage operations dialog box is displayed which includes a list of all defined operators. At step 2352, an idle state is entered to allow the user to input data.

If the user presses the edit/view button, at step 2358, a database look-up is performed on the operator. At step 2360, the dialog box is populated with data from the database. At step 2362, an idle state is entered to allow the user to input data. If the user presses the same button, at step 2364 information is saved to the database and control returns to step 2352. From step 2352, if the user presses the new button, at step 2356, the system displays the dialog box with empty fields for new operator information. Control proceeds to step 2362 and execution continues as described above.

If from step 2352, the delete button is pushed, at step 2354, the highlighted operator is deleted from the database and the list. Control returns to step 2352.

If the user presses change password, execution continues at step 2366 where the change password dialog box is displayed. Then at step 2368, the user enters the current password, the new desired password, and verifies the password. At step 2370, an idle state is entered. If the user presses the cancel button, control returns to step 2352. If the user presses the save button, control continues at step 2372, where the system verifies the current password for the operator and, if valid, the password in changes in the database.

Then, at step 2374, the system determines if the current password matches. If the answer is negative, at step 2376, the system provides feedback to the user indicating this fact. Control returns to step 2352. If the answer is affirmative, at step 2378, the password is changed in the database for the operator and control returns to step 2352.

Network Management Utility Operation

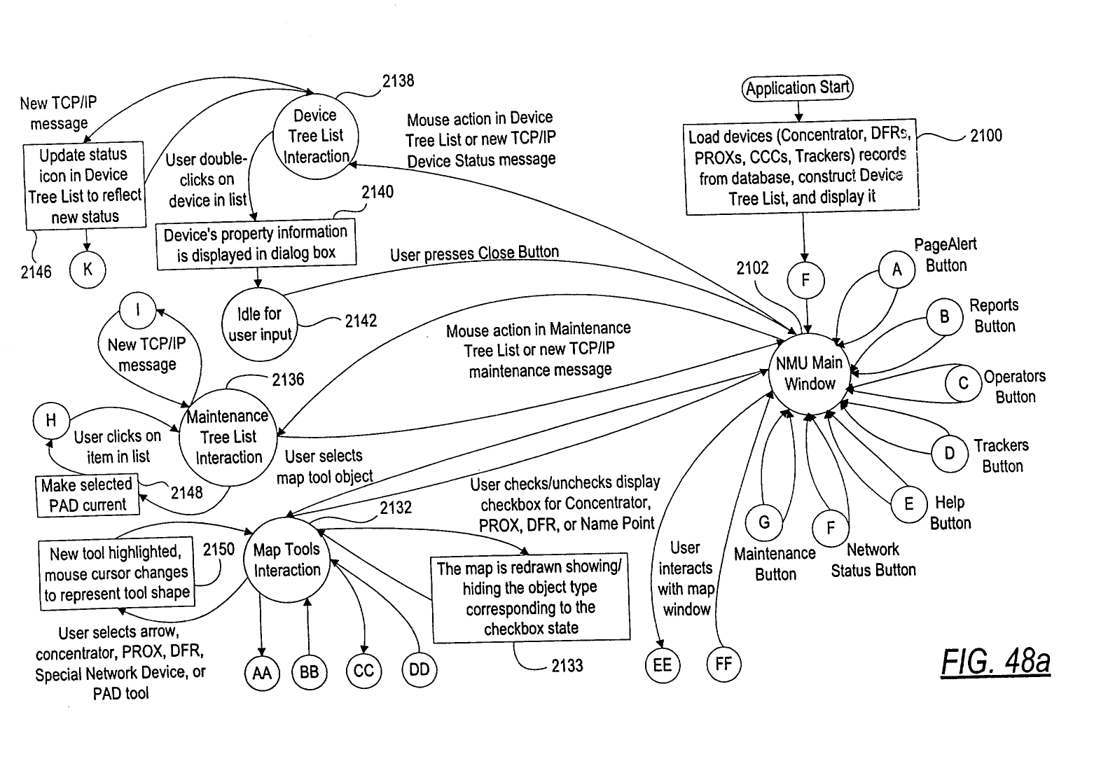

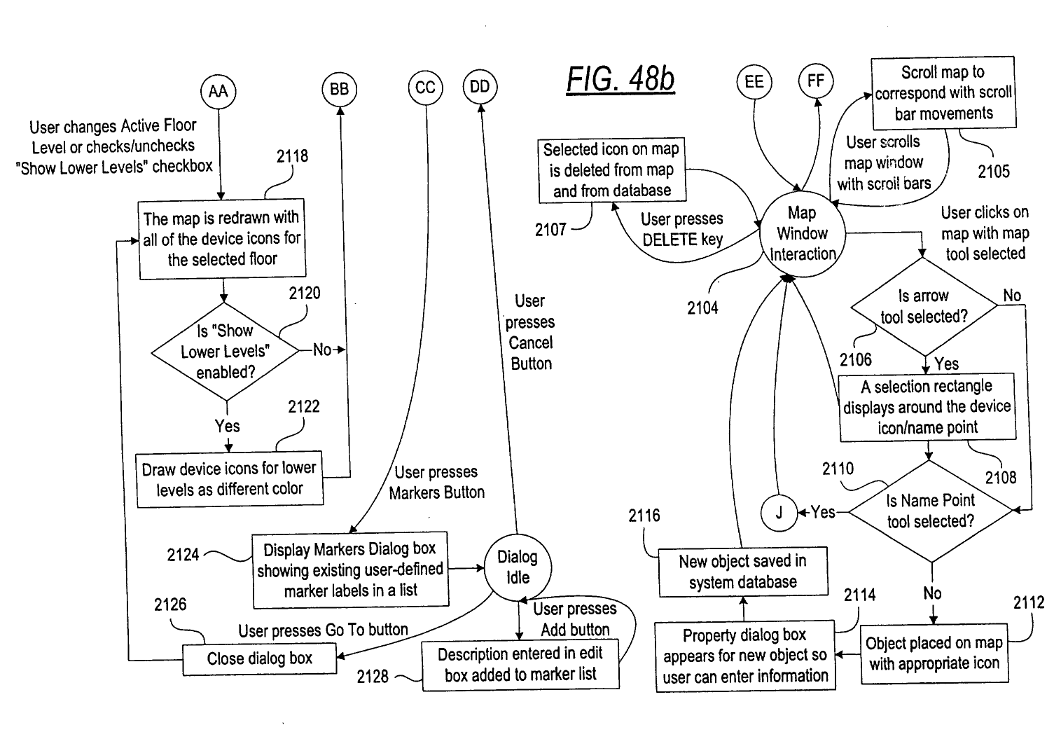

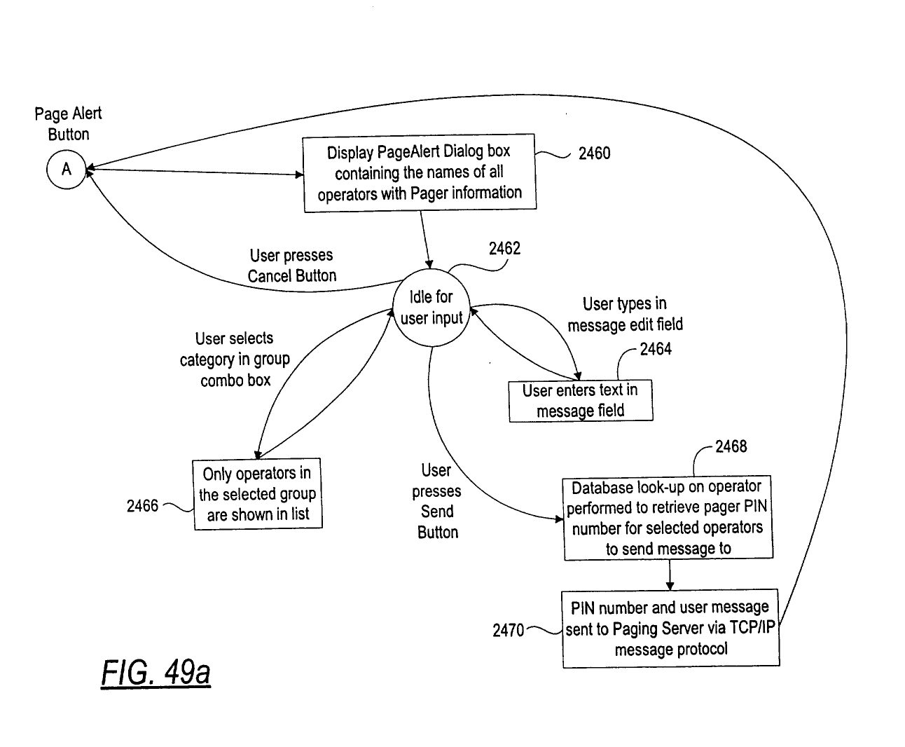

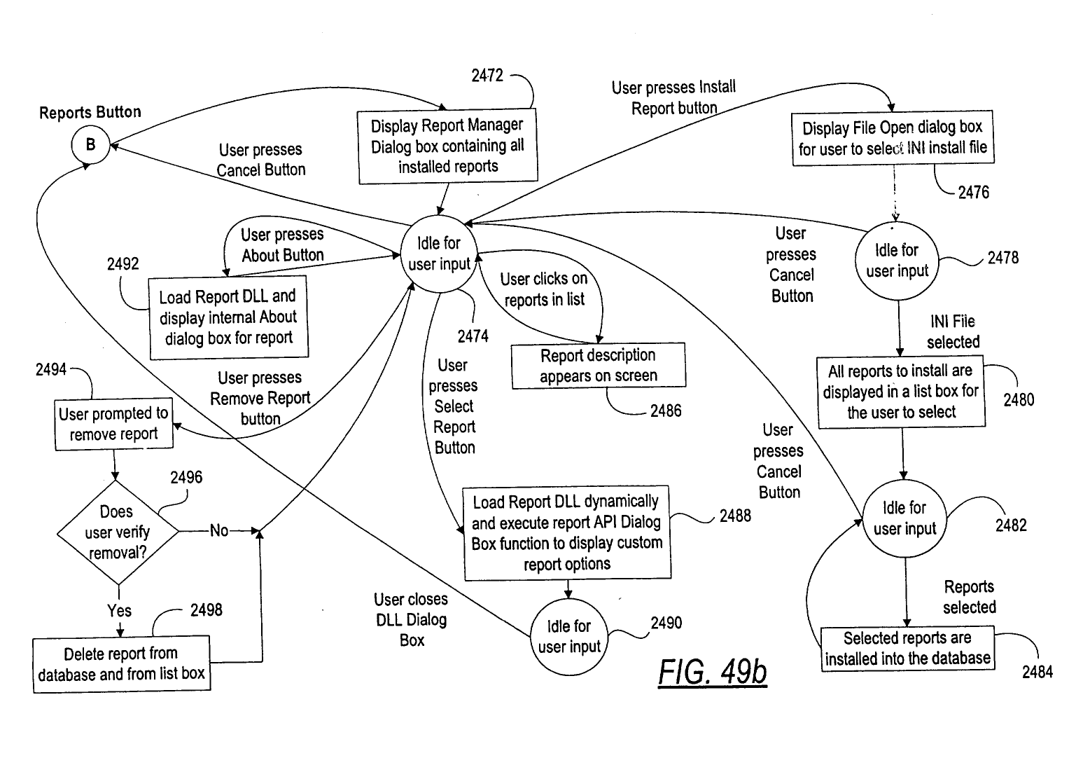

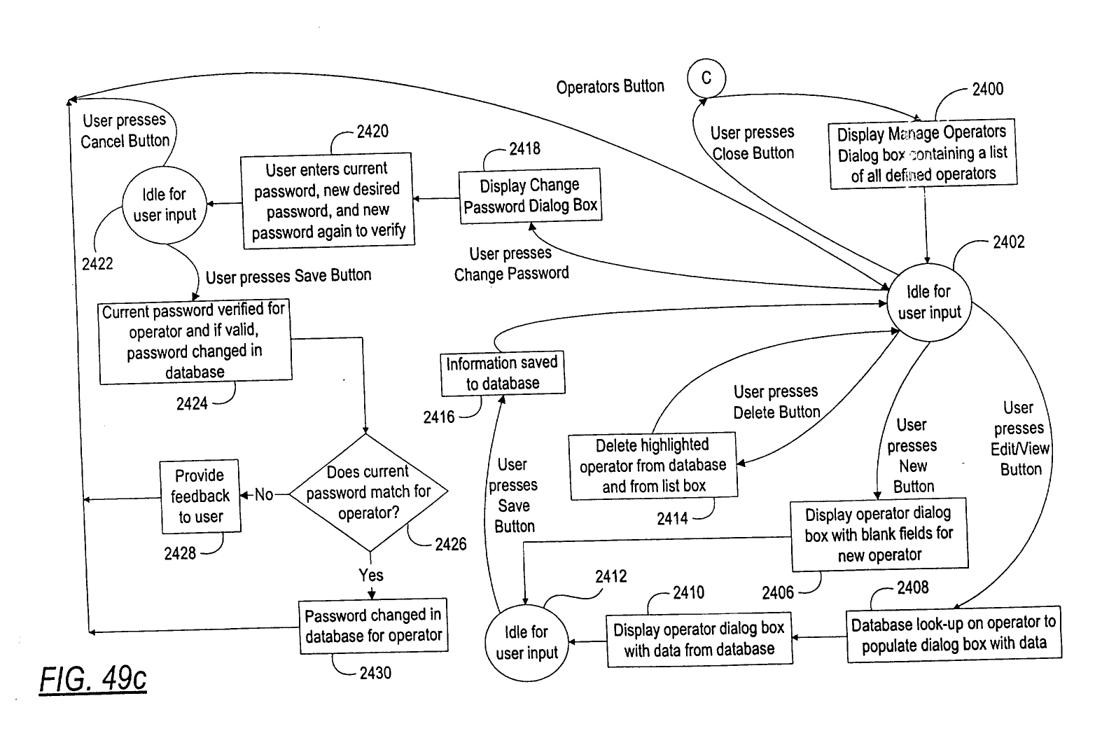

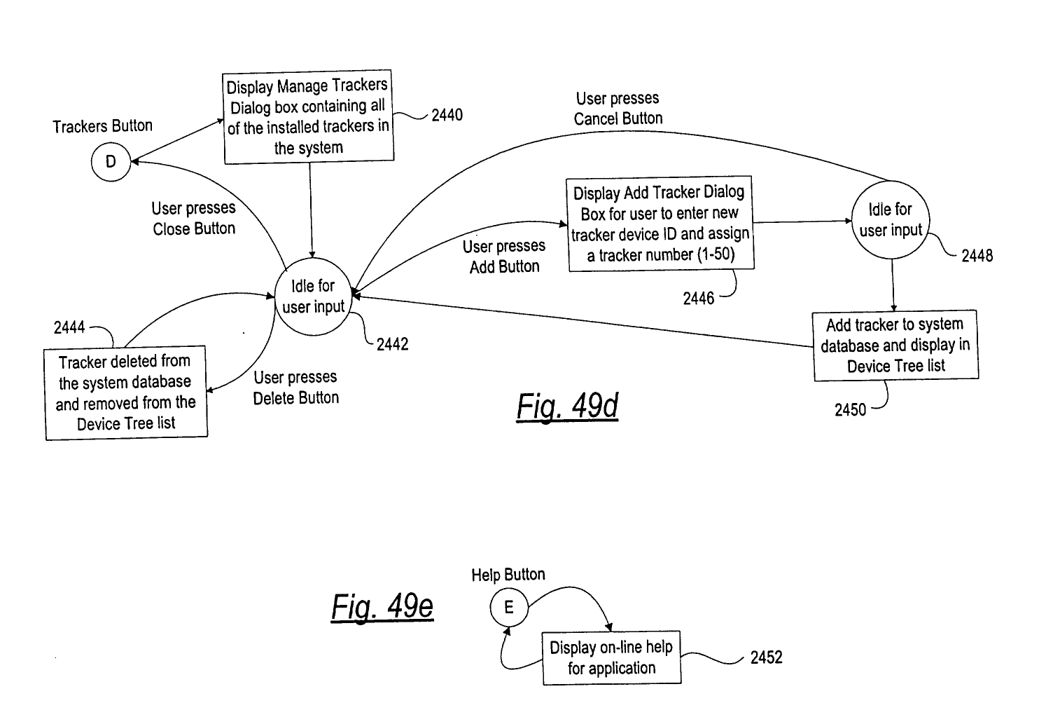

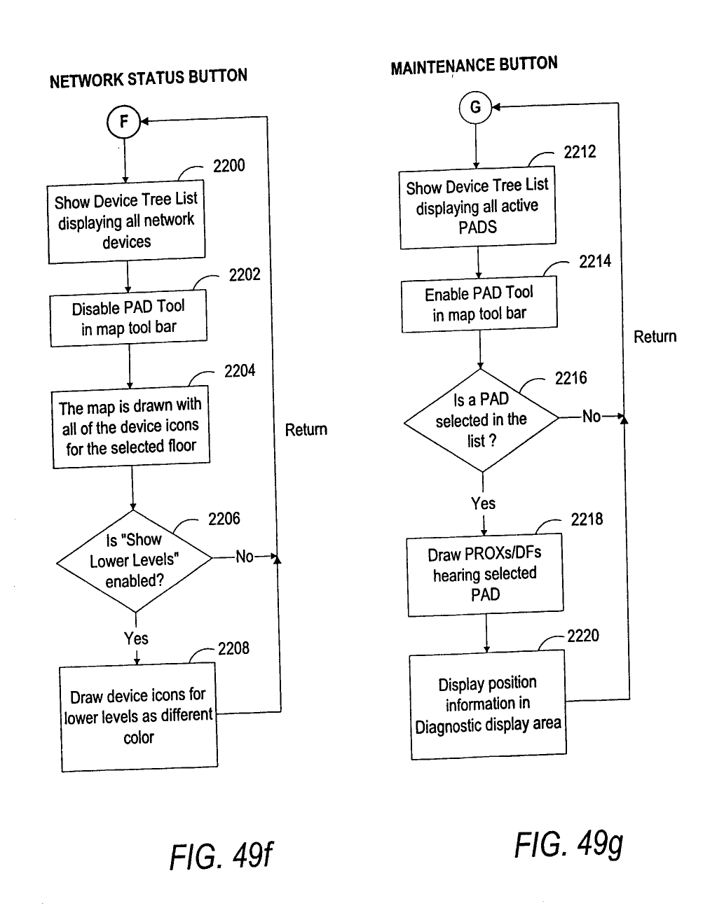

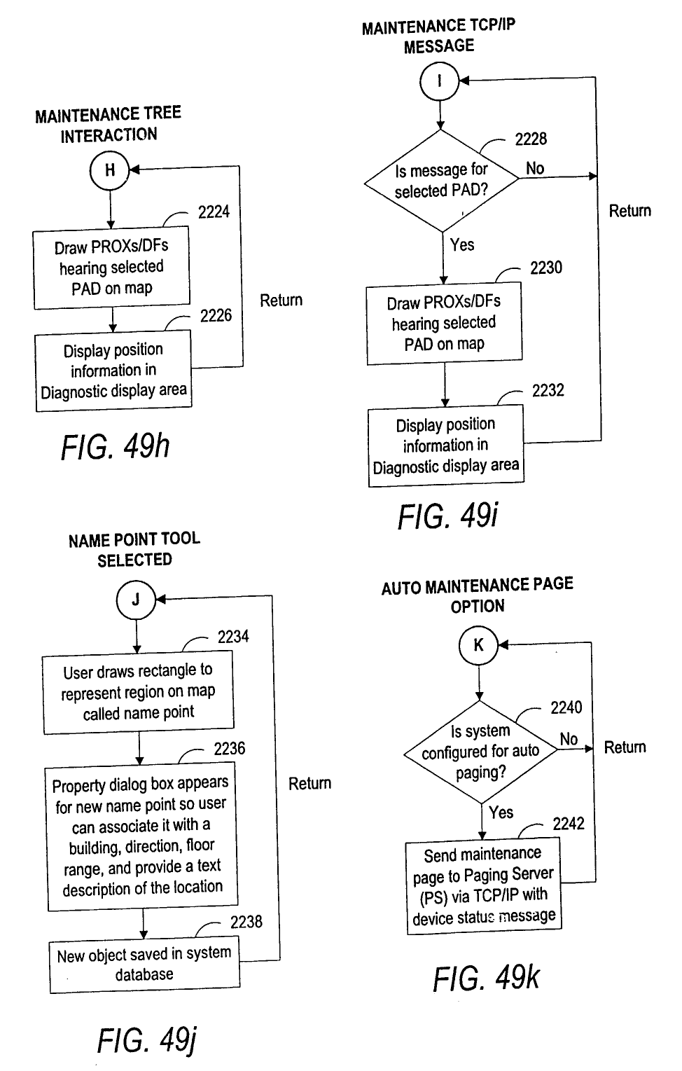

Referring now to FIG. 48, the operation of the NMU is now described. At step 2100, various device are loaded with relevant information from the database. These device include the concentrators, DFRs, PROXs, CCCs, and trackers Operation continues with the operation of the Network Status Button. See FIG. 49f and accompanying text. Then, at step 2102, the NMU main window is displayed. From the NMU main window step (2102) various buttons can be pushed including the page alert button, the reports button, the operations button, the trackers button, the help button, the network status button, and the maintenance button. The operation of these buttons is described in connection with FIGS. 49a-g and the accompanying text.

User instruction with the map window at step 2101 causes execution to continue at step 2104 where map window interaction takes place.

If the user scrolls the map window with the scroll bars, execution continues at step 2105 where the map is scrolled to correspond with the scroll bar movements. Execution returns to step 2104. If the user selects the delete key, execution proceeds to step 2107 where the selected icon on the map is deleted from the map and the data base.

If the user clicks on the map with the map tool selected at step 2106, the system determines if the arrow tool is selected. If the answer is negative, the execution continues at step 2110. If the answer is affirmative at step 2108, a selection rectangle displays around the device icon/name point. Next, at step 2110, the system determines whether the name point tool is selected. If the answer is affirmative, then execution continues with the algorithm described by FIG. 49f and the accompanying text. Control then returns to step 2104.

If the answer at step 2110 is negative, then execution continues with step 2112 where the system places the object on the map with the appropriate icon. Next, at step 2114, the property dialog box appears for a new object and the user can enter the appropriate information. Next, at step 2116, the new object is saved in the system data base. Control returns to step 2104.

From step 2102, mouse action by the user in the device tree list or new TCP/IP device states message causes control to proceed to step 2138 where device tree interaction occurs. If the user double-clicks on a device in the list, control proceeds to step 2140 where the device's property information is displayed in the dialog property box. Next, at step 2142, the task goes idle for user input. When the user presses the close button, control returns to step 2102.

From step 2138, a new TCP/IP message causes control to proceed to step 2146 where the status icon in the device tree list is updated to reflect the new status.

If, at step 2102, the user selects the map tool, control continues at step 2132 where the map tool interaction takes place. If the user selects an arrow, concentrator, PROX, DFR, Special Network device or PAD tool, execution continues at step 2150 where the new tool is high-lighted and the mouse cursor changes to represents the tool shape. Control returns to step 2132.

If, at step 2132, the user checks or unchecks the display checkbox for the concentrator, PROX, the DFR, or the namepoint, control proceeds to step 2133 where the map is redrawn showing or hiding the object type corresponding to the checkbox state. Execution then returns to step 2132.

If, at step 2132, the user presses the markers button, control proceeds to step 2124 where the markers dialog box is displayed showing the existing user-defined marker labels in a list. Control proceeds to step 2130 where the dialog box is idle. If the user presses the cancel button, control returns to step 2132. If the user presses the go to button, control proceeds to step 2126 where the dialog box is closed. Control continues at step 2118.

If, at step 2130, the user presses the add button, control goes to step 2128 where the user enters the description in the edit box which is added to the marker box. Control returns to step 2130.

If, at step 2132, the user changes the active floor level or checks or unchecks “show lower levels” checkbox, control is transferred to step 2118. At step 2118, the map is redrawn with all of the device icons for the selected floor. Next, at step 2120, the system determines if the “show lower levels” is enabled. If the answer is negative, control returns to step 2132. If the answer is affirmative at step 2122, the system draws device icons for lower levels as a different color. Control returns to step 2132.

The operation of the Network Management Utility is now described with respect to FIGS. 49a-49k.

Referring now to FIG. 47a, the operation of the Page Alert button is now described. At step 2460, the Page Alert dialog box is displayed containing the names of all the operators with pager information. At step 2462, the system is idle allowing input from the user. The user types text into the message field at step 2464. If the user presses the Send button, at step 2468, a database look-up on an operator is performed to retrieve the pager PIN number for selected operators. Then, at step 2470, the PIN number and user message is sent to the paging server via TCP/IP message protocol. Execution then concludes. If, at step 2462, the user selects a category in the group combination box, at step 2466, only the operators in the selected group are shown.

Referring now to FIG. 47b, the operation of the Reports button is described. At step 2472, the system displays the Report Manager dialog box which contains all of the installed reports. Next, at step 2474, the system is idle to allow for user input if a user presses the Install Report button, at step 2476, the system displays the File Open dialog box. Next, at step 2478, the system is idle for user input. At step 2478, if the user presses the Cancel button control returns to step 2474. However, if a file is selected, at step 2480, all reports are displayed in a list box for the user to select. Next, at step 2482, the system is idle to allow for user input. If the user presses the Cancel button, control returns to step 2474. However, if the user selects a report, step 2484 is executed whereby reports are installed in the database. Control returns to step 2482.

If at step 2474, the user clicks on the Reports lists, step 2486 is executed where the report description appears on the screen. Control returns to step 2484.

If at step 2474 the user presses the Select Report button, control continues at step 2488 where the report is loaded dynamically and the custom report options are displays. Next, at step 2490 the system is idle to allow for user input. When the user closes the dialog box, the system exits the Report button function.

If, at step 2492, the user presses the About button, the system loads the report DLL and displays the internal About dialog box. Control returns to step 2474.

If, at step 2474, the user presses the Remove Report button, at step 2494 the user is prompted to remove the report. Next, at step 2496, the system determines whether the user wants to verify removal. If the answer is negative, control returns to step 2474. If the answer is affirmative at step 2498, the report is deleted from the database and from the list box. Control returns to step 2474.

Referring now to FIG. 49d, the operation of the Trackers button is described. At step 2440, the system displays the Manage Trackers dialog box containing all of the installed trackers in the system. At step 2442, the system is idle to allow for user input. If the user presses the Delete button, at step 2444 the tracker is deleted from the database and removed from the device tree list. Control returns to step 2442.

At step 2442, if the user presses the Add button, the Add Tracker dialog box is displayed for the user to enter a new tracker device ID and assign a tracker number. Next, at step 2448, the system is idle to allow for user input. If the user presses the Cancel button, execution returns to step 2442. Otherwise, at step 2450, the tracker is added to the system database and to the device tree list. Execution returns to step 2442.

Referring now to FIG. 49c, the operations of the Operators Button is now described. At step 2400, the Manage Operators dialog box is displayed which contains a list of all defined operators. At step 2402, the system is idle to allow for user input. If the user presses the New button, at step 2406 the Operator dialog box is displayed with blank fields for the new operator. Next, at step 2412, the system is idle allowing the user to fill the fields. When the user presses the Save button, step 2416 is executed where the information input by the user is saved in the system database.

If at step 2402, the user presses the Edit/View button, step 2408 is executed where the database look-up is performed on the operator to populate the dialog box with data. Next, at step 2410, the Operator dialog box is displayed with data from the database. Control continues at step 2412 as described above.

If, at step 2402, the user presses the Change Password button, at step 2418 the Change Password dialog box is displayed. Next, at step 2420, the user enters the current password, new desired password, and the new desired password for verification. Then, at step 2422, the system is idle to allow for user input. If the user then presses the Cancel button, control returns to step 2402. However, if the user presses the Save button, at step 2424, the current password, verified by the operator, is changes in the database. Then, at step 2426, the system determines the current password matches that for the operator. If the answer is negative a message to the effect is sent to the user at step 2428 and control returns to step 2402. If the answer is affirmative, at step 2430, the password is changed in the database for the operator and control returns to step 2402.

FIG. 47e illustrates the operation of the Help button where at step 2452, online help information is displayed.

Referring to FIG. 49f, operation of the network status button is described. At step 2200, the device tree list is displayed which shows all network devices. Next, at step 2202, the PAD tool in the map tool bar is disabled. Then, at step 2204, the map is drawn with all of the device icons on the selected floor. At step 2206, the system determines whether the “show lower levels” option has been enabled. If the answer is negative, control returns to step 2200. If the answer is affirmative, control proceeds to step 2208 where the device icons for lower levels are displayed in a different color. From step 2208, control returns to step 2200 where the system awaits the next pushing of the network status button.

Referring now to FIG. 49g, the operation of the system after the maintenance button is pushed is described. At step 2212, the maintenance tree list displaying all active PADs is shown. Next, at step 2214, the PAD tool in the map tool bar is enabled. Then, at step 2216, the system determines whether a Pad has been selected from the list. If the answer is negative, control returns to step “g” where the system awaits the next pressing of the maintenance button.

If the answer at step 2216 is affirmative, control continues at step 2218 where the PROXs or DFRs hearing the selected PAD are drawn. Then, at step 2220 position information is displayed in the diagnostic display area. Control returns to step “g” where the system awaits the next pressing of the maintenance button.

Referring now to FIG. 49h, the maintenance tree interaction is described. At step 2224, PROXs and DFRs hearing the selected PAD are displayed on the map. Next, at step 2226, position information is displayed in the diagnostic display area. Control then terminates by returning to step “h.”

Referring now to FIG. 49i, operation of the Maintenance TCP/IP message is described. At step 2228, the system determines whether the message option for a particular PAD has been selected. If the answer is negative, control returns to step “i”. If the answer is affirmative, at step 2230, the PROXs and DFRs hearing the selected PAD are displayed on the map. Then, at step 2232, position information is displayed in the diagnostic display area. Control then returns to step “i.”

Referring now to FIG. 49j, at step 2234, the user draws a rectangle on the map to represent the region on the map to e called name point. Next, at step 2236, the property dialog box appears for a new name point so that the user can associate the box with a building, floor range, and provide a textual description of the location. Finally, at step 2238, the new object is saved in the system database.

Referring to FIG. 49k, at step 2240, the system determines if it is configured for autopaging. If the answer is negative, execution is retained to the main NMU routine. If the answer is affirmative, at step 2242, a maintenance page is sent to the paging source via the TCP/IP with the device status message.

Paging Server Operation

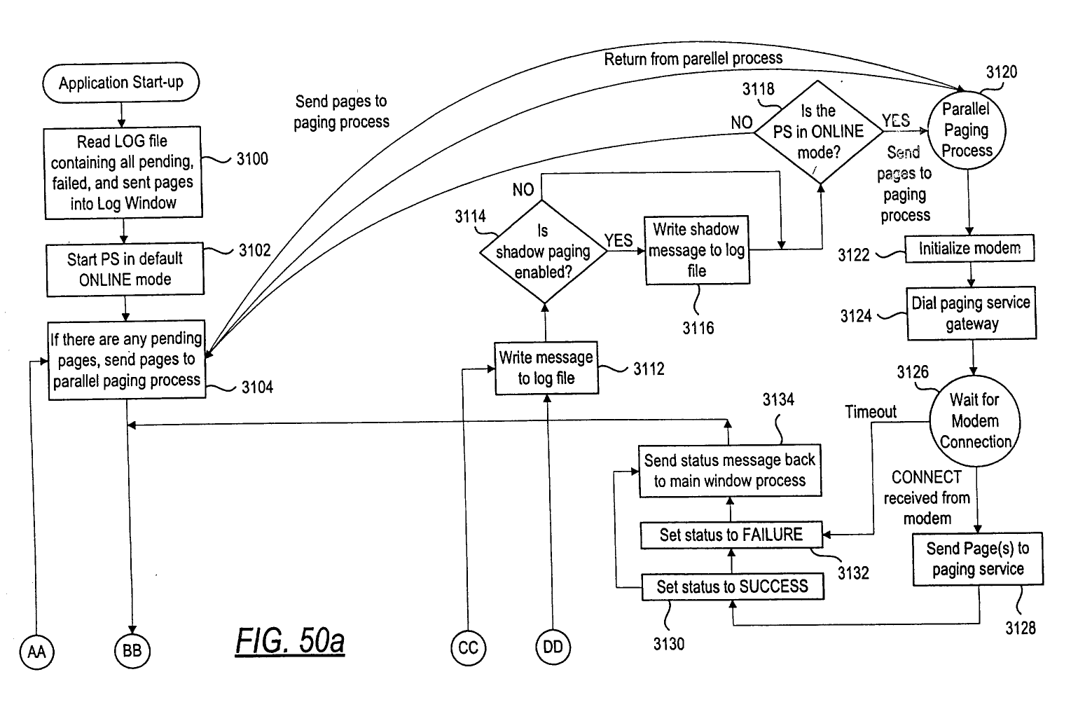

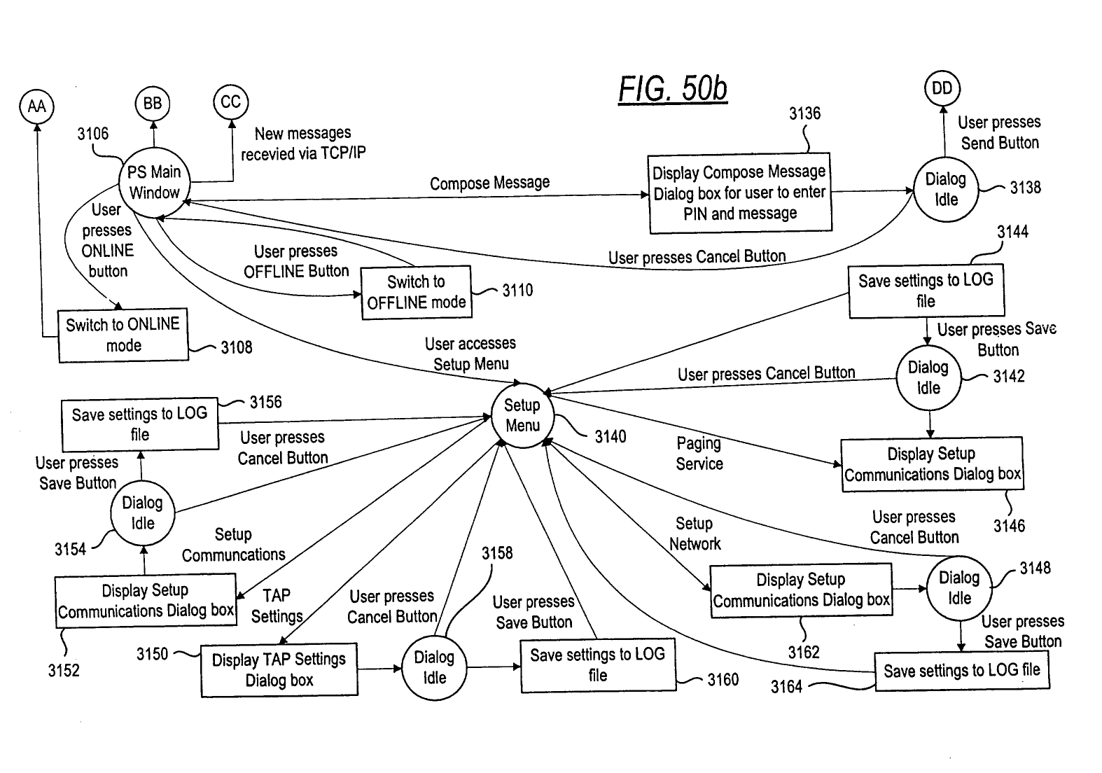

Referring now to FIG. 50, at step 3100, the application reads the LOG file containing all pending failed and sent pages into the LOG window. Next, at step 3102, the paging server is started in ONLINE mode which is the default mode. Then, at step 3104, if there are any pending pages, the pages are sent to a parallel paging process. Next, at step 3106, the paging server main window is entered. When new messages are received via the TCR/OP, at step 3112, the message is written to a LOG file. At step 3114, the system determines whether shadow paging is enabled. If the answer is negative, control shifts to step 3118. If the answer is negative at step 3116, a shadow message is written to the LOG file.

At step 3118, the system determines whether the paging server is online. If the answer is negative, control returns to step 3104. If the answer is affirmative, control continues at step 3120 where the pages are sent to a parallel paging process. Next, at step 3122, the modem is initialized. At step 3124, the paging service gateway is dialed. At step 3126, the system waits for a modem connection. If a timeout occurs, control continues at 3132. If a connect is received from the modem, control continues at step 3128 where the system sends the page or pages to the paging server. At step 3130, the status is set to success. Control then proceeds to step 3134. If step 3132 is entered, the status is set to failure. Control then proceeds to step 3134.

At step 3134, the status message is sent back to the main window process (step 3106).

If a compose message is received at step 3106, control continues at step 3136 where the compose message is displayed in the dialog box for the user to enter the PIN and message. Next, at step 3138, the dialog idle process is entered. Next, control proceeds to step 3112 where control proceeds as described above.

If a user presses the offline button at step 3106, control continues at step 3110 where the system switching to offline mode.

If a user presses the online button at step 3106, control continues at step 3108 where the system enters online mode.

If a user accesses the setup menu at step 3106, control continues at step 3140 where the setup menu process is executed. If paging service is desired at step 3146, the communications dialog box is displayed. Execution continues at step 3142 where the dialog idle process is executed. Next, at step 3144, the settings are saved to a log file. If a user processes a cancel button at step 3142, execution continues at step 3140.

If setup network is indicated at step 3140, execution continues at step 3162 where the communications dialog box is displayed. Next, at step 3148 the dialog idle process is entered. If user presses the cancel button, control returns to step 3140. If the user presses the save button, control proceeds to step 3164 where the settings are saved to the log file. Control returns to step 3140.

If tap settings is indicated at step 3140, execution continues at step 3150 where the tap settings dialog box is displayed. Next, at step 3158, the dialog idle process is executed. Then, at step 3160 the settings are saved to the log file.

If setup communications is indicated at step 3140, at step 3152 the system displays the setup communication dialog box. Next, at step 3154 the dialog idle process is executed. If the user presses the cancel button, control returns to step 3140. If the user presses the save button, control continues with step 3156 where the settings selected are saved to a log file.

Subscriber Management Unit Operation

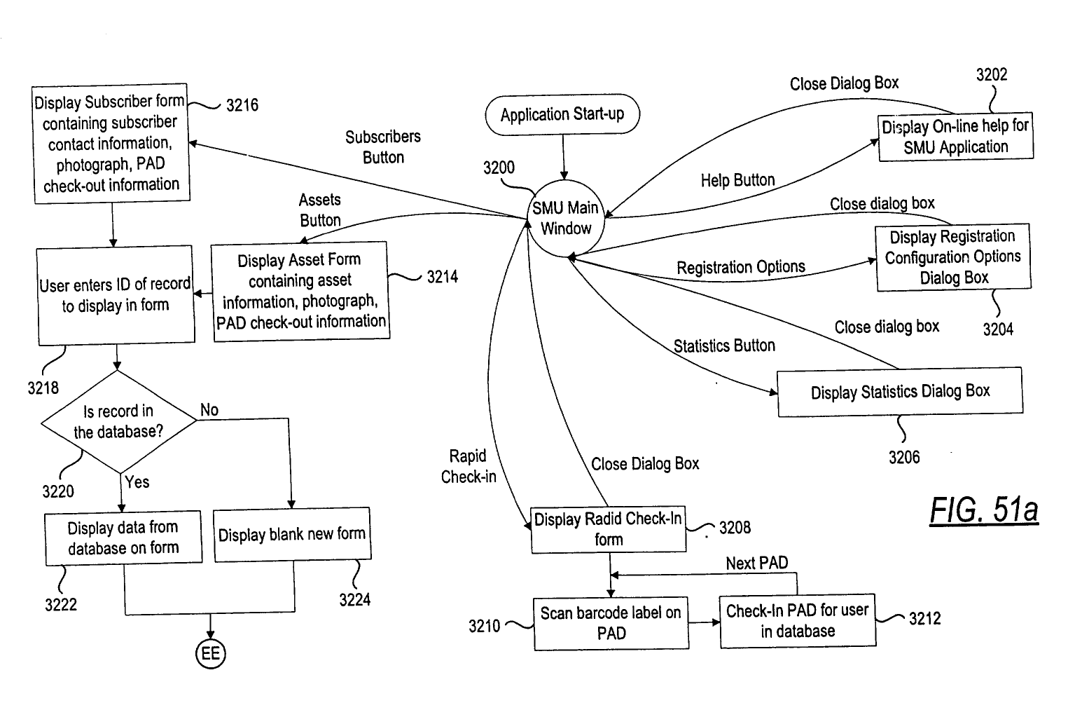

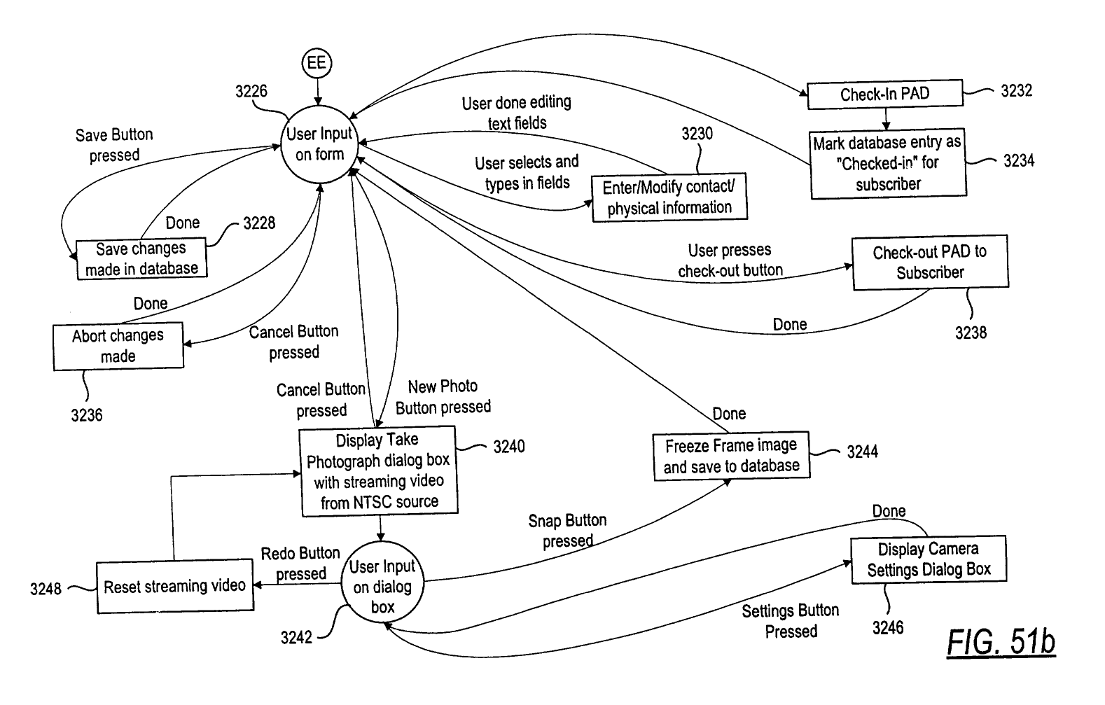

Referring now to FIG. 51, the SMU utility is now described, At step 3200, the SMU main window process is entered. If the help button is pressed, at step 3202, on-line help for the SMU application is displayed. When the dialog box is closed, control returns to step 3200.

If the registration options button is selected, at step 3204, registration confirmation options are displayed. When the dialog box is closed, control returns to step 3200.

If the statistics button is selected, at step 3206, the statistics dialog box is displayed. When the box is closed, control returns to step 3200.

If the rapid check-in button is selected, at step 3208, the rapid check-in forms is displayed. Next, at step 3210, the user scans the bar code on the PAD. Then, at step, 3212, the PAD is checked into the database for the user. Control returns to step 3210 for the next PAD. When there are no more PADs for check-in, this loop is exited and control returns to step 3200.

If the subscribers button is selected, step 3216 is executed, the subscriber form is displayed at step 3216. This form includes subscription contact information, photograph, and PAD check-out information. Control continues at step 3218 which is described below.

If the assets button is pushed, at step 3214, an asset form is displayed containing asset information, photograph, and PAD check-out information. Execution continues at step 3218.

At step 3218, the user enters the ID of record to display on the form. Next, at step 3200, the system determines if the record is in the database. Then, at step 3222, data from the database is displayed on the form if the answer at step 3200 is off or marked. Control continues at step 3226. If the answer at step 3220 is negative, a new form is displayed at step 3224. At step 3226, the user inputs data on a form. At step 3232, the PAD is checked in. At step 3234, the database entry is marked as checked in for the subscriber. Control returns to step 3226.

If the user selects and types in the fields, at step 3230, the user enters or modifies contact or physical information. When the user is finished, control returns to step 3226.

When the user presses a check-out button at step 3238, the PAD is checked out to the subscriber. When finished, control returns to step 3226.

If the cancel button is pressed, at step 3236, any changes are aborted, control returns to step 3226.

If the new photo button is pressed, control continues at step 3240 where the take photograph dialog box is displayed with streaming video from the NTSC source. Then, at step 3242, the user inputs data to the dialog box. If the redo button is pressed, step 3248 is executed where the video is reset. If the snap button is pressed, at step 3244, the freeze form video image is saved to the database. If the settings button is pressed, at step 3246, the display camera settings dialog box is displayed. When done, control returns to step 3242.

PAD Registration Process

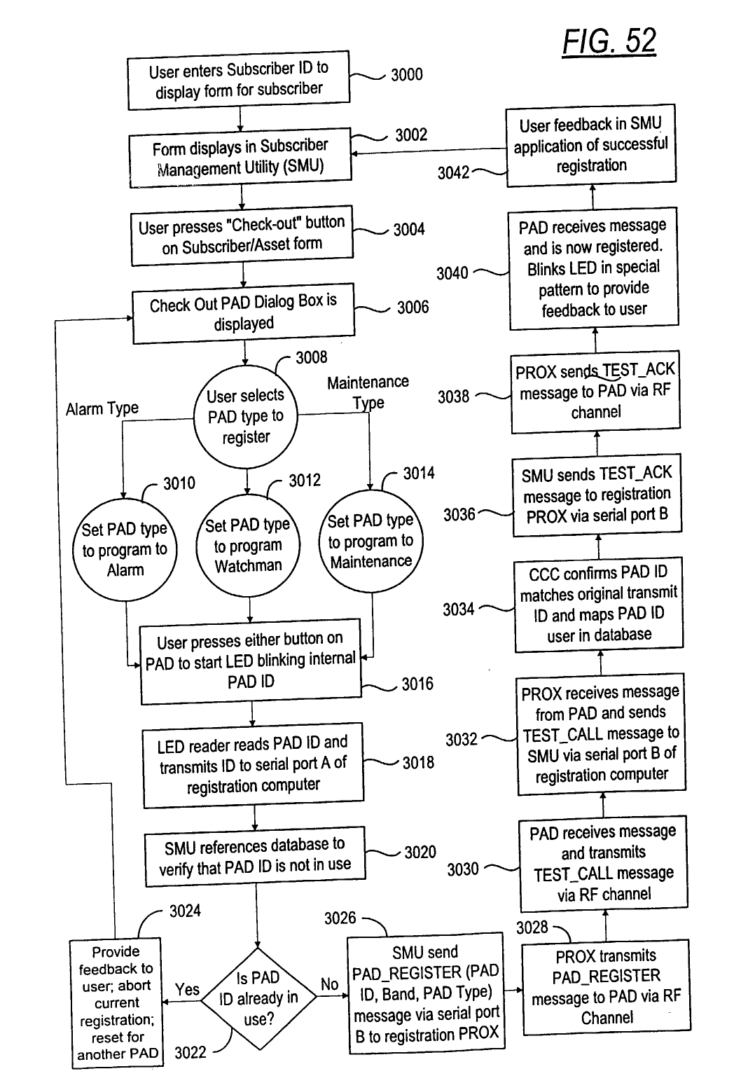

Referring now to FIG. 52, the PAD registration algorithm is now described. At step 3000, the user enters the subscriber identification to display the subscriber form. At step 3002, the form is displayed in the SMU. At step 3004, the user presses the check-out button. At step 3006, the check-out PAD box is displayed. At step 3008, the user selects the Pad type to register. If the type is alarm type, at step 3010, the PAD type is set to alarm. Alternatively, if the type is watchman type, the PAD type is set to watchman at step 3012. Alternatively, if the type selected is maintenance type, the PAD type is set to maintenance at step 3014.

Then at step 3016, the user presses either the button on the PAD which starts the LED blinking the internal PAD identification. Next, at step 3018, the LED reader reads the PAD identification and transmits the ID to the serial port of the registration computer. Then at step 3020, the SMU references the database to verify that the PAD is not in use. At step 3022, it is determined whether the PAD identification is already in use. If the answer is affirmative, then at step 3024 feedback is provided to the user indicating the PAD identification is in use, the current registration is aborted and control returns to step 3006.

If the answer at step 3022 is negative, control continues at step 3026 where the SMU sends a PAD registration message via a serial port to a PROX. Then at step 3028, the PROX transmits the message via a RF signal. At step 3030, the PAD receives the message and transmits a TEST_CALL message via the RF channel. Then, at step 3032, the PROX receives the message from the PAD and sends a TEST_CALL message to the SMU via the serial port of the registration computer. AT step 3034, the CCC confirms that the PAD ID matches the original transmit id and places the PAD ID into the database. At step 3036, the SMU sends a TEST_ACK message to the registration PROX via a serial port. At step 3038, the PROX sends a TEST_ACK message to the PAD via the RF channel. At step 3040, the PAD receives the message and is now registered. THE LEDs are blinked in a special pattern to provide feedback to the user. Finally, at step 3042, feedback is provided to the user that the registration has been successful.

While the present invention has been described with reference to one or more preferred embodiments, those skilled in the art will recognize that many changes may be made thereto without departing from the spirit and scope of the present invention which is set forth in the following claims.

What is claimed is:

1. A system for accessing a communication channel and displaying information to a user comprising:
means for transmitting successive packets of information over said communication channel;
access means for prioritizing access of said packets of information to said communications channel said access means including means for withholding the transmission of said packets over said communication channel for a predetermined period of time; means for continuously sensing the state of said communication channel during said predetermined period of time; means for determining if said channel is clear after waiting for said predetermined period of time; and means for transmitting said packet after said predetermined period of time if said channel is clear; and
command and control means coupled to said location determination means for accepting queries from a user and displaying the location of said transmitting devices on a map, said command and control means including a plurality of subscriber records and subscriber management means for accessing and modifying said records, said command and control means also including network management means for displaying a graphical network tree, said tree containing all of said transmitting devices on the network, said network management means including mapping means for positioning devices on said map and for defining regions of said map in response to user commands.

2. The system of claim 1 wherein said access means further comprises means for frequency-hopping among a plurality of communication channels.

3. The system of claim 1 further comprises a plurality of remote units and wherein said packet comprises information indicating the identity of selected one said remote units.

4. The network of claim 1 further comprising location determination means for determining the location of a selected one of said remote units from said information in said packet.

5. A location determination network comprising:
a plurality of transmitting devices each having an associated geographic location and each of which includes transmission means for transmitting packets of information over a communication channel, said packets including information indicating the identity of said transmitting devices, said transmission means including means for continuously sensing the state of said channel; means for waiting for a predetermined time after sensing that said channel is clear; means for determining if said channel is clear after waiting for said predetermined time, and means for transmitting said packet after waiting for said predetermined time and determining that said channel is clear;
multiple proximate receiving means for receiving said packets from said transmitting devices located in close proximity to said transmitting devices; and
location determination means coupled to said proximate receiving means for determining the location of said plurality of transmitting devices; and
command and control means coupled to said location determination means for accepting queries from a user and displaying the location of said transmitting devices on a map, said command and control means including a plurality of subscriber records and subscriber management means for accessing and modifying said records, said command and control means also including network management means for displaying a graphical network tree, said tree containing all of said transmitting devices on the network, said network management means including mapping means for positioning devices on said map and for defining regions of said map in response to user commands, said command and control means further including means for tracking the movement of said transmitting devices over any floor of a building.

6. The network of claim 5 further comprising remote receiving means for receiving packets from a selected group of said remotely located devices, said selected group located remotely from said proximate receiving means.

7. A location determination network comprising:
a plurality of transmitting devices each having an associated geographic location and each of which includes transmission means for transmitting packets of information over a communication channel, said packets including information indicating the identity of said transmitting devices, said transmission means including means for continuously sensing the state of said channel; means for waiting for a predetermined time after sensing that said channel is clear; means for determining if said channel is clear after waiting for said predetermined time, and means for transmitting said packet after waiting for said predetermined time and determining that said channel is clear;
multiple proximate receiving means for receiving said packets from said transmitting devices located in close proximity to said transmitting devices;
location determination means communicatively coupled to said proximate receiving means for determining the location of said plurality of transmitting devices;
display means coupled to said location determination means for displaying the location of said transmitting devices said display means including means for tracking the movement of said transmitting devices over any floor of a building.

8. A location determination network for locating a plurality of remotely located devices comprising:
a plurality of transmitting devices each having an associated geographic location and each of which includes transmission means for transmitting packets of information over a communication channel, said packets including information indicating the identity of said transmitting devices, said transmission means including means for continuously sensing the state of said channel; means for waiting for a predetermined time after sensing that said channel is clear; means for determining if said channel is clear after waiting for said predetermined time, and means for transmitting said packet after waiting for said predetermined time and determining that said channel is clear;
multiple proximate receiving means for receiving said packets from said remotely located devices located in close proximity to said transmitting devices;
location determination means coupled to said proximate receiving means for determining the location of said plurality of transmitting devices;
a hand-held tracking device coupled to said proximate receiving means for indicating the location of said plurality of remotely located devices; and
command and control means coupled to said location determination means for accepting queries from a user and displaying the location of said transmitting devices on a map, said command and control means including a plurality of subscriber records and subscriber management means for accessing and modifying said records, said command and control means also including network management means for displaying a graphical network tree, said tree containing all of said transmitting devices on the network, said network management means including mapping means for positioning devices on said map and for defining regions of said map in response to user commands.

9. A network for determining the location of a plurality of remotely located devices said network comprising:
a plurality of transmitting devices each having an associated geographic location and each of which includes transmission means for transmitting packets of information over a communication channel, said packets including information indicating the identity of said transmitting devices, said transmission means including means for continuously sensing the state of said channel; means for waiting for a predetermined time after sensing that said channel is clear; means for determining if said channel is clear after waiting for said predetermined time, and means for transmitting said packet after waiting for said predetermined time and determining that said channel is clear;
multiple remote receiving means for receiving said packets and test signals from a selected group of said transmitting devices, said selected group located remotely from said transmitting devices;
location determination means coupled to said remote receiving means for determining the location of said plurality of transmitting devices; and
command and control means coupled to said location determination means for accepting queries from a user and displaying the location of said transmitting devices on a map, said command and control means including a plurality of subscriber records and subscriber management means for accessing and modifying said records, said command and control means also including network management means for displaying a graphical network tree, said tree containing all of said transmitting devices on the network, said network management means including mapping means for positioning devices on said map and for defining regions of said map in response to user commands, said command and control means further including means for tracking the movement of said transmitting devices over any floor of a building and paging server means for receiving paging messages from said subscriber management means and said network management means, said messages containing information indicative of a need for paging service, said paging server means sending a paging request to a paging gateway in response to receipt of said messages.

10. A graphical user interface for a location determination system comprising:
means for displaying the geographical location of a plurality of transmitting devices each having an associated geographic location; and
means for displaying a graphical network tree, said tree containing all of said transmitting devices on the network, said network management means including mapping means for positioning devices on said map and for defining regions of said map in response to user commands, said command and control means further including means for tracking the movement of said transmitting devices over any floor of a building and paging server means for receiving paging messages from said subscriber management means and said network management means, said messages containing information indicative of a need for paging service, said paging server means sending a paging request to a paging gateway in response to receipt of said messages.
